(19) United States
(12) Patent Application Publication
(10) Pub. No.: US 2026/0236134 A1
(43) Pub. Date: Aug. 13, 2026

(54) System and Method of a Customer Management System with Auto-Provisioning AI-Based Dialog Services

(71) Applicant: Nextiva, Inc., Scottsdale, AZ (US)

(72) Inventors: Tomas Gorny, Scottsdale, AZ (US); Gerald A. Holly, JR., Parkland, FL (US); Edwin K. Margulies, Clifton, TX (US); Namir Sincoff-Yedid, San Diego, CA (US)

(21) Appl. No.: 19/426,962

(22) Filed: Dec. 19, 2025

Related U.S. Application Data
(63) Continuation-in-part of application No. 19/191,643, filed on Apr. 28, 2025.
Application No. 19/191,643 is a continuation of application No. 16/731,907, filed on Dec. 31, 2019, now Pat. No. 12,287,946.
Application No. 16/731,907 is a continuation of application No. 15/078,818, filed on Mar. 23, 2016, now Pat. No. 10,551,989.
(63) Continuation-in-part of application No. 18/180,804, filed on Mar. 8, 2023, now Pat. No. 12,632,532.
Application No. 18/180,804 is a continuation of application No. 16/430,245, filed on Jun. 3, 2019, now Pat. No. 11,620,371.
(60) Provisional application No. 62/169,215, filed on Jun. 1, 2015.
(60) Provisional application No. 62/686,212, filed on Jun. 18, 2018.

(51) Int. Cl. G06F 3/0481; G06F 3/04845; G06F 40/186; G06Q 30/02; H04L 41/18; H04L 41/22; H04L 43/045; H04M 3/42; H04M 3/51; H04W 24/08; H04W 24/10

(52) U.S. Cl. CPC G06F 3/0481; G06F 3/04845; G06F 40/186; G06Q 30/02; H04L 41/18; H04L 41/22; H04L 43/045; H04M 3/42068; H04M 3/5133; H04W 24/08; H04W 24/10; H04M 3/42348; H04M 2203/558

(57) ABSTRACT

A system and method are disclosed for automated provisioning of AI-based dialog services across a plurality of target applications. The system comprises a communication device, a system administrator, and a modular architecture of microservices including a runtime engine, provisioning server, and crawler. The system administrator initiates a setup process, receives user information, and associates it with an identification number. Dialog templates are stored and associated with deployment objects, enabling extraction of textual data from target applications. The extracted data is assembled into inquiries or responses according to the templates and deployed as AI-based dialog services. The system supports secure token exchange, template-driven normalization, and orchestration of conversational agents using transformer-based models. Deployment may occur across web portals, mobile apps, or embedded systems, with support for dynamic re-crawling, escalation triggers, and FAQ generation.

### CROSS-REFERENCE TO RELATED APPLICATIONS

This application is a continuation-in-part of U.S. patent application Ser. No. 19/191,643, filed on Apr. 28, 2025, entitled “System and Method of a Customer Management System” which is a continuation of U.S. patent application Ser. No. 16/731,907, filed on Dec. 31, 2019, entitled “System and Method of a Customer Management System”, now U.S. Pat. No. 12,287,946 which is a continuation of U.S. patent application Ser. No. 15/078,818, filed on Mar. 23, 2016, entitled “System and Method of a Customer Management System”, now U.S. Pat. No. 10,551,989 which claims the benefit under 35 U.S.C. § 119(e) to U.S. Provisional Application No. 62/169,215, filed Jun. 1, 2015, and entitled “System and Method of a User Interface System”. This application is a continuation-in-part of U.S. patent application Ser. No. 18/180,804, filed on Mar. 8, 2023, entitled “Method for Auto-provisioning AI-based Dialog Service” which is a continuation of U.S. patent application Ser. No. 16/430,245, filed on Jun. 3, 2019, entitled “Method for Auto-provisioning AI-based Dialog Service”, now U.S. Pat. No. 11,620,371, which claims the benefit under 35 U.S.C. § 119(e) to U.S. Provisional Application No. 62/686,212, filed Jun. 18, 2018, and entitled “System and Method for Auto-provisioning Timeline Dialogs”.

U.S. Pat. Nos. 12,287,946, 10,551,989, 11,620,371, U.S. patent application Ser. Nos. 19/191,643, 18/180,804, and U.S. Provisional Application Nos. 62/169,215 and 62/686,212 are assigned to the assignee of the present application.

### TECHNICAL FIELD

The present disclosure relates generally to a system and a method for telecommunications and specifically to a customer management system which may utilize automatically-provisioned artificial intelligence (AI)-based dialogs.

### BACKGROUND

In a typical user interface, most users cannot access all features because the interface is too complicated even for technologically adept users. For enterprise telecommunications systems, in particular, access to useful features might require many steps, which take too long to accomplish and are overly complicated.

Prior art telecommunication user interfaces require a team of administrators, and/or customer service telephone calls to fully utilize powerful features of a communication interface. Traditional prior art systems sacrifice functionality for ease of use or provide more functionality at the expense of making a difficult and overly complex user interface. In fact, prior art user interfaces have been unable to create a user interface that is simple to use while still providing high functionality. Some, traditional prior art systems add more features, without simplifying the user interface to make the features easy to use. Other prior art systems attempt to simplify the user interface, but, in so doing, eliminate many user-desired functions. The lack of an easy-to-use interface that also provides high functionality is undesirable.

Additionally, modern uses of automation technology include so-called chat bots, ecommerce sites, and AI-based transactional systems. An example of an AI-based transactional system is Google Assistant or Amazon Alexa to name a few.

The primary motivation for small or large companies to automate dialogs and transactions between their companies and their human customers is to save money. The cost of contact center infrastructure, and its employees who act as “agents” or customer service representatives, is daunting. It is not uncommon for the cost of a long customer service call to be twenty dollars or more accounting for cost of carriage, infrastructure, hourly wages and benefits. On the other hand, a complex transaction that may cost twenty dollars or more with human intervention can be handled in an automated way for under a dollar. It is therefore no surprise that, according to the Deloitte 2017 Global Contact Center Survey Results, 33% of managers who operate contact centers plan to invest in robotics and process automation in the next 2 years.

To the dismay of many enterprises who have explored the idea of automating dialogs on web sites, mobile smart phone applications and Facebook Business Pages, for example, the cost of initial deployment is often insurmountable. Ironically, even though the end result of deploying a “chat bot” is in fact some level of automation, the deployment of same is nowhere near automatic. At present, the state of the art in bot or other automation deployments is almost completely manual. That is to say that both consulting and technical professional services are required to deploy an automation system.

These problems combined add up to a serious problem for those enterprises who seek to automate transactions for their customers. In summary, most enterprises simply do not have the time or money to pay for automation. Ironically, the deployment of automation systems is simply not automatic. It is fraught with manually-intensive and expensive work.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates an exemplary customer management system with auto-provisioning AI-based dialogs according to a preferred embodiment;

FIG. 2 illustrates the system administrator of FIG. 1 in greater detail according to an embodiment;

FIG. 3 illustrates the end user system of FIG. 1 in greater detail according to an embodiment;

FIG. 4 illustrates the entities of FIG. 1 in greater detail according to an embodiment;

FIG. 5 illustrates a user interface according to an embodiment;

FIG. 6 illustrates an exemplary method of an account setup according to an embodiment;

FIGS. 7A-7I illustrate an account setup wizard according to an embodiment;

FIGS. 8A-8G illustrate a user overview wizard according to the user interface of FIG. 5;

FIG. 9 illustrates an exemplary method of an accordion function;

FIGS. 10A-10D illustrate a locations overview wizard according to the user interface of FIG. 5;

FIGS. 11A-11B illustrate an advanced routing wizard according to the user interface of FIG. 5;

FIG. 12 illustrates a device wizard according to the user interface of FIG. 5;

FIGS. 13A-13C illustrate a call centers wizard according to the user interface of FIG. 5;

FIGS. 14A-14C illustrate a settings wizard according to the user interface of FIG. 5;

FIGS. 15A-15B illustrate an account wizard according to the user interface of FIG. 5;

FIGS. 16A-16B illustrate a user portal according to the user interface of FIG. 5;

FIG. 17 illustrates an example system for auto-provisioning AI-based (artificial intelligence based) dialogs; and

FIG. 18 diagrammatically depicts the arrangement of FIGS. 18A and 18B, of which FIG. 18A shows a first part of a process or logic flow for credentialization and provisioning and FIG. 18B shows a second part of the process.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

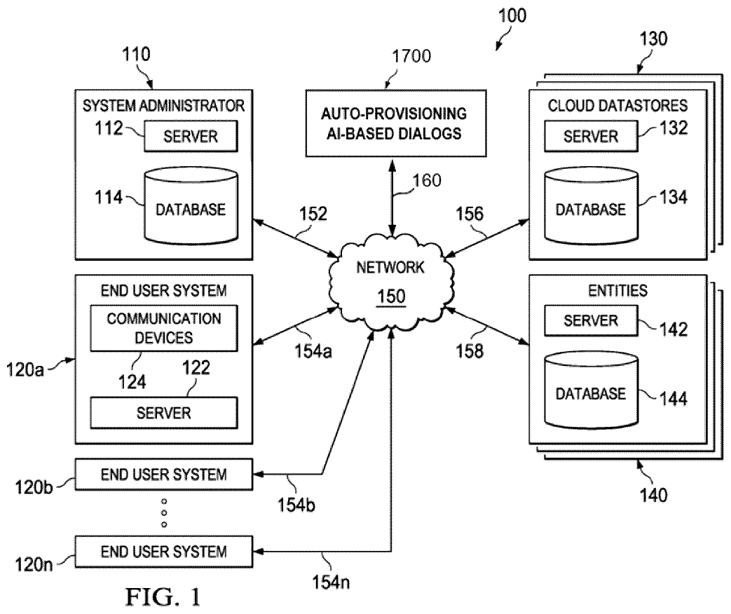

FIG. 1 illustrates an exemplary customer management system 100, according to a preferred embodiment. Customer management system 100 comprises a system administrator 110, one or more end user systems 120a-n, one or more cloud datastores 130, one or more entities 140, an auto-provisioning AI-based dialogs 1700, network 150, and communication links 152, 154a-n, 156, 158 and 160. Although a single system administrator 110, one or more end user systems 120a-n, one or more cloud datastores 130, one or more entities 140, an auto-provisioning AI-based dialogs 1700, a single network 150, and communication links 152, 154a-n, 156, 158 and 160 are shown and described; embodiments contemplate any number of system administrators 110, end user systems 120a-n, cloud datastores 130, entities 140, auto-provisioning AI-based dialogs 1700, networks 150, or communication links 152, 154a-n, 156, 158 and 160 according to particular needs.

In one embodiment, system administrator 110 comprises server 112 and database 114. Server 112 is programmed to access, update and provide system administration, system updating, interface hosting, database management, auto-provisioning AI-based (artificial intelligence based) dialogs 1700 associated with one or more end user systems 120a-n, one or more cloud datastores 130, and/or one or more entities 140, as discussed below in more detail. Database 114 comprises one or more databases or other data storage arrangements at one or more locations, local to, or remote from, system administrator 110. In one embodiment, one or more databases 114 is coupled with one or more servers 112 using one or more local area networks (LANs), metropolitan area networks (MANs), wide area networks (WANs), network 150, such as, for example, the Internet, or any other appropriate wire line, wireless, or any other communication links. One or more databases 114 stores data that is made available and may be used by one or more servers 112 according to the operation of customer management system 100.

In one embodiment, one or more end user systems 120a-n comprises an end user system such as, for example, a customer, buyer, seller, retailer, or any other business or enterprise coupled with one or more entities 140. Each of the one or more end user systems 120a-n comprises one or more communication devices 124. In addition, or as an alternative, each communication device 124 provides one or more end user systems 120a-n with a channel of communication between each of the one or more end user systems 120a-n and one or more entities 140. One or more end user systems 120a-n may be coupled with one or more entities 140 by network 150 via communication links 154a, 154b, and 154n.

According to an embodiment, one or more cloud datastores 130 comprises any server, system, or data arrangement that performs any one of the function described in connection with system administrators 110. One or more cloud datastores 130 comprise server 132 and database 134 that may comprise any database or datastore that replicates or works in connection with system administrator 110 and/or auto-provisioning AI-based (artificial intelligence based) dialogs 1700 according to any suitable distributed computing or remote data storage configuration.

In an embodiment, one or more entities 140 may be any entity, such as, for example, a business, company, enterprise, distributor, retailer, call-center, CRM specialist system, customer service system, help desk system, telephone or media service, social media service (such as FACEBOOK, TWITTER, or the like) or any entity which communicates with customers, either its own customers or the customers of another entity 140. One or more entities 140 may operate on one or more computers comprising one or more servers 142 and one or more databases 144 or other data storage arrangements at one or more locations which are integral to or separate from the hardware and/or software that support customer management system 100. These one or more entities 140 utilize customer management system 100 in order to monitor, score, and analyze the interactions and communications between one or more end user systems 120a-n and one or more entities 140.

According to some embodiments, one or more entities 140 comprise communication services such as an email service provider, VOIP or telephony provider, or any provider of communications. According to these embodiments, the communication services interact with other entities 140 to provide all the services indicated below with respect to entities. As an example only and not by way of limitation, an entity 140 that is a call-center may use the email and/or telephone services of another entity 140 which is a communication service. According to these embodiments, some data may be stored at one or more databases 144 of one or more entities 140 as indicated above and channels between one or more end user systems 120a-n may pass between one or more end user systems 120a-n and any one or more entities 140.

Auto-provisioning AI-based dialogs 1700 provide chat bots and other artificial intelligence-based dialog services including, but not limited to, the automatic provisioning of voice or text-based dialogs between one or more entities 140 and one or more customers on a plurality of platforms and a plurality of communication channels including social engagement timelines, smart phone applications, and web sites. Auto-provisioning AI-based dialogs 1700 includes “Provider/Coordinator” services, “Microservices” and “Third Party Resources”, as described in detail further below. Further as discussed in more detail below, one or more entities 140 may utilize auto-provisioning AI-based (artificial intelligence based) dialogs 1700 to interact with customers.

System administrator 110 including server 112 and database 114 is coupled with network 150 using communications link 152, which may be any wireline, wireless, or other link suitable to support data communications between system administrator 110 and network 150. One or more end user systems 120a-n is coupled with network 150 using communications links 154a-n, which may be any wireline, wireless, or other link suitable to support data communications between one or more end user systems 120a-n and network 150. One or more cloud datastores 130 including server 132 and database 134 may be coupled with network 150 using communications link 156, which may be any wireless or other link suitable to support data communications between one or more cloud datastores 130 and network 150. One or more entities 140 including server 142 and database 144 may be coupled with network 150 using communications link 158, which may be any wireless or other link suitable to support data communications between one or more entities 140 and network 150. Auto-provisioning AI-based dialogs 1700 may be coupled to network 150 using communications link 160 and/or communication bus 1705.

Although communication links 152, 154a-n, 156, 158 and 160 are shown as generally coupling system administrator 110, one or more end user systems 120a-n, one or more cloud datastores 130, one or more entities 140 and auto-provisioning AI-based dialogs 1700 with network 150, system administrator 110, one or more end user systems 120a-n, one or more cloud datastores 130, one or more entities 140 and auto-provisioning AI-based dialogs 1700 may communicate directly with each other according to particular needs.

In an embodiment, network 150 includes the Internet, telephone lines, any appropriate local area networks LANs, MANs, or WANs, and any other communication network coupling system administrator 110, one or more end user systems 120a-n, one or more cloud datastores 130, one or more entities 140 and auto-provisioning AI-based dialogs 1700. For example, data may be maintained by system administrator 110 or at one or more locations external to system administrator 110 and/or and made available to system administrator 110, one or more end user systems 120a-n, one or more cloud datastores 130, one or more entities 140 and auto-provisioning AI-based dialogs 1700 using network 150 or in any other appropriate manner. Those skilled in the art will recognize that the complete structure and operation of communication network 150 and other components within customer management system 100 are not depicted or described. Embodiments may be employed in conjunction with known communications networks and other components.

In one embodiment, system administrator 110, one or more end user systems 120a-n, one or more cloud datastores 130, one or more entities 140 and/or auto-provisioning AI-based dialogs 1700 may each operate on one or more computers or computer systems that are integral to or separate from the hardware and/or software that support customer management system 100. In addition or as an alternative, one or more users, such as end users or representatives, may be associated with customer management system 100 including system administrator 110, one or more end user systems 120a-n, one or more entities 140 and/or auto-provisioning AI-based dialogs 1700. These one or more users may include, for example, one or more computers programmed to autonomously configure, manage, and provide communications between system administrator 110, one or more end user systems 120a-n, one or more entities 140, auto-provisioning AI-based dialogs 1700 and/or one or more related tasks within customer management system 100. As used herein, the term “computer” or “computer system” includes any suitable input device, such as a keypad, mouse, touch screen, microphone, or other device to input information. Any suitable output device that may convey information associated with the operation of customer management system 100, including digital or analog data, visual information, or audio information. Furthermore, the computer includes any suitable fixed or removable non-transitory computer-readable storage media, such as magnetic computer disks, CD-ROM, or other suitable media to receive output from and provide input to customer management system 100. The computer also includes one or more processors and associated memory to execute instructions and manipulate information according to the operation of customer management system 100.

In one embodiment and as discussed in more detail below, customer management system 100 provides a simplified user interface for setting up, configuring, managing, and providing telecommunications within customer management system 100. Customer management system 100 provides a user interface of the current disclosure that is easy to use while also maintaining a high level of functionality. According to an embodiment, customer management system 100 provides a user interface that sets up, manages, configures, and provides communications utilizing one or more communication platforms, such as, for example, BROADSOFT™ telecommunication service or HOMEGROWN SOLUTIONS™ telecommunication service to provide communications between system administrator 110, one or more end user systems 120, and/or one or more entities 140.

As will be explained in more detail below, a user interface of customer management system 100 provides interface tools that are easy to access from local or remote locations and is configured to reduce the number of actions and time to perform set up and configuration of customer management system 100. According to some embodiments, the user interface of customer management system 100 is located at one or more servers 112, 122, 132, and 142 or remotely accesses servers through each communication device 124 using a communication protocol over network 150. According to embodiments, each communication device 124 may be assigned one or more identification numbers, such as IP addresses, that may be used to identify a communication device 124 at a fixed location in network 150 or to identify a communication device 124 as they are moved to different access points in network 150. According to these embodiments, communication devices 124 are associated with a user such that each communication device 124 will act the same no matter where it is connected in network 150. According to another embodiment, a user may associate each communication device 124 with the user's account, such that any features of that user's account may be accessed by any communication device 124 associated with the user.

For example, a user may connect a telephone, or other communication device 124, directly to network 150 through the computer, or directly to network 150. In addition, or as an alternative, customer management system 100 recognizes with an identification number (such an IP address) associated with communication device 124 regardless to where in network 150, it is connected.

According to some embodiments, system administrator 110 stores all configurations, settings, features, and functions associated with communication device 124 which provides for unplugging a communication device 124 from a first location, taking it to a second location, with the same configurations, settings, features, and functions, including the same phone number. According to some embodiments, communication device 124 may be location aware such that the configurations, settings, features, and functions associated with communication device 124 change automatically based on where or how communication device 124 connects to network 150.

According to some embodiments, each communication device 124 is associated with an identification number, such as an IP or MAC address, such that regardless of where communication device 124 is connected in network 150, system administrator 110 recognizes communication device 124 and associates configuration data 204 with that communication device 124.

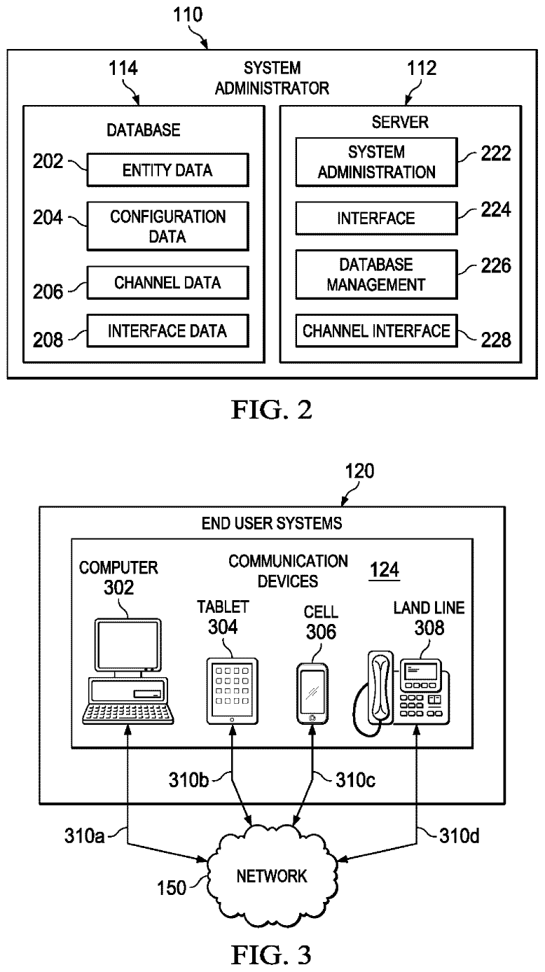

FIG. 2 illustrates system administrator 110 of FIG. 1 in greater detail, according to an embodiment. As discussed above, system administrator 110 comprises one or more computers at one or more locations including associated input devices, output devices, non-transitory computer-readable storage media, processors, memory, or other components for configuring, managing, and providing communications according to the operation of customer management system 100. In addition, and as discussed in more detail below, system administrator 110 comprises server 112 and database 114. Although system administrator 110 is shown and described as comprising a single computer, server 112 and database 114; embodiments contemplate any suitable number of computers, servers or databases internal to or externally coupled with system administrator 110. In addition, or as an alternative, system administrator 110 may be located internal to one or more entities 140. In other embodiments, system administrator 110 may be located external to one or more entities 140 and may be located in, for example, a corporate or regional entity of the one or more entities 140, according to particular needs.

Server 112 comprises system administration 222, interface 224, database management 226 and channel interface 228. Although a particular configuration of server 112 is shown and described; embodiments contemplate any suitable number or combination of these, located at one or more locations, local to, or remote from, system administrator 110, according to particular needs. In addition, or as an alternative, administration 222, interface 224, database management 226 and channel interface 228 may be located on multiple servers or computers at any location in customer management system 100.

Database 114 of system administrator 110 comprises entity data 202, configuration data 204, channel data 206 and interface data 208. Although, database 114 is shown and described as comprising entity data 202, configuration data 204, channel data 206 and interface data 208; embodiments contemplate any suitable number or combination of these, located at one or more locations, local to, or remote from, system administrator 110, according to particular needs.

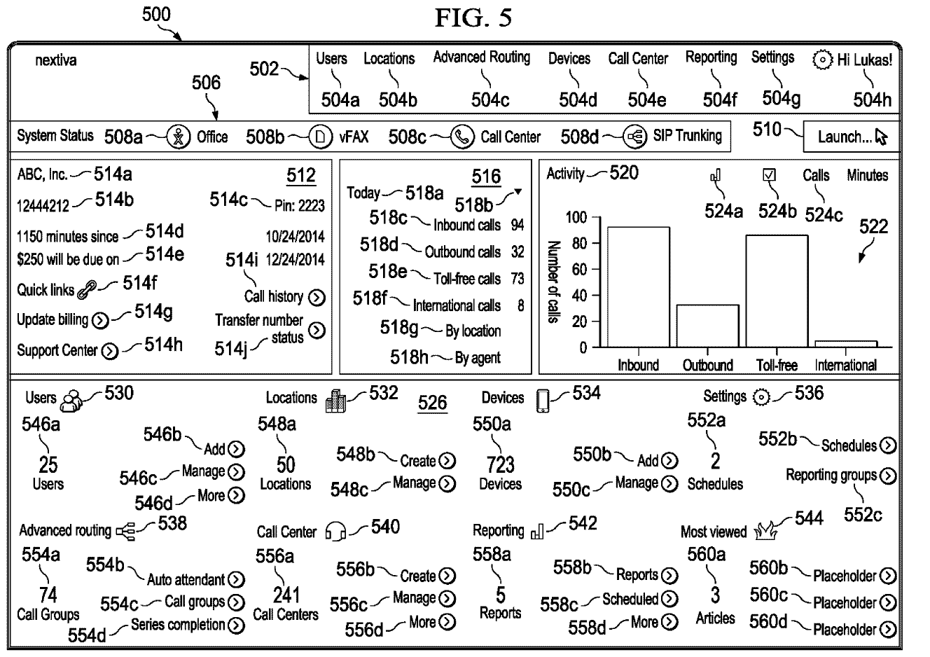

Entity data 202 of database 114 describes the identification information of one or more entities 140 of customer management system 100. Entity data 202 comprises identification information, such as, for example, names, addresses, company, phone numbers, email, IP addresses, and the like. In one embodiment, entity data 202 is used by system administration 222 to identify one or more entities 140 in customer management system 100 to generate particular configurations of customer management system 100 specific to each of the one or more entities 140. As an example only and not by way of limitation, where one or more entities 140 is a customer service center, the identification information stored in entity data 202 permits system administrator 110 to generate a particularized user interface specific to the customer service center. Specifically, system administration 222 provides a particularized user interface specific to the industry of entity 140, the types of customers served by one or more entities 140, and/or the types of products sold by one or more entities 140. For example, particularized user interfaces may comprise a different arrangement of elements on user interface 500 (See FIG. 5). In one embodiment, the particularized user interfaces are stored in, for example, configuration data 204.

Configuration data 204 of database 114 comprises data which describes the various functionalities of customer management system 100 useful to each of one or more entities 140 and one or more end user systems 120a-n. In one embodiment, configuration data 204 comprises, for example, location data that describes where the data is generated or received by system administrator 110, one or more end user systems 120a-n, cloud datastores 130 and/or one or more entities 140. In another embodiment, configuration data 204 comprises settings and parameters that describe the system-level functioning of customer management system 100.

Channel data 206 of database 114 comprises the organization and setup of channel interface 228. According to some embodiments, channel data 206 comprises the particular communication channels which are open to a particular end user system 120a-n or entity 140, the times which the communication channels are open, the protocols or metadata which describe the communication, and/or any other configuration data and setup data necessary to configure channel interface 228. Interface data 208 of database 114 comprises the configuration, setup, and display data of user interface 224.

System administration 222 of server 112 may configure, update, and/or administer customer management system 100. That is, system administration 222 may provide services to configure the operation of customer management system 100 and change which data is executed and/or stored on system administrator 110, one or more end user systems 120a-n, and/or one or more entities 140. Embodiments contemplate a user-configurable customer management system 100, such that the data may be stored either singularly or redundantly on system administrator 110, one or more end user systems 120a-n, and/or one or more entities 140, according to particular needs. In addition, or as an alternative, system administration 222 receives, processes, updates, creates, and stores entity data 202 and configuration data 204.

Interface 224 of server 112 generates a user interface, such as user interface 500, described in more detail below. Various features of interface 224 include: generating charts, storing and retrieving historical data of customer relationship management, displaying notifications and/or escalations, and creating and managing calendars. Interface 224 stores and retrieves data from database 114 including entity data 202, configuration data 204, channel data 206, and interface data 208.

Database management 226 of server 112 provides a data sorting, retrieval, duplication, backup, creation and/or interface manager for data stored in database 114 to efficiently provide data to end user system 120a-n and one or more entities 140 and manage the data generated from various components of customer management system 100 that are stored in database 114. According to some embodiments, database management 226 organizes and stores the various types of data generated from customer management system 100 to provide real-time access of the data on database 114 to operate customer management system 100.

Channel interface 228 of server 112 generates, receives, and monitors communication between one or more entities 140 and one or more end user systems 120a-n. For example, channel interface 228 comprises one or more of VOIP, email, internet or web-based chat, and/or other types of communication systems useful for allowing an end user system 120a-n to contact one or more entities 140 or one or more entities 140 to contact other entities 140. For example, channel interface 228 initiates or receives communication to communication devices 124 of one or more end user systems 120a-n. In addition, channel interface 228 records the time, duration, date, voice, text, and other information transmitted. Alternatively or in addition, channel interface 228 may utilize the third party protocol gateway 1704, as described in further detail below, for communicating with (but not limited to) one or more third party ACD (Automatic Call Distributor), email delivery platform, SMS/Text gateway, chat platform, web site, or social site.

FIG. 3 illustrates one or more end user systems 120a-n of FIG. 1 in greater detail according to an embodiment. One or more end user systems 120a-n each comprise communication devices 124, network 150 and communication links 310a-d and 314. As discussed above, each of one or more end user systems 120a-n comprise one or more computers at one or more locations including associated input devices, output devices, non-transitory computer-readable storage media, processors, memory, or other components that provide one or more end user systems 120a-n with a channel of communication between each of one or more end user systems 120a-n and one or more entities 140, according to the operation of customer management system 100. Although one or more end user systems 120a-n is shown and described as comprising a single computer, communication devices 124 and communication links 310a-d and 314 coupling one or more end user systems 120 to network 150; embodiments contemplate any suitable number of computers, servers or communication devices internal to or externally coupled with network 150.

Communication devices 124 comprise computers 302, tablet-type devices 304, smartphones 306 and land-line phones 308. Although particular communication devices are shown and described; embodiments contemplate any suitable communication device, according to particular needs. In one embodiment, computers 302, tablet-type devices 304, smartphones 306 comprise a processor, memory and data storage. The processor may execute an operating system program stored in memory to control the overall operation of computers 302, tablet-type devices 304, smartphones 306. For example, the processor may control the reception of signals and the transmission of signals within customer management system 100. The processor may execute other processes and programs resident in memory, such as, for example, registration, identification or communication and transferring data into or out of the memory, as required by an executing process.

Those skilled in the art will recognize that one or more specific examples of end user systems 120a-n are given by way of example and that for simplicity and clarity, only so much of the construction and operation of end user systems 120a-n as is necessary for an understanding of the present invention is shown and described. Moreover, it is understood that one or more end user systems 120a-n should not be construed to limit the types of communication devices in which embodiments of the present invention may be implemented. For example, one or more end user systems 120a-n may be any device, including, but not limited to, conventional cellular or mobile telephones, smart mobile phones, an IPHONE™, an IPAD™, wireless tablet devices, paging devices, personal digital assistant devices, short message service (SMS) wireless devices, portable computers, or any other device capable of wireless or network communication.

In addition, or as an alternative, system administrator 110, and/or one or more entities 140 and/or auto-provisioning AI-based dialogs 1700 provides one or more end user systems 120a-n access to one or more entities 140 in order to communicate over one or more channels. Among other things, embodiments enable customer service, such as troubleshooting and product set up, maintenance requests, refunds, providing product information, scheduling routine maintenance, requesting on-site maintenance, walk-throughs, company information, sales, taking purchase orders, scheduling meetings, changing passwords, website help, and the like. Among other things, embodiments enable interactions with customers using AI-powered bots as provided by auto-provisioning AI-based dialogs 1700, as discussed in greater detail below. For example, auto-provisioning AI-based dialogs 1700 may provide customer interaction with an AI powered bot on a customer website, where the bot interaction may, based on the operation of auto-provisioning AI-based dialogs 1700, escalate to interaction with a human customer service representative (CSR). In other embodiments, auto-provisioning AI-based dialogs 1700 may provide an AI-based set of frequently asked questions (FAQ) on a customer website and/or in a customer application, where the FAQ is based, at least in part, on AI-based analysis of customer interactions.

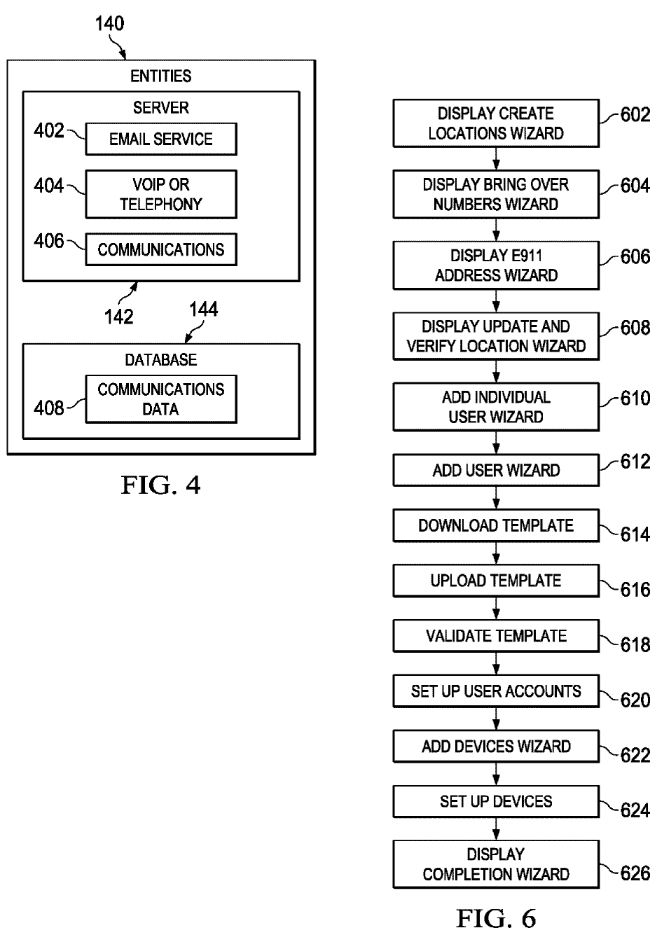

FIG. 4 illustrates one or more entities 140 of FIG. 1 in greater detail, according to an embodiment. As discussed above, one or more entities 140 comprises one or more computers at one or more locations including associated input devices, output devices, non-transitory computer-readable storage media, processors, memory, or other components for monitoring, scoring, and analyzing the interactions and communications between one or more end user systems 120a-n and one or more entities 140. In addition, and as discussed above, one or more entities 140 may be any entity, such as, for example, a business, company, enterprise, distributor, retailer, call-center, CRM specialist system, customer service system, help desk system, telephone or media service, website, application, social media service (such as FACEBOOK, TWITTER, or the like) or any entity which communicates with customers, either its own customers or the customers of another entity 140.

One or more entities 140 comprise server 142 and database 144. Although one or more entities 140 is shown and described as comprising a single computer, server 142 and database 144; embodiments contemplate any suitable number of computers, servers or databases internal to or externally coupled with one or more entities 140. In addition, or as an alternative, one or more end user systems 120a-120n may be located internal or external to one or more entities 140, such as, for example, a corporate or regional entity of one or more entities 140, according to particular needs.

Server 142 of one or more entities 140 comprises one or more communication services, such as, for example, email service 402, VOIP or telephony 404, and communications 406. Although a particular configuration of server 142 is shown and described; embodiments contemplate any suitable number or combination of these, located at one or more locations, local to, or remote from, one or more entities 140, according to particular needs. In addition, or as an alternative, email service 402, VOIP or telephony 404, and communications 406 may be located on multiple servers or computers at any location in customer management system 100.

Database 144 of one or more entities 140 comprises communications data 408. Although, database 144 is shown and described as comprising communications data 408; embodiments contemplate any suitable number or combination of these, located at one or more locations, local to, or remote from, one or more entities 140, according to particular needs.

According to some embodiments, one or more communication services associated with server 142, interact with other entities 140 to provide communication services. For example, an entity 140 that is a call-center may use email service 402 and communications data 408 of another entity 140 or use VOIP or telephony 404 services and communications data 408 of another entity. Likewise, an entity 140 may use communications 406 and communications data 408 of another entity, according to particular needs. According to these embodiments, data may be stored at communications data 408 of one or more entities 140 as indicated above and channels between one or more end user systems 120a-n may pass between one or more end user systems 120a-n and any one or more entities 140.

FIG. 5 illustrates user interface 500 according to an embodiment. User interface 500 comprises taskbar 502, status bar 506, quick launch button 510, account summary 512, call summary 516, activity summary 520, and dashboards 526. Although user interface 500 is shown and described as comprising a particular taskbar 502, status bar 506, quick launch button 510, account summary 512, call summary 516, activity summary 520, and dashboards 526; embodiments contemplate any suitable number or types of taskbars, status bars, buttons, summaries or dashboards, according to particular needs.

In one embodiment, one or more end user systems 120a-120n of customer management system 100 access user interface 500 to monitor, modify, and navigate customer management system 100 generated by interface 224 of server 112. As an example only and not by way of limitation, user interface 500 provides one or more end user systems 120a-120n with summaries, statistics, and charts illustrating use and status of, for example, a telecommunication system.

In other embodiments, user interface 500 provides access to high functionality, while providing a simplified and intuitive interface with viewing of information of customer management system 100, with one click access from login to access one or more features of customer management system 100. This provides quick access to high functionalities while providing a complete overview of an account in an intuitive way.

As will be discussed in more detail below, user interface 500 comprises a main information screen for a user login to user interface 500. User interface 500 may provide status and information about various wizard functionalities. According to an embodiment, status is received from a status system via an Application Program Interface (API) across one or more, or all, of the wizards or functionalities associated with user interface 500. Embodiments of the present disclosure provide a user with a quick and easy insight of the user interface system through user interface 500.

Taskbar 502 of user interface 500 comprises one or more user-selectable top-level menu choices 504a-504h. That is, taskbar 502 comprises users 504a, locations 504b, advanced routing 504c, devices 504d, call center 504e, reporting 504f, settings 504g, and user-selectable menu choice for adjusting log-in and user settings 504h. When top-level menu choice 504a-504h is selected from taskbar 502, user interface 500 is updated to display content representing that selection. For example, when users 504a is selected from taskbar 502, user interface 500 main wizard is replaced with user submenu wizard 600 (See FIG. 6). When other top-level menu choices 504a-504h are selected, the user interface 500 main wizard is replaced with the associated submenu wizard, as described more fully below.

According to some embodiments, taskbar 502 links to an overview wizard for one or more wizards, functions, or features of customer management system 100. For example, embodiments of the present disclosure provide a user a one click method to access any feature of function of the user interface system. According to an embodiment, a user of customer management system 100 can manage one or more other users of the system with, for example, a single input of the user interface system, such as a single click of a mouse. This provides for easy access to tools and general overviews of wizards.

Status bar 506 of user interface 500 comprises system status indicators 508a-508d, which illustrate the status of one or more subsystems of customer management system 100. For example, system status indicators 508a-508d may comprise a label and a button, wherein the color of the button indicates a status of the system. System labels may comprise, for example, “Office,” “vFAX,” “Call Center,” and “SIP Trunking.” Colors of the buttons may comprise, for example, green for a fully-functioning subsystem, yellow for a partially-functioning subsystem, and/or orange for an inactive subsystem.

Quick launch button 510 of user interface 500 comprises a user-selectable drop-down box that links to one or more submenus, features, or system configuration menus of user interface 500.

Account summary 512 of user interface 500 comprises an information summary of account information related to the currently logged-in account. Account information may be compiled from one or more databases of system administrator 110, one or more end user systems 120a-120n, and/or one or more entities 140. Such information of account summary 512 may comprise, for example, company name 514a, account number 514b, personal identification number (PIN) 514c, minutes used since a previous date 514d, account balance for a future date 514e, quick links configuration button 514f, update billing quick link 514g, support center quick link 514h, call history quick link 514i, and transfer number status quick link 514j. Although particular information and links are shown and described; embodiments contemplate any suitable information or quick links and any suitable arrangement of the same, according to particular needs.

Call summary 516 of user interface 500 comprises an information summary of call information related to the currently logged-in account. Call summary 516 comprises information sorted according to a time period 518a that may be user-adjusted by a time period drop down selection tab 518b. Based on time period 518a selected, call summary 516 displays call information according to the time period. For example, time period 518a selected in FIG. 5 is “today.” In addition or as an alternative, call summary 516 may display call information or call history. For example, a dropdown box provides a selection box for one or more of “today,” “yesterday,” “last seven days,” “last 30 days,” and other like time periods. In addition, the call information may comprise the number of inbound calls 518c, outbound calls 518d, toll-free calls 518e, international calls 518f, calls by location 518g, and calls by agent 518h. Although the call information is shown and described as the number of calls; embodiments contemplate any call information or combination of call information, according to particular needs.

Activity summary 520 of user interface 500 comprises customizable charts and graphs that display the information of call summary 516 according to one or more user-selectable configurations. For example, activity summary 520 comprises chart 522 that display the number of calls for each of inbound calls, outbound calls, toll-free calls, and international calls. This call information may be configured to display different types of charts or graphs and different types of call information. For example, activity summary 520 comprises a chart selection tool 524a, an activity configuration button 524b, and a units selector 524c. Chart selection tool 524a comprises a drop down box that permits a user to select a different type of chart or graph, such as, for example, pie charts, line charts, bar charts, tables, or the like. In response a selection of a different type of chart or graph, chart 422 of activity summary 520 displays a presentation of information according to the selection. In one embodiment, activity configuration button 524b comprises a link to a configuration of activity information such as selecting what type of information to present, how that information is presented, or other configuration options, according to particular needs. In another embodiment, unit selector 524c permits a selection of what units the information in chart 522 is displayed in. According to the illustrated example, unit selector 524c permits a selection between calls and minutes; however embodiments contemplate any suitable units and any suitable presentation of information, such as dollars, time period, number of users, locations, devices, customers, or any like unit necessary for the presentation of call information. In embodiments, activity summary 520 of user interface 500 may comprise customizable charts and graphs obtained from reports rendering server 1706, as described in further detail below. Reports rending server 1706 may, in some embodiments, provide reporting templates for use and/or display by activity summary 520 of user interface 500.

Dashboards 526 of user interface 100 comprises users dashboard 530, locations dashboard 532, devices dashboard 534, settings dashboard 536, advanced routing dashboard 538, call center dashboard 540, reporting dashboard 542, and most viewed dashboard 544. Although dashboards 526 is shown and described as comprising particular dashboards; embodiments contemplate any suitable number or types of dashboards, according to particular needs. In addition, or as an alternative, as disused above, taskbar 502 comprises one or more user-selectable top-level menu choices 504a-504h that link to one or more dashboards 526.

According to an embodiment, dashboards 530-544 of user interface 500 correspond to high-level functionalities or other interfaces or wizards of customer management system 100. That is, dashboards 530-544 may provide one or more of the most commonly used features and one or more scores. As an example only and not by way of limitation, user score 546a for users dashboard 530 indicates the number of users set up on customer management system 100. According to some embodiments, a score represents the number of activities, the forms, or other functions within the interface or wizard associated with dashboards 530-544. In addition, or as an alternative, each of one or more dashboards 530-544 may display information relating to one or more subwizards associated with the dashboard and may comprise links to configuration settings or features associated with the subwizards. In addition, or as an alternative, dashboards 530-544 may access analytics server 1707 and display one or more analytics associated with customers and/or customer interactions.

For example, users dashboard 530 may comprise a user count 546a, an add user link 546b, a manager users link 546c, and a more users link 546d. Locations dashboard 532 may comprise a locations count 548a, a create locations link 548b, and a manage locations link 548c. Devices dashboard 534 may comprise a devices count 550a, a add devices link 550b, and a manage devices link 550c. Settings dashboard 536 may comprise a schedules count 552a, a schedules link 552b, and a reporting groups link 552c. Advanced routing dashboard 538 may comprise a call groups count 554a, an auto attendant link 554b, a call groups link 554c, and a series completion link 554d. Call center dashboard 540 may comprise a call centers count 556a, a create call centers link 556b, a manage call centers link 556c, and a more call centers link 556d. Reporting dashboard 542 may comprise a reports count 558a, a reports link 558b, a scheduled reports link 558c, and a more reporting link 558d. Most viewed dashboard 544 may comprise an articles count 560a, a plurality of placeholder links 560a-560c. Although FIG. 5 illustrates particular dashboards in a particular order, embodiments contemplate any number or combination of dashboards according to particular needs.

FIG. 6 illustrates exemplary method 600 of an account setup according to an embodiment. Method 600 proceeds by one or more activities, which although described in a particular order may be performed in one or more permutations, according to particular needs. Method 600 may comprise one or more account setup wizards 7A-7H, according to an embodiment. In one embodiment, one or more account setup wizards 7A-7H may comprise a fast and easy-to-use user interface for setting up, for example, a phone system according to system administrator 110. In addition, or as an alternative, embodiments contemplate a guided user interface 500 that permits a user to setup a telephone system and one or more features of the telephone system according to the current disclosure.

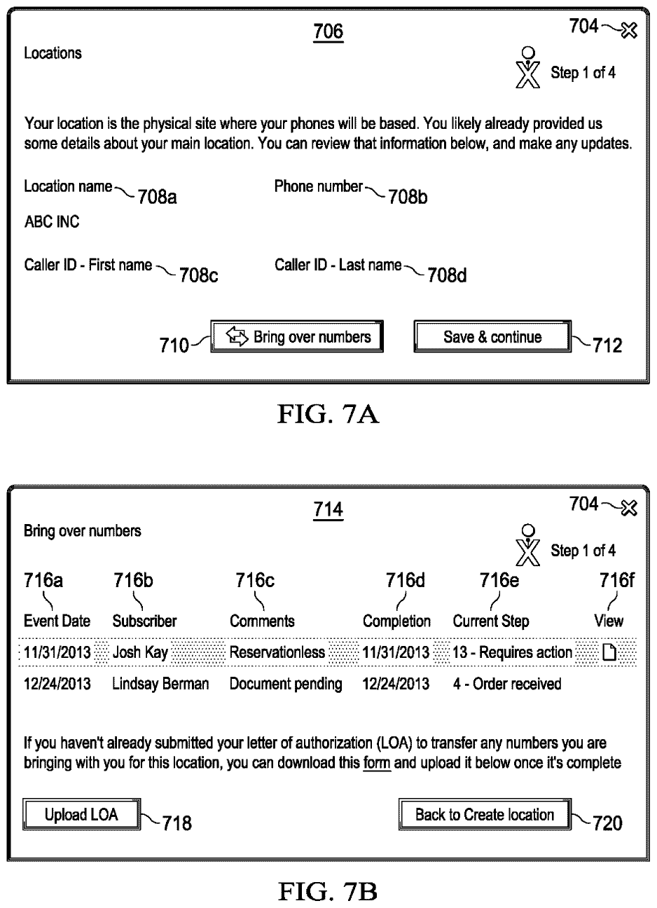

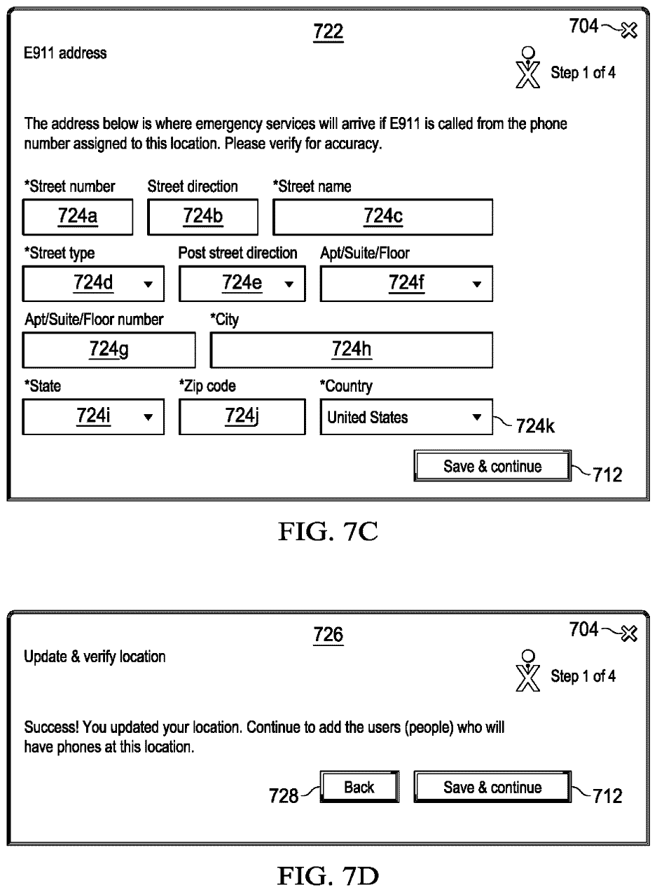

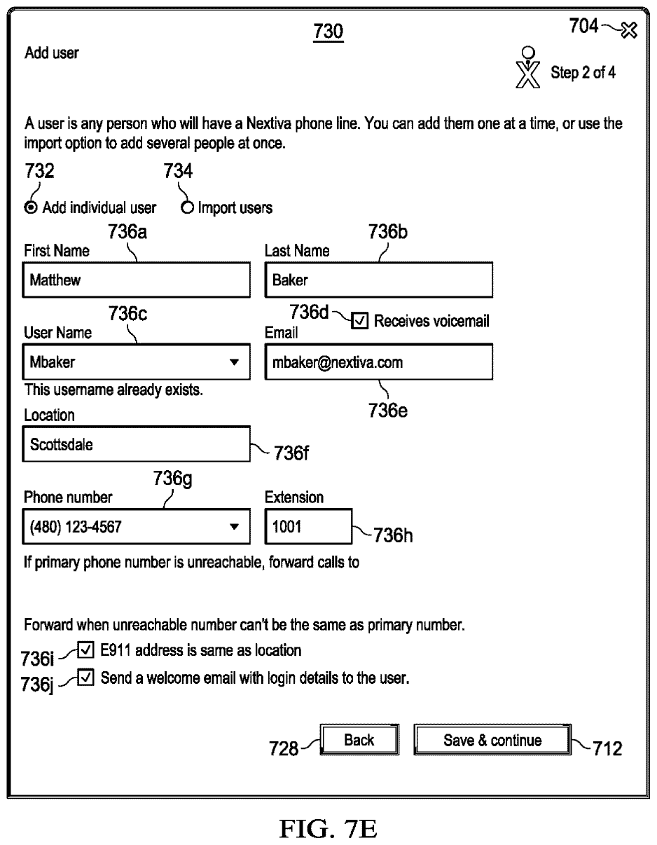

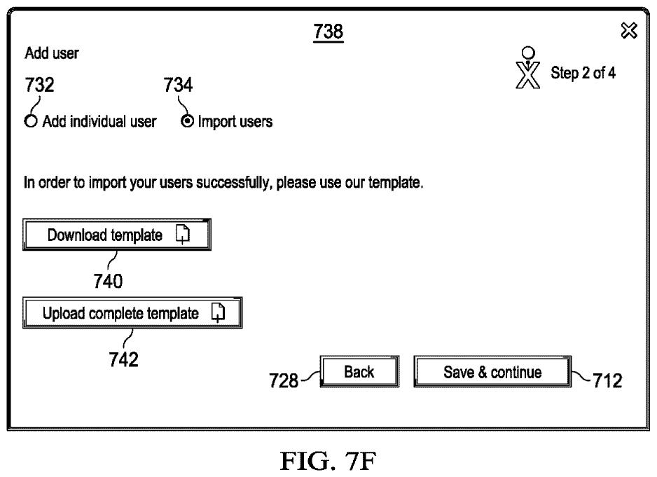

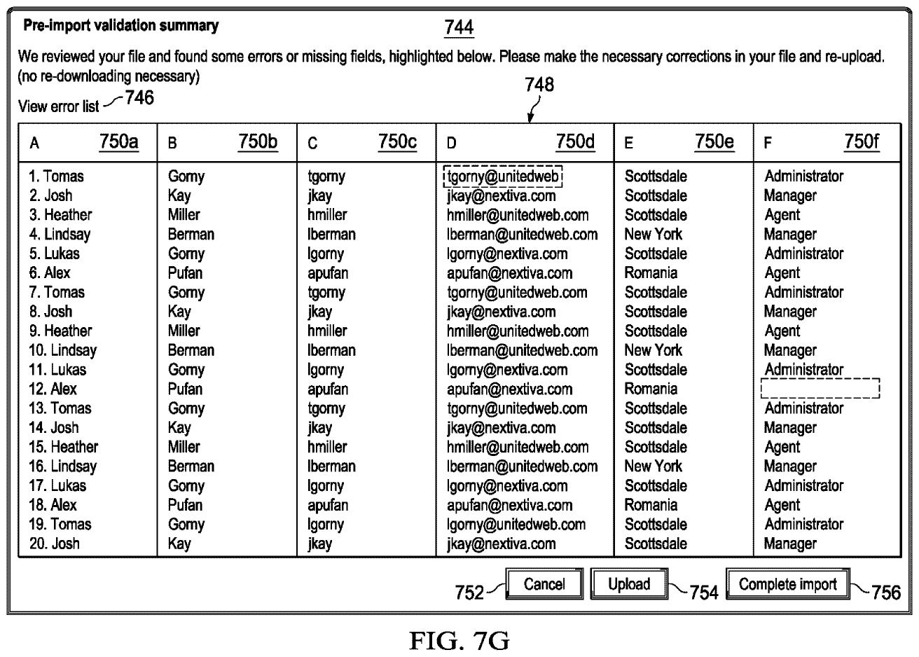

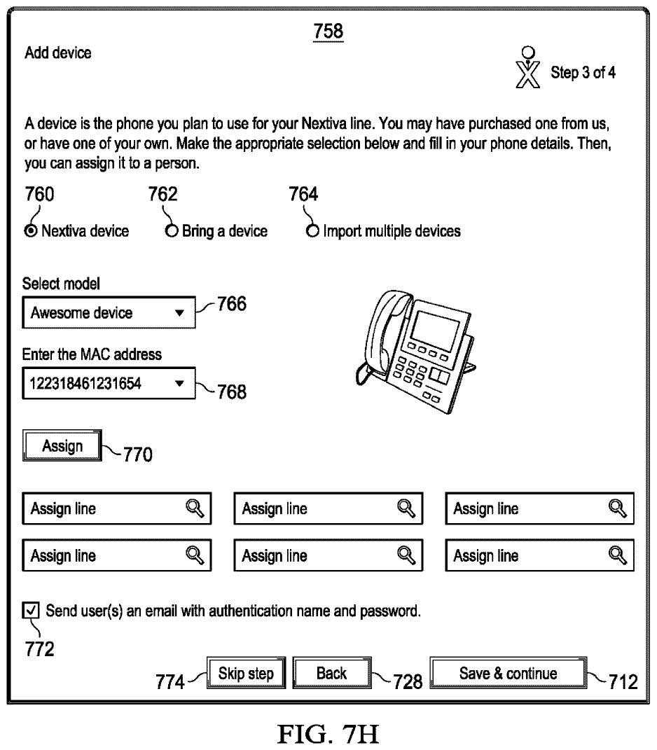

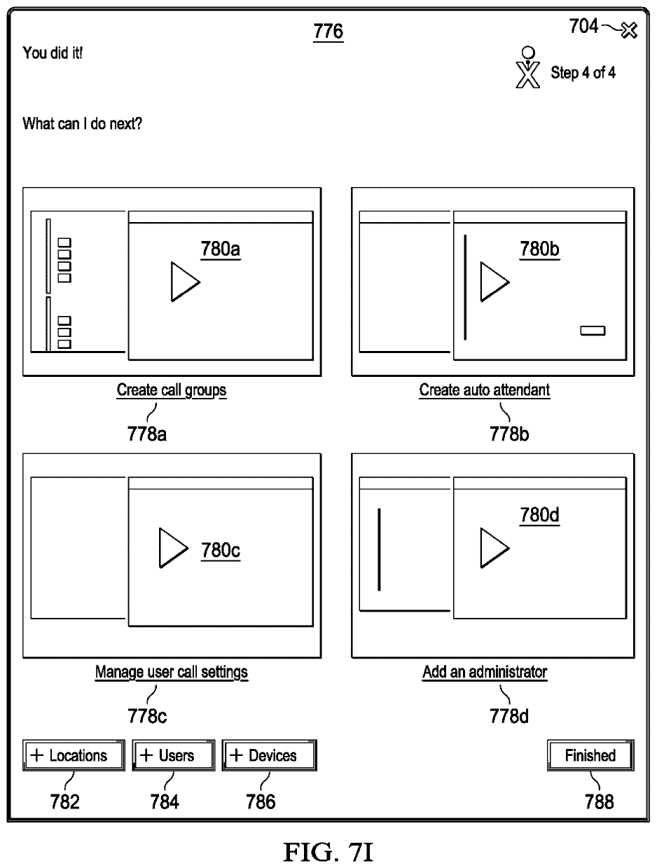

Method 600 begins at activity 602 where system administrator 110 displays locations wizard 706 (FIG. 7A) that permits the input of location information, such as, for example, location name 708a, phone number 708b, first name 708c, and last name 708d. After location data is entered, a user may select bring over numbers button 710 or save and continue button 712. In response to a selection of bring over numbers button 710, the method continues to activity 604. In addition, or as an alternative, exit button 704, may be selected at any of the one or more activities or wizards of method 600, and, in response, system administrator 110 may save or discard all or some of the entered data, according to particular needs.

At activity 604, system administrator 110 displays a bring over numbers wizard 714 (FIG. 7B) which displays the status of numbers that are ported from other communication services to system administrator 110. According to an embodiment, bring over numbers wizard 714 displays information associated with porting a number such as an event date 716a, subscriber 716b, comments 716c, completion 716d, current step 716e, and document view 716f. Upload letter of authorization (LOA) button 718 permits a user to upload an LOA that may be required to port a number from one service to another. After a user has viewed or changed information on bring over numbers wizard 714, a user may select back to create location button 720 and return to locations wizard 706. At locations wizard 706, a user may select save and continue button 712 and the method continues to activity 606.

At activity 606, system administrator 110 displays an E911 address wizard 722 (FIG. 7C) which permits a user to enter an address in address input boxes 724a-724k, which associates each communication device 124 with a physical location. In one embodiment, the physical location may be used by emergency services to locate each communication device 124. After a user has entered a physical location in address input boxes 724a-724k, the user may select save and continue button 712, and the method continues to activity 608.

At activity 608, system administrator 110 displays an update and verify location wizard 726 (FIG. 7D), which provides for adding the updated users and locations. In response to a selection of back button 728, the method returns to activity 606, and the user may make changes to previously entered information. In response to a selection of save and continue button 712, the method continues to activity 610.

At activity 610, system administrator 110 displays add user wizard 730 (FIG. 7E) which permits a user to enter information for an individual user by selection of add individual user radio button 732 or import users by selection of import users radio button 734. According to an embodiment, add individual user radio button 732 is pre-selected and add user wizard 730 displays input and checkboxes 736a-736j that permit user input of information such as first name 736a, last name 736b, username 736c, request to receive voicemail 736d, email 736e, location 736f, phone number 736g, extension 736h, request to use E911 address as the same as entered location 736i, and request to send a welcome email with login details to an entered user 736j. In addition, or as an alternative, each user may be identified by, for example, a name, telephone number, address, username, email address or the like. One or more selection boxes enable one or more features to be associated with each user. In response to a selection of back button 728, the method returns to activity 608, and in response to selection of save and continue button 712, the method continues to activity 620.

At activity 612, system administrator 110 displays add user wizard 730 (FIG. 7F) comprising a download template button 740 and an upload complete template 742. In response to a selection of a download template button, method 600 continues to activity 614, and system administrator 110 sends an import user template to one or more end user systems 120a-120n. Import user template may comprise any suitable format or file that permits a user to input or generate user information to be added for setup of an account. After one or more end user systems 120a-120n inputs information into user information template, the user may select upload complete template button 742. In response, the method continues to activity 616, and one or more end user systems 120a-120n uploads the user template to system administrator 110. The method then continues to activity 618.

At activity 618, system administrator 110 receives the completed template, performs a validation check of the information contained in the user template, and generates a user template wizard 744 (FIG. 7G). In one embodiment, user template wizard 744 permits a user to edit information, view validation errors, cancel the upload, upload the template again after changing one or more fields of information, or complete the import of user information. In addition, or as an alternative, user template wizard 744 comprises a view error list selectable element 746, user information fields 748, cancel button 752, upload button 754, and complete import button 756.

In response to a selection of a view error list selectable element 746, system administrator 110 displays a list of errors detected by system administrator 110 in the user template. Errors may comprise, for example, inconsistent information, duplicate information, pre-assigned user information, or other like errors, according to particular embodiments. In addition, a user may directly edit the user information in user information fields 748 to correct information, which may be highlighted to indicate that an error is present in a particular field of information. Such information may include, for example, first name 750a, last name 750b, username 750c, email address 750d, location 750e, and role 750f. Role 750f may indicate the position a user has within an enterprise or may indicate an access level for using customer management system 100. Roles 750f may include, for example, administrator, manager, and agent.

According to an embodiment, the user template module provides for adding many users at a single time by, for example, importing by a CSV file. According to this embodiment, a user downloads a file from system administrator 110 according to a template that is created, the user information is provided on the template, and the template is uploaded to system administrator 110. After uploading, system administrator 110 provides a pre-import validation module, which, for example, parses the import file for errors, generates error codes, finds fields which are missing information or are invalid, and permits a user to upload a new version of the CSV file or correct the errors shown. This provides for adding one, ten, hundreds, or more of users or businesses in a single simplified process. According to an embodiment, the user template module indicates the number of users added by the import file and may also indicate the number of users that were not added because of, for example, one or more errors. A user is then provided the option of downloading individually or in bulk a file to correct the information, or correcting the information directly through the module.

After one or more end user systems 120a-120n validates the information, cancel button 752, upload button 754, or complete import button 756 may be selected. In response to a selection of cancel button 752, method 600 returns to add users wizard 730 or import users wizard 738. In response to a selection of upload button 754, the method returns to activity 616 and one or more end user systems 120a-120n uploads the altered information in information fields 748 to system administrator 110. In response, the method may return to activity 618 and system administrator 110 may validate the template again.

In response to selection of complete import button 756, the method continues to activity 620 and system administrator 110 sets up user accounts for each of the users in information field 748. System administrator 110 sets up user accounts by associating user information with a user account.

At activity 622, system administrator 110 displays an add device wizard 758 (FIG. 7H). According to add device wizard 758, one or more devices may be associated with one or more users or user accounts. For example, a telephone system is selected and information about the system is input into the system. Additional devices may be added be selecting an appropriate button and other features may be added. In one embodiment, add device wizard 758 comprises system device radio button 760, bring a device radio button 762, import multiple devices radio button 764, model selection box 766, MAC address entry box 768, assign button 770, request email sent with authentication name and password box 772, and skip step selectable element 774.

When system device radio button 760 is selected, model selection box 766 may prepopulate with available models of communication devices 124 provided by customer management system 100 to one or more end user systems 120a-120n. After an appropriate model is selected, MAC address of the device is entered in MAC address entry box 768. After the model and MAC address are selected or entered, assign button 770 may be selected, and, in response, one or more end user systems 120a-120n causes the method to continue to activity 624, where system administrator 110 assigns the MAC address and device with a user of customer management system 100. When bring a device radio button 762 is selected, model selection box 766 may provide a text entry box or prepopulate with communication devices 124 that are compatible with customer management system 100. After an appropriate model is selected, MAC address of the device is entered in MAC address entry box 768. After the model and MAC address are selected or entered, assign button 770 may be selected, and, in response, one or more end user systems 120a-120n causes the method to continue to activity 626, where system administrator 110 assigns the MAC address and device with a user of customer management system 100.

When import multiple devices radio button 764 is selected, a template is downloaded to complete the necessary information, such as, for example, the MAC address, the device type and the user to assign each of the multiple devices to. Once completed, the template can be uploaded to system administrator 110.

After one or more communication devices 124 are assigned to one or more end user systems 120a-120n by system administrator 110, request email sent with authentication name and password box 772 may be selected, where system administrator 110 generates an email to be sent to an email address associated with one or more user accounts setup that will provide authentication name and password information. In addition, or as an alternative, in some instances, a communication device 124 may not be desired to be associated with a user account. According to embodiments, in this case, skip step selectable element 774 may be selected and the method will continue to activity 626, without assigning a MAC address and device with a user account.

Back button 728 may be selected to return to a previous activity, or save and continue button 712 may be selected to continue to activity 626. At activity 626, system administrator 110 displays a completion wizard 776 (FIG. 7I). According to completion wizard 776 of the setup wizard, an indication that the phone system was successfully set up, is displayed. Selection buttons at the bottom of wizard 776 permit may be selected to add more locations 782, users 784, or devices 786. In addition, or as an alternative, one or more instructional videos may be played that demonstrate, for example, how to create call groups 780a, create auto attendants 780b, manage user call settings 780c, and/or add an administrator 780d.

According to an embodiment, completion wizard 776 may comprise links 778a-778d for and movies for how-to videos 780a-780d for creating call groups, creating auto attendants, managing user call settings, and adding an administrator, respectively. According to embodiments, completion wizard 776 provides access to adding more locations, users, or devices by add locations button 782, add users button 784, and add devices button 786. After the completion of the account setup wizard of method 600 is completed, finished button 788 is selected, and the method ends.

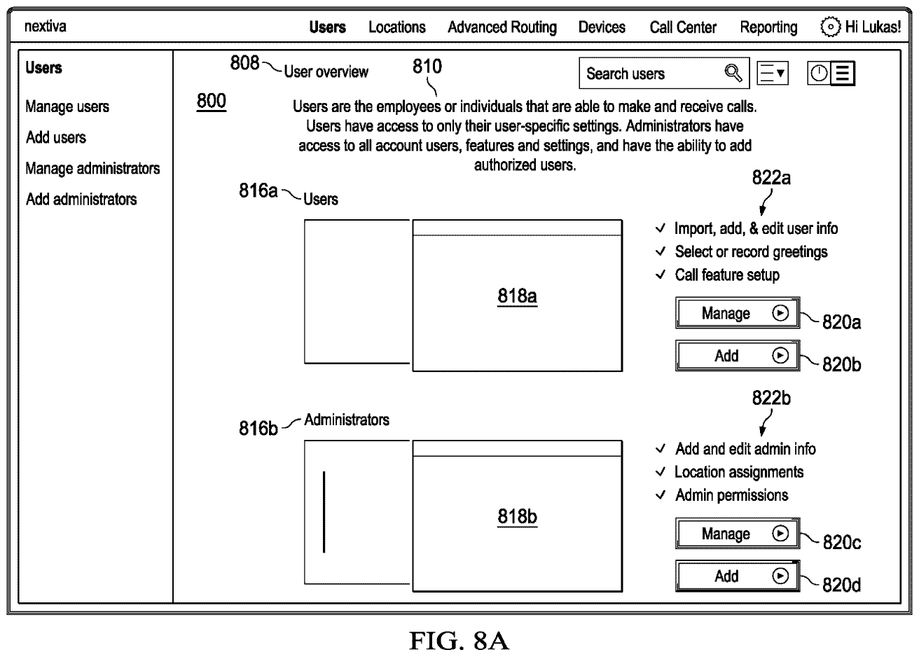

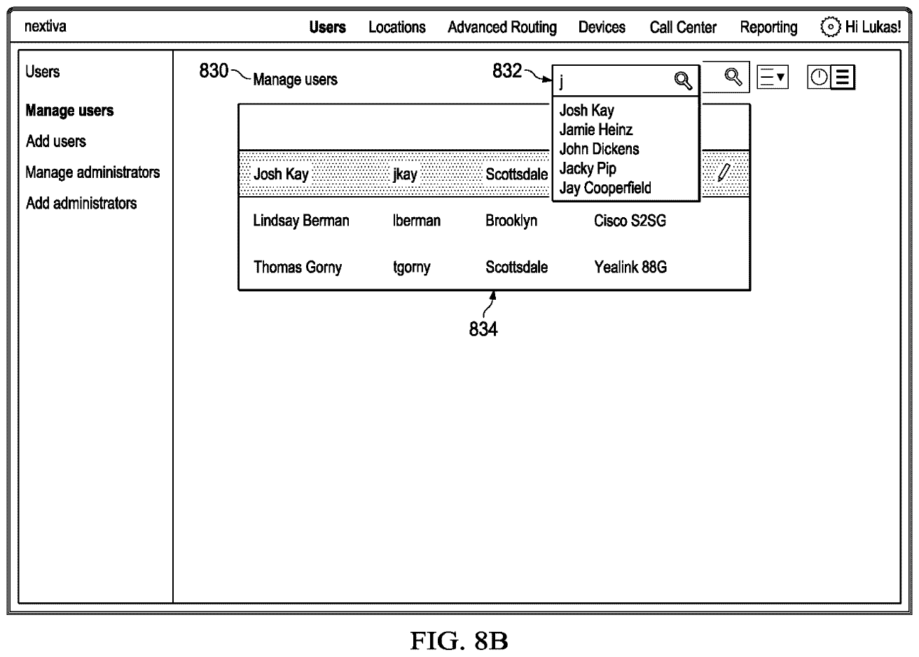

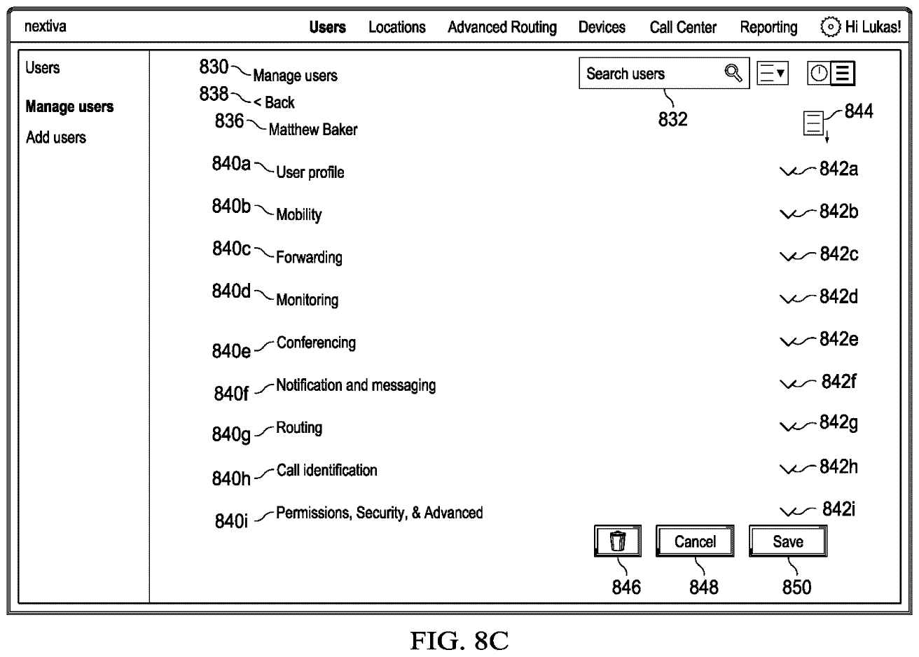

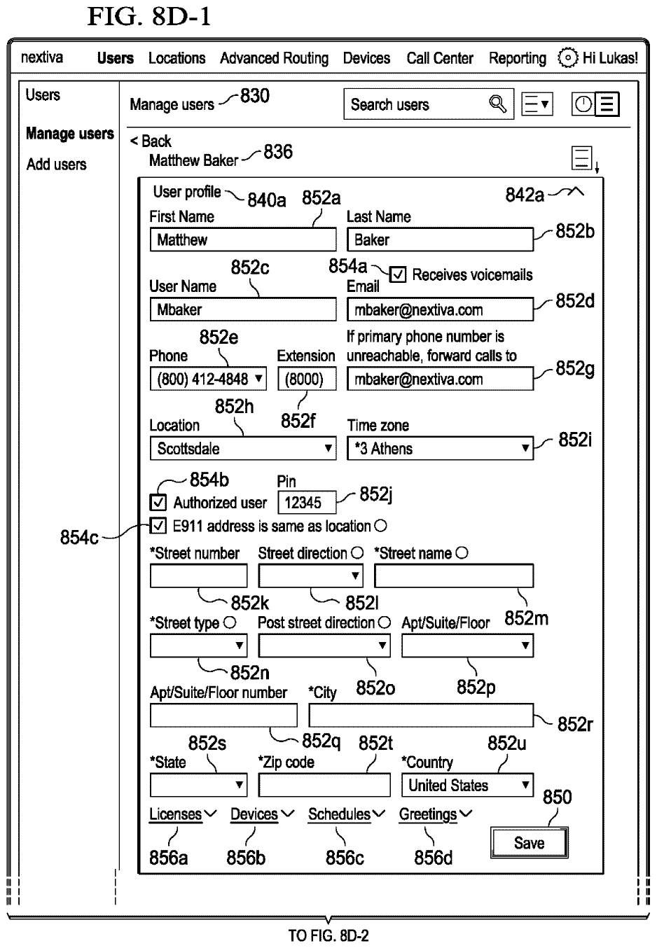

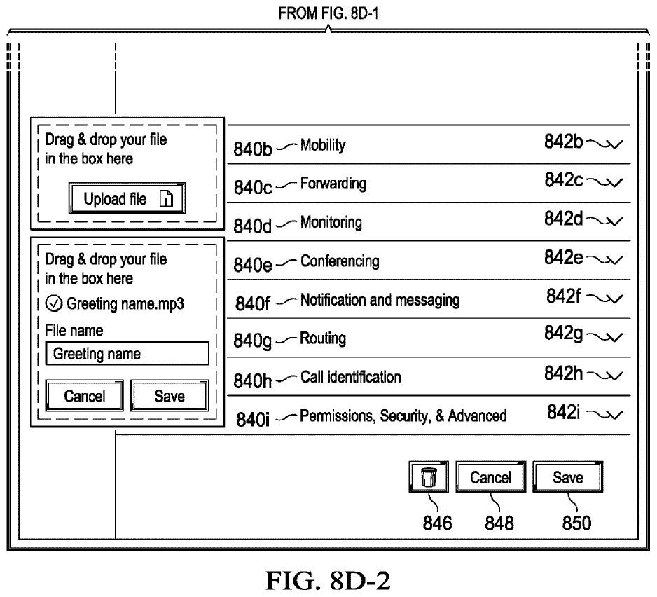

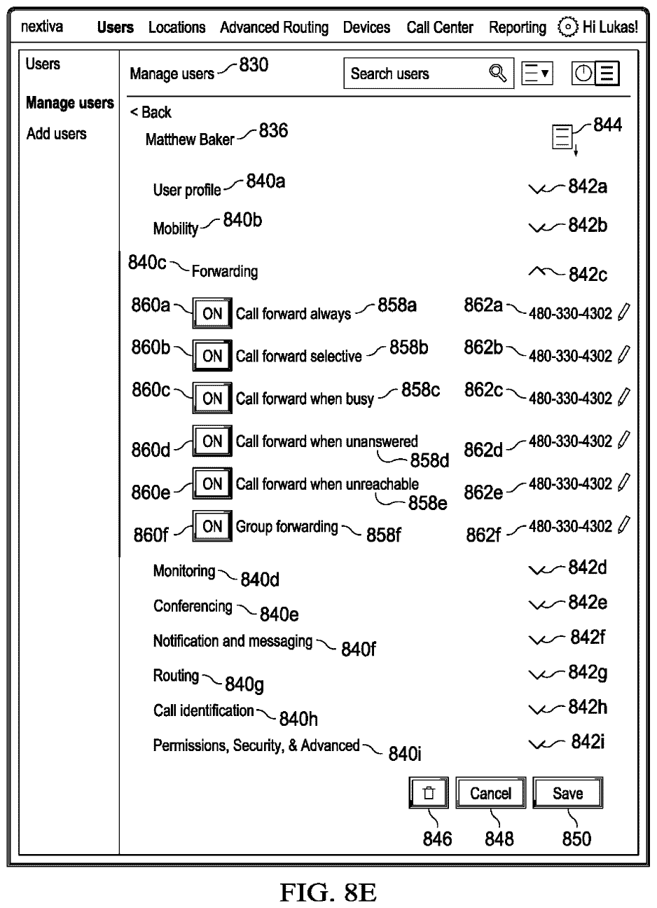

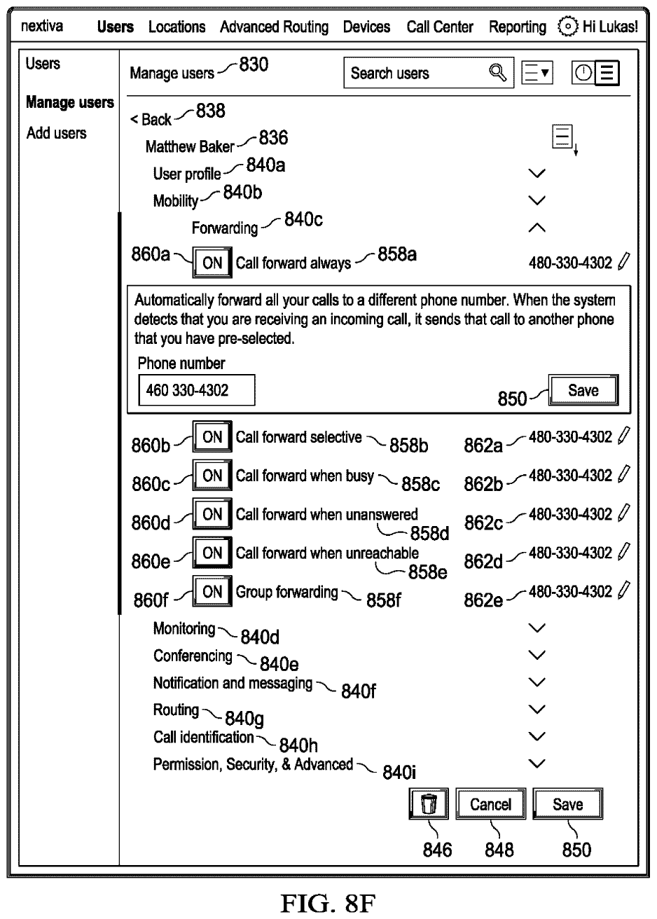

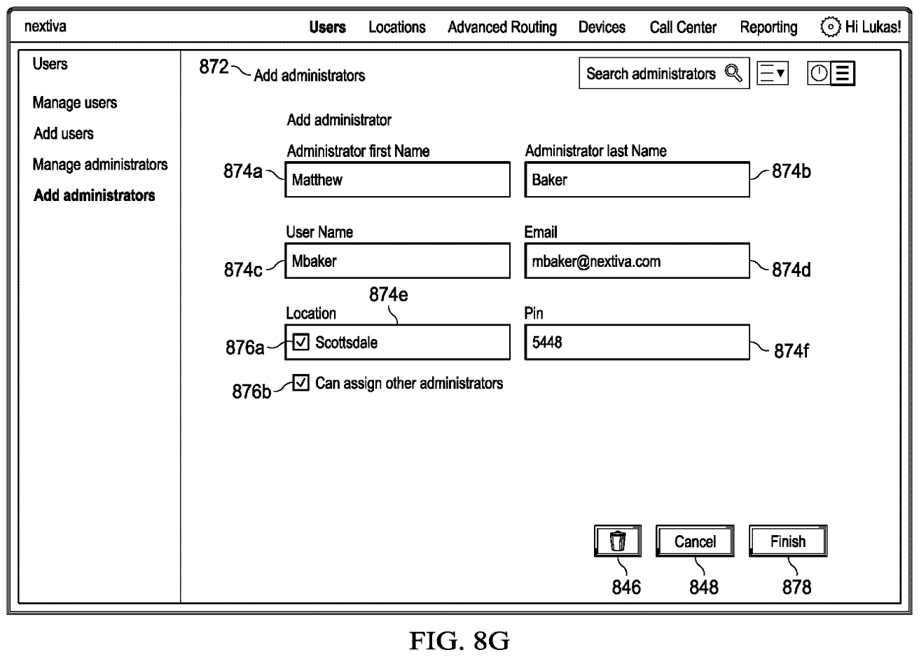

Returning now to user interface 500 of FIG. 5, scores associated with dashboards 530-544 may be updated to reflect the added users, locations, devices, or functionalities. In addition, account overview 512, call overview 516, and activity overview 520 are updated to reflect the new information. From user interface 500, selection of user top-level menu choice 504a causes user interface 500 to generate user overview wizard 800 (FIG. 8A). As used in this disclosure, selection of a button or link may be by customer management system 100 automatically monitoring a defined area of user interface 500, such as a button, link, or selectable area, and in response to a cursor, click, or other action occurring within the defined area, automatically generating a response in an attached computer to cause one or more defined functions, such as displaying a wizard or other elements, as described within this disclosure.

FIG. 8A illustrates user overview wizard 800 of user interface 500 according to an embodiment. In one embodiment, user overview wizard 800 permits a user to manage users, add users, manage administrators, and add administrators. Although particular elements are shown and described in association with overview wizard 800, embodiments contemplate any one or more elements or features, according to particular needs. User overview wizard 800 comprises a dynamic area which displays text, buttons, text or number entry boxes, and/or other types of dynamic elements that are configurable to allows for the input, display, or configure communication devices 124 and/or customer management system 100.

In one embodiment, user overview wizard 800 may comprise an overview 808, which in turn comprises overview information 810, help button 812, menu tool 814, and one or more feature overviews 816a-816b. Feature overviews 816a-816b comprise screenshots 818a-818b and link buttons 820a-820d, each of which relates to one or more features. For example, as shown in FIG. 8, users overview 808 comprises feature overviews for users 816a and administrators 816b. According to embodiments, each of feature overviews 816a-816b has one or more screenshots 818a-818b which displays on user interface 500 examples or pictures of updated user overview wizard 800 for the one or more features.

In addition, or as an alternative, the feature overview for users 816a comprises information 822a regarding that feature, including “Import, add, & edit user info,” “select or record greetings,” and “call feature setup.” One or more link buttons 820a-820b allows for the selection of a feature, which causes user overview wizard 800 to update the display to show a wizard associated with the selected feature. In addition, the feature overview for administrators 816b comprises information 822b regarding that feature, including “add and edit admin info,” “location assignments,” and “admins permissions.” One or more link buttons 820c-820d allows for the selection of a feature, which causes user overview wizard 800 to update the display to show a wizard associated with the selected feature.

When manage 820a is selected to manage users, user overview wizard 800 is updated to display a manage users wizard 830 (FIG. 8B). In one embodiment, manage users wizard 830 permits the searching and selection of users associated with a communication account and adjusting the configurations and settings associated with the users. In addition, or as an alternative, manage users wizard 830 may comprise search bar 832 and list of users 834. Search bar 832 permits entering a query to search for one or more users associated with a communication account. List of users 834 comprises information about each of the users associated with the account, such as, for example, name, username, an associated location, and an associated communication device 124. Selection of one or more users permits editing the information or changing configurations and settings associated with the selected user.

FIG. 8C illustrates manage users wizard 830 updated in response to selection of the user an exemplary user, i.e., Matthew Baker. In one embodiment, manager users wizard 830 displays a name of user 836, back button 838, configuration and settings subwizards 840a-840i, expand buttons 842a-842i, expand all button 844, delete user button 846, cancel button 848, and save button 850. Although manage users wizard 830 is described and illustrated with particular configuration and settings subwizards 840a-840i and a particular layout, embodiments contemplate any suitable categories or subcategories of configuration and settings subwizards 840a-840i arranged, according to particular needs. In addition, or as an alternative, each of expand buttons 842a-842i may expand the configuration and settings subwizard 840a-840i with which they are associated. For example, if user profile expand button 842a is selected, user profile configuration and settings subwizard 840a expands to reveal the configuration and settings of the user profile that may be edited, as shown in FIG. 8D. In addition, selection of expand all button 844 may expand all configuration and settings subwizards 840a-840i to reveal all configuration and settings associated with each configuration and settings subwizard 840a-840i.

For example, expanding the user profile configuration and settings subwizard 840a may reveal editable text boxes or drop-down selection boxes for first name 852a, last name 852b, username 852c, email 852d, phone number 852e, extension 852f, forwarding number 852g, location 852h, time zone 852i, PIN 852j, street number 852k, street direction 52l, street name 852m, street type 852n, post street direction 852o, apt/suite/floor indicator 852p, apt/suite/floor number 852q, city 852r, state 852s, zip code 852t, and country 852u. According to some embodiments, expanding the user profile configuration and settings subwizard 840a may further reveal selection boxes for receiving voicemails by email 854a, authorizing a user 854b, and setting an E811 address the same as user location 854c. According to some embodiments, selectable elements allow for setting licenses 856a, devices 856b, schedules 856c, and greetings 856d. Once correct information has been entered or changed, selection of save button 850 uploads the information to server 114.

Once information has been entered or changed, a different configuration and settings subwizard 840a-840i may be selected, by selecting the associated expand buttons 842a-842i to reveal the configuration and settings associated with the respective configuration and settings subwizard 840a-840i. According to some embodiments, configuration and settings associated with each configuration and settings subwizard 840a-840i are revealed according to an accordion function, as described in more detail below. According to an embodiment, one or more wizards of customer management system 100 comprises an accordion function, which comprises a system and method for sectioning off particular information to permit a user to see only the most relevant or necessary information to provide for greater ease of use. According to an embodiment, an accordion function comprises sectioning off information depending on the associated feature, the profile setting, what the system determines is important to the user, such as providing a “bite-sized” field to provide for a not overwhelming interface for the user.

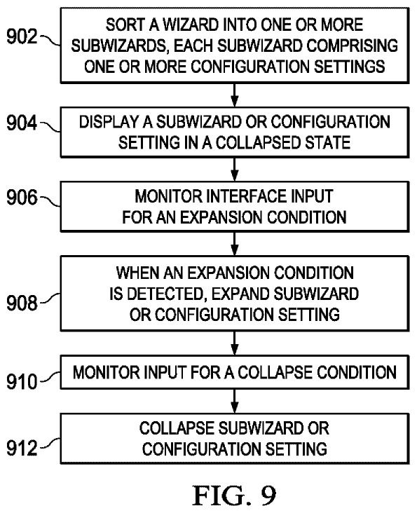

FIG. 9 illustrates an exemplary method 900 of an accordion function according to an embodiment. Method 900 proceeds by one or more activities, which although described in a particular order may be performed in one or more permutations, according to particular needs. Method 900 may comprise one or more account setup wizards 8E-8G, according to an embodiment.

In one embodiment, the user interface system automatically minimizes the completed steps, so that the complex and long process of setting up or editing a functionality of customer management system 100 is divided into manageable parts by eliminating or hiding unused or unnecessary information. Instead of a user needing to scroll up and down the wizard to navigate the user interface, the system automatically hides unused information from the user, and presents only the information of the current step or a portion of the current step. According to some embodiments, the user interface hides portions of the user interface that do not pertain to that particular user. In this manner, system administrator 110 divides long tasks into small and manageable tasks, which guides a user through one or more setup or editing wizards or processes of customer management system 100.

Method 900 begins at activity 902 by sorting a wizard into one or more subwizards, where each subwizard comprises one or more configuration settings. For example, and as illustrated in FIG. 8C, wizard 830 is sorted according to subwizards 840a-840i. Each subwizard 840a-840i is, in turn, sorted according to one or more configuration settings in each subwizard, as will be explained in more detail below.

At activity 904, system administrator 110 displays a subwizard or configuration setting in a collapsed state. For example, each subwizard 840a-840i occupies a single line of text, and none of the configuration settings available in each subwizard is visible. Although subwizards are illustrated as comprising no visible configuration settings in a collapsed state, embodiments contemplate some collapsed states as comprising one or more configuration settings, selectable elements, or text entry or selection boxes, according to particular needs.

At activity 906, system administrator 110 monitors input for an expansion condition. For example, system administrator 110 may comprise a graphical user interface (GUI). According to a GUI embodiment, system administrator 110 may receive input through a mouse, touchscreen, cursor, or other input that comprises a visual representation of sub wizards 840a-840i or configuration settings. Interface may detect a selection or movement inside an area of the interface, which indicates an expansion condition. Expansion conditions may comprise, for example, selecting an expansion button 842a, turning a switch on, entering text in a predetermined text entry box, selecting an item from a drop down selection box, clicking a button, or other types of input.

At activity 908, when an expansion condition is detected, system administrator 110 automatically expands a subwizard or configuration setting from a collapsed state into an expanded state that occupies a greater area of a display than the collapsed state. As illustrated in FIG. 8D, user profile subwizard 840a expands from a collapsed state in FIG. 8C. One or more text entry boxes associated with user profile subwizard 840a were not visible in the collapsed state, and other subwizards 840b-840i move to a lower portion of the display.

At activity 910, system administrator 110 monitors input for a collapse condition associated with a subwizard or a configuration setting. Collapse conditions may comprise a similar detected input as in expansion condition. A collapse condition may comprise a selection or movement inside an area of the interface, which indicates a collapse condition is desired to occur. Collapse conditions may comprise, for example, selecting an expansion button 842a for a second time or selecting an expansion button 842a when the associated subwizard is already in an expanded state, turning a switch off, entering text in a predetermined text entry box, selecting an item from a drop down selection box, clicking a button, or other types of input. According to some embodiments, a collapse condition for one subwizard may be the same as an expansion condition for another subwizard. For example, when user profile subwizard 840a is collapsed, mobility subwizard 840b automatically expands in response to the same input.

At activity 912, system administrator 110 automatically collapses a subwizard or configuration setting from an expanded state into a collapsed state that occupies a lesser area of a display than the expanded state. As illustrated in FIG. 8E, user profile subwizard 840 now occupies an area of the display in a collapsed state less than the area of the display in an expanded state.

To further illustrate the accordion function, an example is now given. In the following example, FIG. 8E illustrates manage users wizard 830 updated in response to selection of the forwarding configuration and settings subwizard 840c. Configuration settings of the forwarding configuration and settings subwizard 840c provides for call forwarding functionalities to be toggled on and off based on which particular phone number is illustrated on the wizard. For example, configuration settings of the forwarding configuration and settings subwizard 840c may comprise call forward always 858a, call forward selective 858b, call forward when busy 858c, call forward when unanswered 858d, call forward when unreachable 858e, and group forwarding 858f. Each of the configuration settings 858a-858f may be associated with a switch 860a-860f and a phone number 862a-862f. Switch 860a-860f permits each of the configuration settings 858a-858f associated with the switch to be toggled between an “on” state and an “off” state based on the position of the switch. Phone numbers 862a-862f associated with each of the configuration settings 858a-858f permits entry one or more phone numbers to receive forwarded calls when switch 860a-860f is toggled to an “on” state.

According to embodiments, the accordion function provides for the second (or further) step not being processed or displayed until a first step is completed, which then turns on or activates the second step. For example, where a first step comprises turning on or off a button, once a user turns on or off the button, system administrator 110 guides the user to the second step. In other words, the entire process is not presented at once, but, instead, the accordion function allocates and provides easy access to the subsections. According to some embodiments, the accordion function logically groups wizard functions and features together based on, for example, user input. Based on this, system administrator 110 provides for an easy, linear access to use any one or more of the functionalities or features of the one or more wizards.

FIG. 8F illustrates manage users wizard 830 updated in response to selection of the call identification configuration and settings subwizard 840h. According to an embodiment, configuration settings of the identification configuration and settings subwizard 840h provides call identification functionalities to be toggled on and off a first item of the call identification wizard, such as, for example, a feature that has not been purchased.

According to an embodiment, call identification configuration and settings subwizard 840h is associated with the accordion function, turning on the first item of call identification subwizard 840h comprises a first step, and the further steps are provided for by the accordion function. For example, to add a number to call identification subwizard 840h, the plus sign is selected. When the plus sign is selected, a drop-own guide is presented by system administrator 110 that guides a user through the process, such as, filing in information, saving the information, and the process completes automatically, without a user scrolling or navigating to further wizards. Therefore, even though the functionality is complex, system administrator 110 provides only the information on a need-to-know basis, which provides an intuitive system that is easy to use, even for the most complex functionalities of customer management system 100. According to further embodiments, the accordion function eliminates many steps from a multi-step processes such as, for example, reducing the number of steps in a two, three, four, or more step process in order to provide an easier to use system. According to some embodiments, some wizards, functions, or features are provided for as a one-step process such as Caller ID functionality.

Returning to FIG. 8A, add 820b may be selected to add users. In response to selection of add 820b, user overview wizard 800 is updated to display add users wizard 730 or import users wizard 738 (FIG. 7E). The initial setup of each of the one or more wizards or functionalities is substantially similar to the look and feel of the editing process of the wizard or functionalities, such as providing a substantially similar editing a wizard functionality as when setting up the wizard or functionality. Therefore, once a user has setup the user interface system, the process to edit any of the features or information would be intuitive and familiar. The user would not need to relearn any of the process from setup to editing.

As discussed above, add users wizard 730 of FIG. 7E permits the adding of new users and import users wizard 738 permits importing users to customer management system 100. Data for adding new users or importing of users may be stored in configuration data 204 of user interface 500. In response to selection of manage 820c to manage administrators, user overview wizard 800 is updated to display a manage administrators wizard. Manage administrators wizard permits adding, deleting, or changing configuration settings of one or more users with administrator status.

In response to selection of add 820d, user overview wizard 800 is updated to display an add administrators wizard 872 (FIG. 8G). Add administrators wizard 872 permits adding one or more administrators to a single location, multiple locations, and assign various rights and permissions to each of the administrators. Add administrators wizard 872 may comprise one or more text or selection boxes for entering, for example, administrator first name 874a, administrator last name 874b, username 874c, email 874d, location 874e, and PIN 874f. Add administrators wizard 872 may comprise one or more check boxes for associating an administrator with a location 876a and associating an administrator with privileges to assign other users as administrators 876b. Once information is entered, a user may select finish button 878 to store information in database 114.

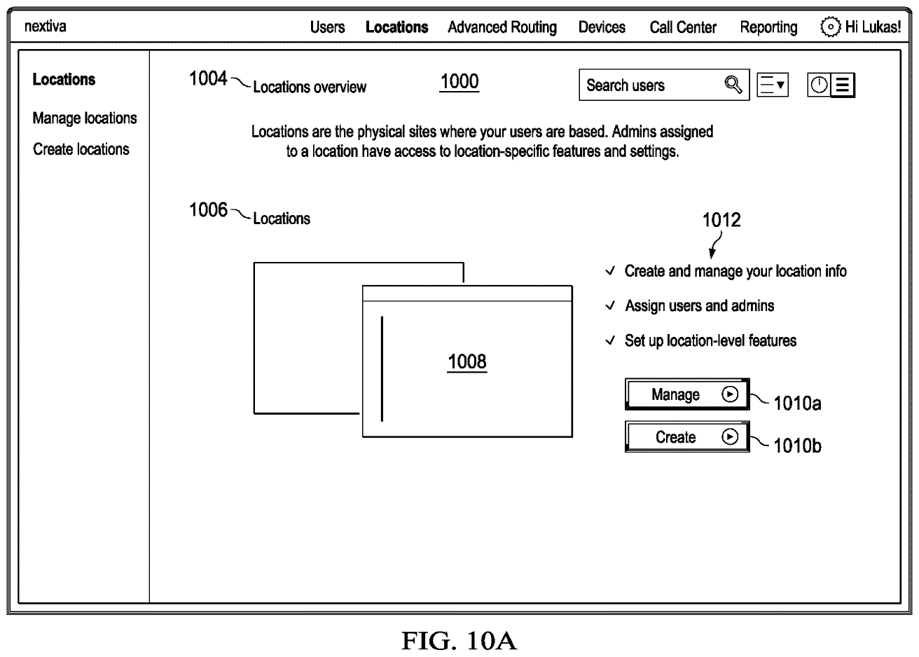

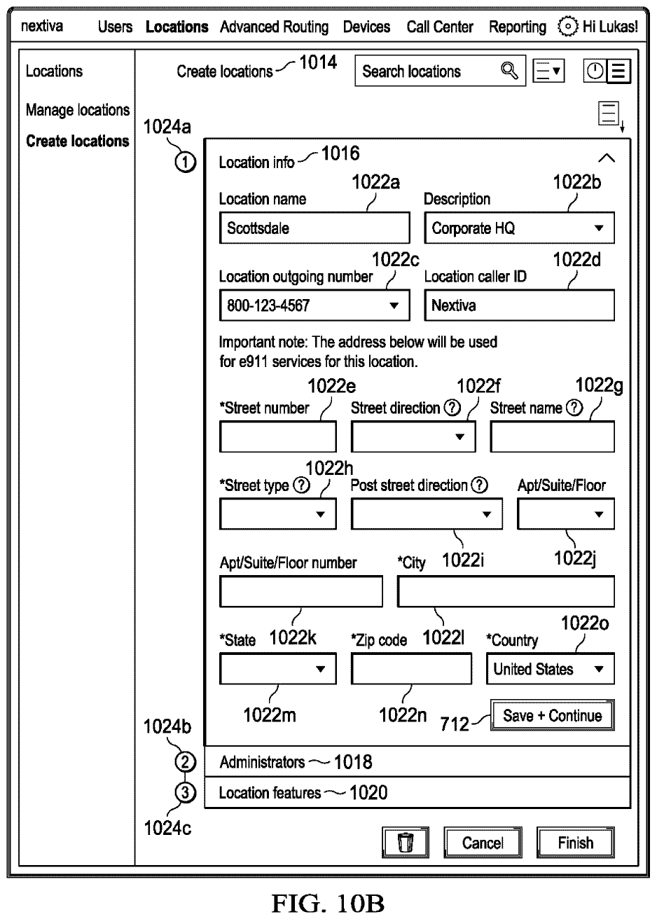

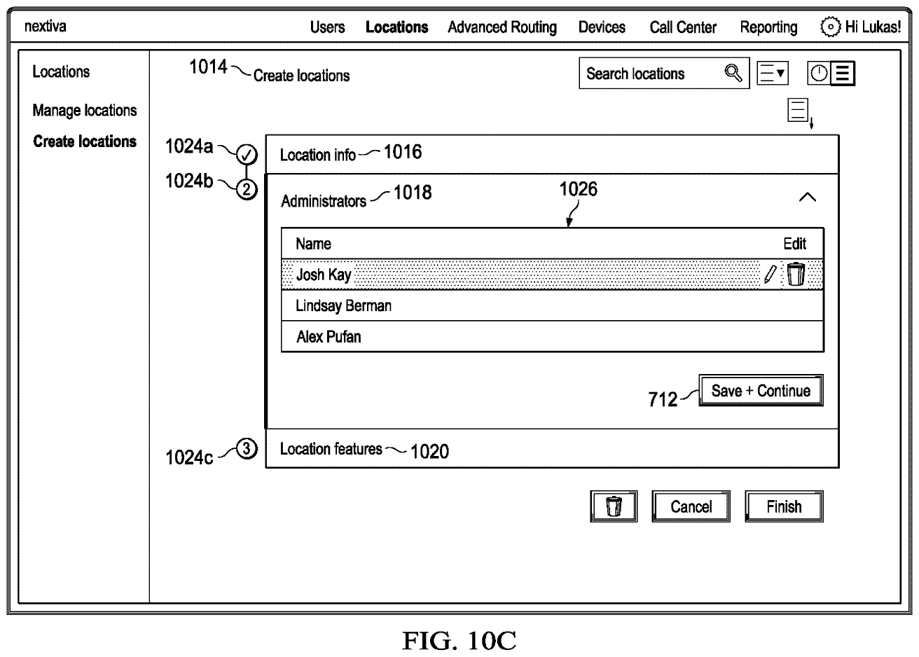

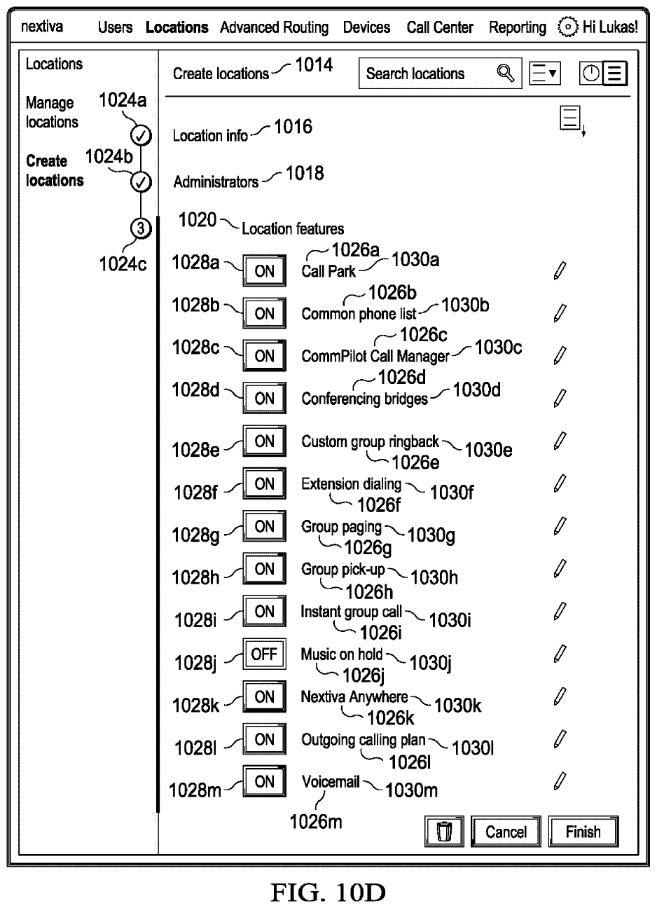

FIG. 10A illustrates a locations overview wizard 1000 of user interface 500 according to an embodiment. Locations overview wizard 1000 permits a user to manage locations, add locations, assign users and administrators to locations, and set up location-level features. In one embodiment, and in response to selection of locations top level menu choice 504b or locations dashboard 532 of user interface 500, locations overview wizard 1000 may display locations overview 1004, and locations feature overview 1006. Locations feature overview 1006 comprises screenshots 1008 and link buttons 1010a-1010b, each of which relates to one or more features. For example, as shown in FIG. 10A, locations overview 1004 comprises a locations feature overview 1006 comprising one or more screenshots 1008 which displays on interface 500 examples or pictures of locations overview wizard 1000 for the one or more features. Locations feature overview 1006 provides information 1012 including “create and manage your location info,” “assign users and admins,” and “set up location-level features.” One or more link buttons 1010a-1010b allows for the selection of a feature, which causes locations overview wizard 1000 to update the display to show a wizard associated with the selected feature.

In response to selection of manage 1010a to manage locations, locations overview wizard 1000 is updated to display a manage locations wizard. Manage locations wizard permits the searching and selection of locations associated with a communication account and adjusting the configurations and settings associated with the locations. In response to selection of create 1010b to create locations, locations overview wizard 1000 is updated to display a create locations wizard 1014 (FIG. 10B). Create locations wizard 1014 permits creation and configuration of locations associated with a communication account.

FIG. 10B illustrates create locations wizard 1014 of locations overview wizard 1000 comprising an accordion function. Create locations wizard 1014 may comprise a three action process for creating locations associated with communication devices 124. According to an embodiment, create locations 1014 comprises a series of actions that are numbered off and, for example, provide for expanding and/or collapsing the one or more actions based on particular user needs. In this manner, one or more actions are presented as a single action, with various portions of the action sectioned off. According to a particular embodiment, the location information is entered into create locations wizard 1014, in a particular section or subwizard. Once information is entered, the next section expands and the information entered in the previous section may be collapsed or reduced. The process continues as information is entered into create locations wizard 1014, further sections expand and previous sections may collapse to facilitate the input of information into the system. In this manner, complex functionalities are divided into manageable portions according to the accordion function, which displays information only as needed at a particular time and avoiding the need to scroll up or down. The accordion function therefore provides for information to be presented, while still providing ease of access to all functions in an easy to use interface.

In addition, or as an alternative, create locations wizard 1014 may comprise a checklist structure of a user interface system. According to an embodiments the checklist structure checks off steps of a create locations user interface as a user completes the steps. The checklist structure permits a user to return to any previous steps and correct or change information by selecting the step from the list of steps. In one embodiment, a checkmark may be placed next each of the one or more steps as that step is completed.

Create locations wizard 1014 displays location information subwizard 1016, administrators subwizard 1018, and location features subwizard 1020 according to an accordion function. The accordion function permits create locations wizard 1014 to display only the features that are being configured by a user at a single time. In this way, the accordion function creates a linear path of actions to pass through one or more wizards. In accordance with an accordion function, the location information subwizard 1016 to be completed first by a user may be expanded automatically by interface 500 upon initiation of create locations wizard 1014. In addition, or as an alternative, interface 500 may monitor the cursor of a user or wait for a selection by the user before expanding one or more subwizards.

In one embodiment, location information subwizard 1016 may comprise text entry or drop down selection boxes for entering information for location name 1022a, description 1022b, location outgoing number 1022c, location caller ID 1022d, street number 1022e, street direction 1022f, street name 1022g, street type 1022h, post street direction 1022i, apt/suite/floor 1022j, apt/suite/floor number 1022k, city 1022l, state 1022m, zip code 1022n, and country 1022o. In addition, or as an alternative, one or more indicators 1024a-1024c may comprise guidance to a user as to an order or status of each action performed according to the accordion function. In one embodiment, when location information subwizard 1016 is expanded, indicator 1024a comprises a number 1 enclosed in a circle, indicating that location information subwizard 1014 should be completed first. In another embodiment, indicators 1024b-1024c may comprise a shaded or blurred numbers 2 and 3, respectively, that indicate that actions associated with these indicators 1024b-1024c are to be completed second and third after the action associated with indicator 1024a.

After information is entered into text entry or drop down selection boxes 1022a-1022n, accordion function may collapse location information subwizard 1016 and expand administrators subwizard 1018. In addition, selection of save and continue button 712 causes accordion function to collapse location information subwizard 1016 and expand administrators subwizard 1018 or another suitable wizard or subwizard, according to particular needs.

FIG. 10C illustrates administrators subwizard 1018 of locations overview wizard 1000 expanded according to the accordion function. As illustrated, location information subwizard 1016 is in a collapsed state and administrators wizard 1018 is in an expanded state. Additionally, indicator 1024a has changed into a checked box, indicating that the actions associated with location information subwizard 1016 is completed, and indicator 1024b has changed into a highlighted number 2, indicating that the actions associated with administrators subwizard 1018 are ready to be performed. In one embodiment, administrators subwizard 1018 permits searching, editing, and configuring the location information associated with one or more administrators. Administrators may be listed in a search box 1026 and selection of an administrator name may permit editing or deleting the selected administrator.

After actions associated with administrators subwizard 1018 are completed, accordion function may collapse administrators subwizard 1018 and expand location features subwizard 1020. In addition, or as an alternative, selection of save and continue button 712 causes accordion function to collapse administrators subwizard 1018 and expand location features subwizard 1020 or another suitable wizard or subwizard, according to particular needs.

FIG. 10D illustrates location features subwizard 1020 locations overview wizard 1000 expanded according to the accordion function. In one embodiment, location features subwizard 1020 may permit locations of the user interface to be easily turned on and off. According to an embodiment, a list of the location features is presented to the user. Boxes next to the location features indicate whether the locations is on or off. The on or off button may be toggled, such that the location from an on status to an off status maybe selected. As illustrated, location features subwizard 1016 and administrators wizard 1018 are in a collapsed state and location features subwizard 1020 is expanded. In addition, indicator 1024b has changed into a checked box, indicating that the actions associated with administrators subwizard 1018 are completed, and indicator 1024c has changed into a highlighted number 3, indicating that the actions associated with location features subwizard 1020 are ready to be performed.

According to an embodiments, location features subwizard 1020 comprises an on and off functionality. Configuration settings of location features subwizard 1020 provides for location configuration features to be toggled on and off. In a non-limiting example, location configuration settings of location features subwizard 1020 may comprise call park 1030a, common phone list 1026b, CommPilot Call Manager 1026c, conferencing bridges 1026d, custom group ring back 1026e, extension dialing 1026f, group paging 1026g, group pick-up 1026h, instant group calls 1026i, music on hold 1026j, Nextiva Anywhere 1026k, outgoing calling plan 1026l, and voicemail 1026m. Each of the configuration settings 1026a-1026m may be associated with a switch 1028a-1028m and a help button 1030a-1030m. In one embodiment, switch 1028a-1028m permits each of the configuration settings 1026a-1026m associated with the switch to be toggled between an “on” state and an “off” state based on the position of the switch. In another embodiment, help buttons 1030a-1030m associated with each of the configuration settings 1026a-1026m permits a functional description functionality.

In association with the on and off functionality is a functional description functionality that provides for a detailed description of an associated function when a graphical element, such as help button 1030a-1030m, is selected. Although the functional description functionality is described in connection with an on and off functionality, the functional description functionality may provide a detailed description in connection with any feature, wizard, or functionality of user interface 500.

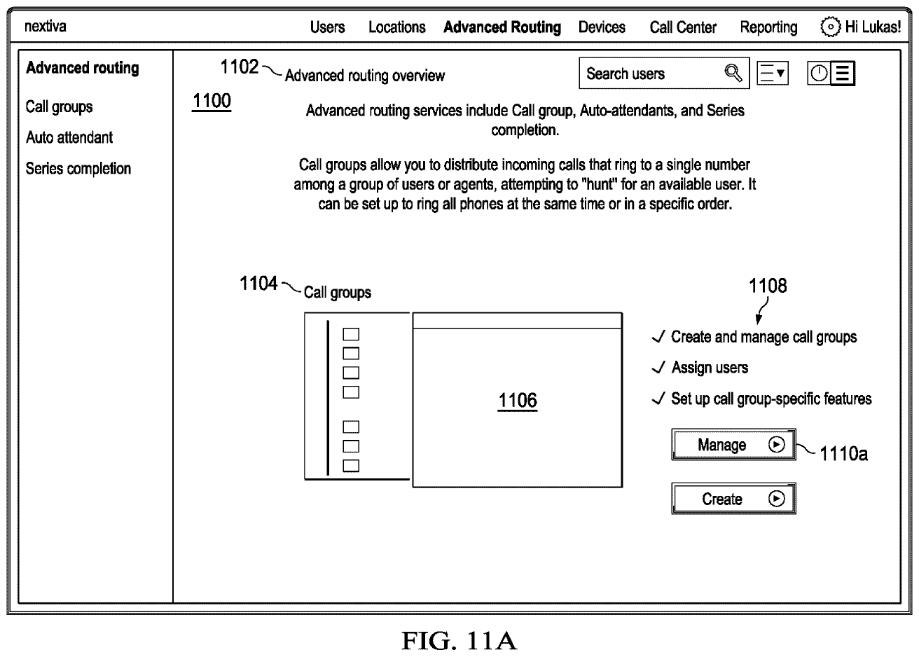

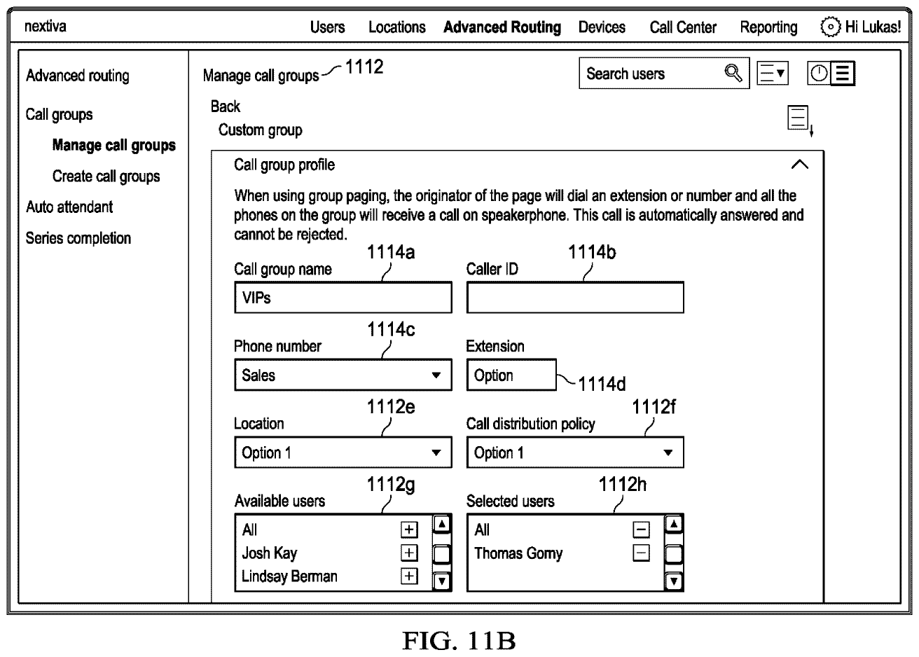

FIG. 11A illustrates an advanced routing wizard 1100 of user interface 500 according to an embodiment. In one embodiment, and in response to selection of advanced routing top level menu choice 504c or advanced routing dashboard 538 of user interface 500, advanced routing wizard 1100 may display advanced routing overview 1102 and call groups feature 1104. In one embodiment, advanced routing wizard 1100 permits a user to manage advanced routing features, including configuring call groups, auto-attendants, and series completion. In one embodiment, advanced routing overview 1102 comprises a call groups feature 1104 comprising one or more screenshots 1106 which displays on interface 500 examples or pictures of the updated advanced routing wizard 1100 for call groups feature 1104. In addition, or as an alternative, call groups feature 1104 gives information 1108 including about the call groups feature 1104 including “create and manage call groups,” “assign users,” and “setup call group-specific features.”

In response to selection of manage 1110a to manage call groups, advanced routing wizard 1100 is updated to display a manage call groups wizard 1112 (FIG. 11B). In one embodiment, manage call groups wizard 1112 permits configuration of a call group profile. A call group may comprise permitting a user to dial an extension or number from a first communication device 124 and causing one or more selected communication devices 124 to receive a communication from the first communication device 124. Configuration of the call group according to manage call groups wizard 1112 may comprise one or more text entry or selection boxes for call group name 1114a, caller identification (ID) 1114b, phone number 1114c, extension 112d, location 1114e, call distribution policy 1114f, available users 1114g, and/or selected users 1114h.

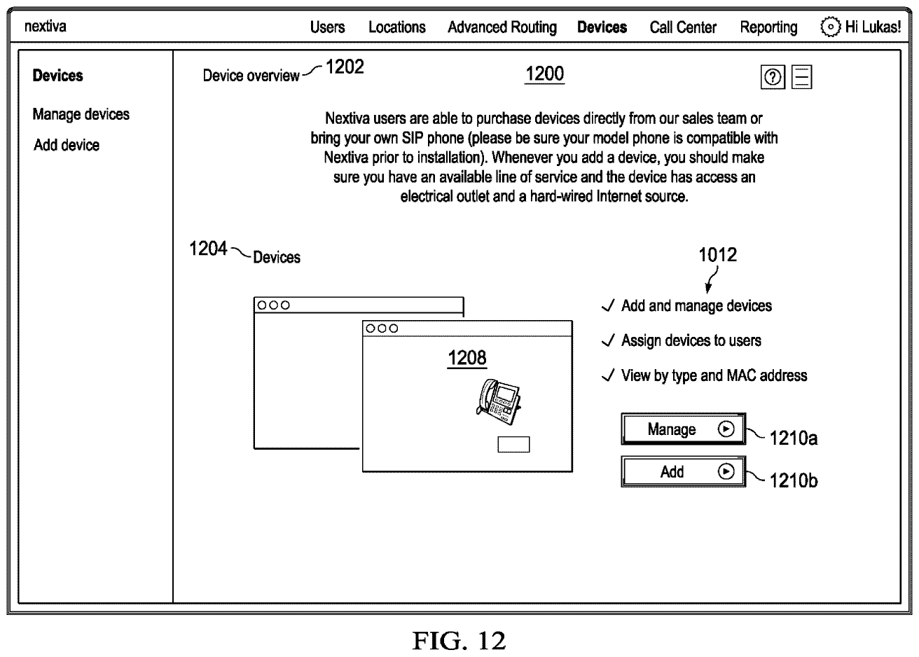

FIG. 12 illustrates a device wizard 1200 of user interface 500 according to an embodiment. In one embodiment, device wizard 1200 permits a user to manage device features, including adding and viewing communication devices 124 to network 150 and configuring locations or users associated with communication devices 124. In response to selection of devices top level menu choice 504d or devices dashboard 534, interface 500 initiates display wizard 1200, which causes device wizard 1200 to display device overview 1202 and devices feature 1204. In an embodiment, device overview 1202 may comprise information regarding the content of devices wizard 1200. Devices feature 1204 may comprise screenshots 1208 and link buttons 1210a-1210b, each of which relates to one or more features associated with devices wizard 1200.

In one embodiment, devices feature 1204 comprises one or more screenshots 1208 which displays on interface 500 examples or pictures of the updated device wizard 1200. Devices feature 1204 provides information 1212 about devices feature 1204 including “add and manage devices,” “assign devices to users,” and “view by type and MAC address.” In response to selection of manage 1210a to manage devices, device wizard 1200 is updated to display a manage devices wizard. In response to selection of add 1210b to add devices, device wizard 1200 is updated to display a add devices wizard 758, as discussed previously in connection with FIG. 7H.

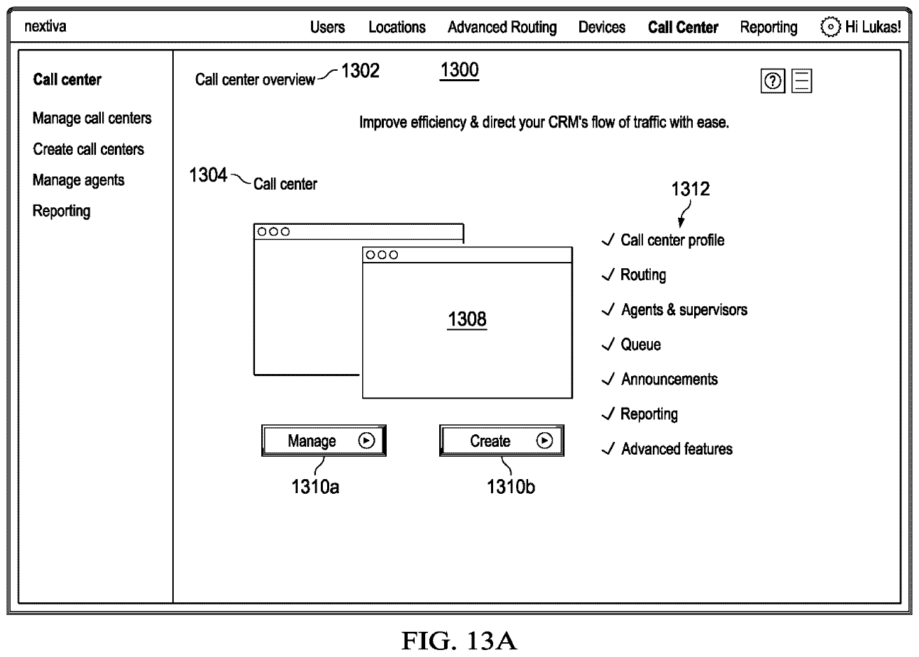

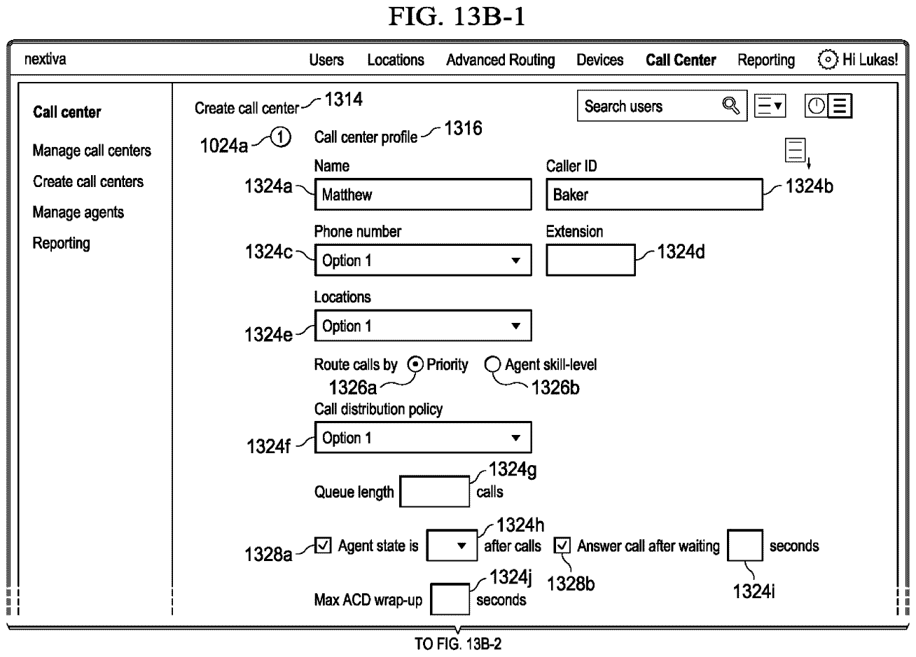

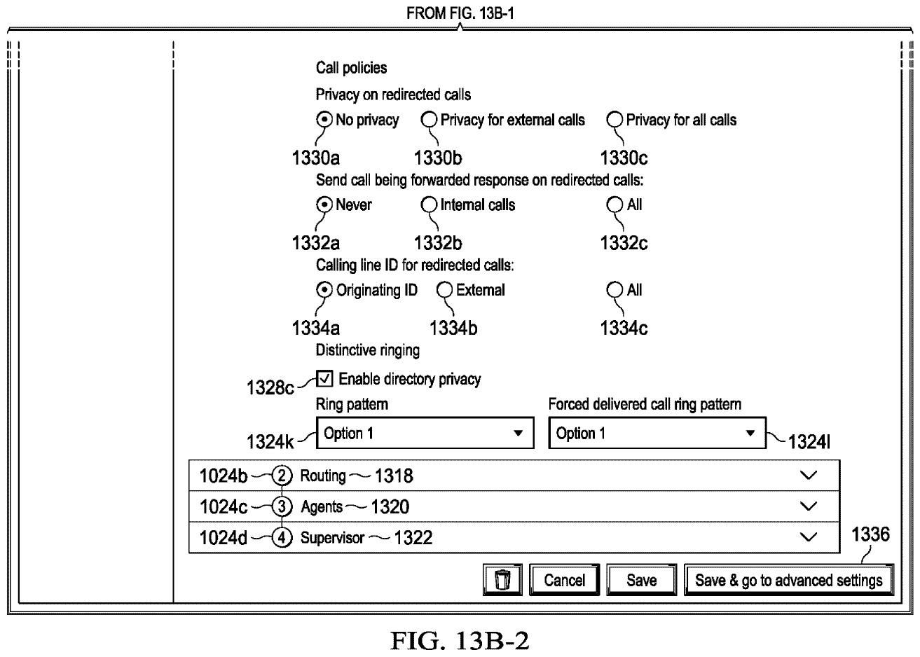

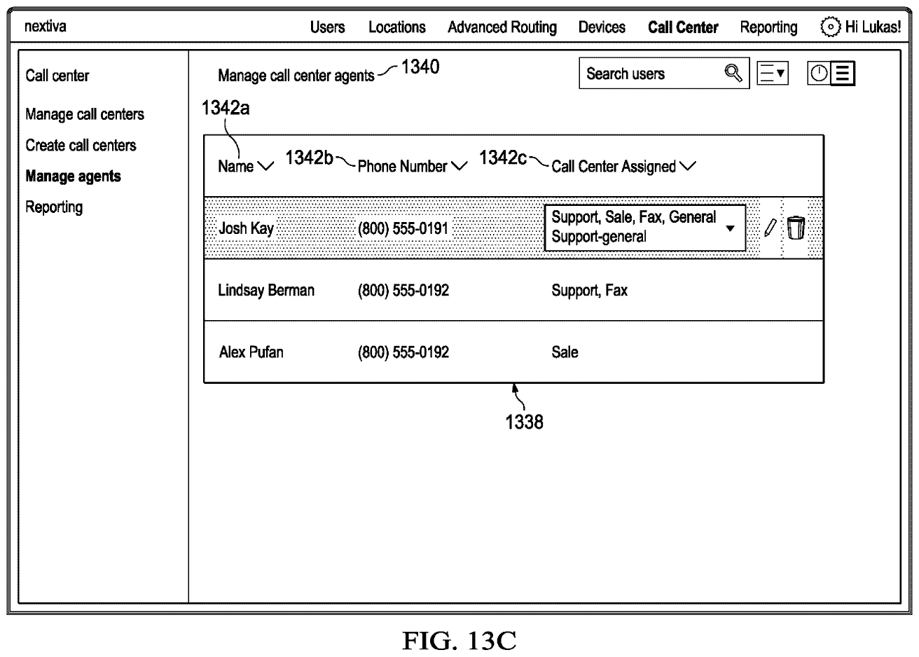

FIG. 13A illustrates call center wizard 1300 of user interface 500 according to an embodiment. In one embodiment, call center wizard 1300 permits a user to manage call center features, including adding and setting up call centers, managing agents and supervisors, establish and modify routing, and other features as described below. In response to selection of call center top level menu choice 504e or call center dashboard 540, call center wizard 1300 causes task interface 804 to display call center overview 1302 and call center feature 1304. In one embodiment, call center overview 1302 may comprise information regarding the content of call center wizard 1300. In addition, call center feature 1304 may comprise screenshots 1308 and link buttons 1310a-1310b, each of which relates to one or more features associated with call center wizard 1300.

In one embodiment, call center feature 1304 comprises one or more screenshots 1308 which may display on interface 500 examples or pictures of the updated call center wizard 1300, such as, examples of manage call centers or create call centers wizards. Call center feature 1304 provides information 1312 about call center feature 1304 including “call center profile,” “routing,” “agents and supervisors,” “queue,” “announcements,” “reporting,” and “advanced features.” In response to selection of manage 1310a to manage call centers, call center wizard 1300 is updated to display a manage call centers wizard. In response to selection of create 1310b to create call centers, call center wizard 1300 is updated to display a create call centers wizard 1314, as discussed in connection with FIGS. 13B-1 and 13B-2.

FIGS. 13B-1 and 13B-2 illustrate create call center wizard 1314 according to an accordion function, as described above. Create call center wizard 1314 comprises call center profile subwizard 1316, routing subwizard 1318, agents subwizard 1320, and supervisor subwizard 1322 according to an accordion function. The accordion function permits call center wizard 1300 to display only the features that are being configured by a user at a single time. In this way, the user's exposure is limited to only the configurations or settings that a user needs to do in the current subwizard, and is prevented from adjusting further configuration or settings in other subwizards until the current subwizard is completed. In addition, or as an alternative, each of the subwizards may be associated with an indicator 1022a-1022d which may be highlighted or shaded as actions are completed or are waiting to be completed discussed above.

As illustrated, create call center profile subwizard 1314 is in an expanded state and routing subwizard 1318, agents subwizard 1320, and supervisor subwizard 1322 are in a collapsed state. In one embodiment, create call center profile subwizard 1314 may comprise text entry or selection boxes for associating information with a call center profile, including, name 1324a, caller ID 1324b, phone number 1324c, extension 1324d, location 1324e, call distribution policy 1324f, queue length 1324g, agent state 1324h, wait time 1324i, maximum ACD wrap-up time 1324j, ring pattern 1324k, and forced delivered call ring pattern 13241. Create call center profile subwizard 1314 may comprise radio selection boxes to choose between routing calls by priority 1326a or by agent skill-level 1326b; associating privacy on redirected calls by no privacy 1330a, privacy for external calls 1330b, or privacy for all calls 1330c; sending call being forwarded response on redirected calls never 1332a, only on internal calls 1332b, or for all calls 1332c; and associating caller line ID for redirected calls with originating ID 1334a, external ID 1334b, or all 1334c. Check boxes permit the selection of features to be associated with the call center profile such as setting an agent state after a user-defined number of calls 1328a, answering a call automatically after waiting a user-defined number of seconds 1328b, setting a maximum ACD wrap-up time 1324j, and enabling directory privacy 1328c. Although call center profile subwizard 1316 is indicated with particular features and in a particular configuration, embodiments contemplate any suitable combination or configuration of features, according to particular needs.

In addition, or as an alternative, after information is entered in call center profile subwizard 1314 or save and go to advanced settings button 1336 are selected, information is stored in database 114 and each of the subwizards 1314-1322 may collapse and expand according to the accordion function as discussed above to permit a user to complete the further actions associated with creating a call center.

FIG. 13C illustrates manage call center agents wizard 1340 according to an embodiment. Manage call center agents wizard 1340 may be displayed in response to selection of manage call center agents. In one embodiment, manage call center agents wizard 1340 permits a user to assign and view, edit, and delete assignments of one or more users to one or more call centers. In addition, or as an alternative, manage call centers wizard 1340 may comprise a list 1338 of names 1342a, phone number 1342b, and call center assignments 1342c of one or more agents associated with a call center. Call center assignments 1342c may comprise, for example, support, sale, fax, general, and/or general support. In an embodiment, the call center assignments 1342c may apply to agents assigned to handle one or more escalations from one or more bots, as discussed in further detail below. For example, an assignment to “support” may assign a user to handle a call from a bot when a trigger for escalating the interaction is exceeded, such as when the tone of the customer and/or an interaction time limit with the bot indicates the interaction should be escalated. Call center assignments 1342c are readily viewable from list 1338 which permits a quicker determination of call center assignments 1342c associated with each of one or more agents. According to an embodiment, a call center agent is one or more end user systems 120a-120n that is associated with a call center assignment and thereby is configured to be associated with one or more configuration settings of a call center, such as being assigned to one or more call center queues.

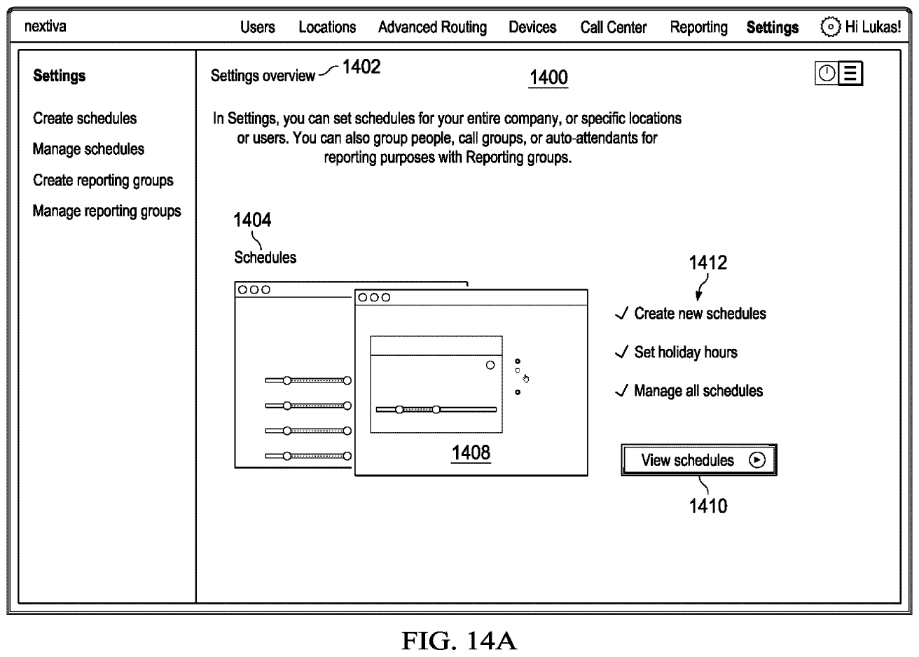

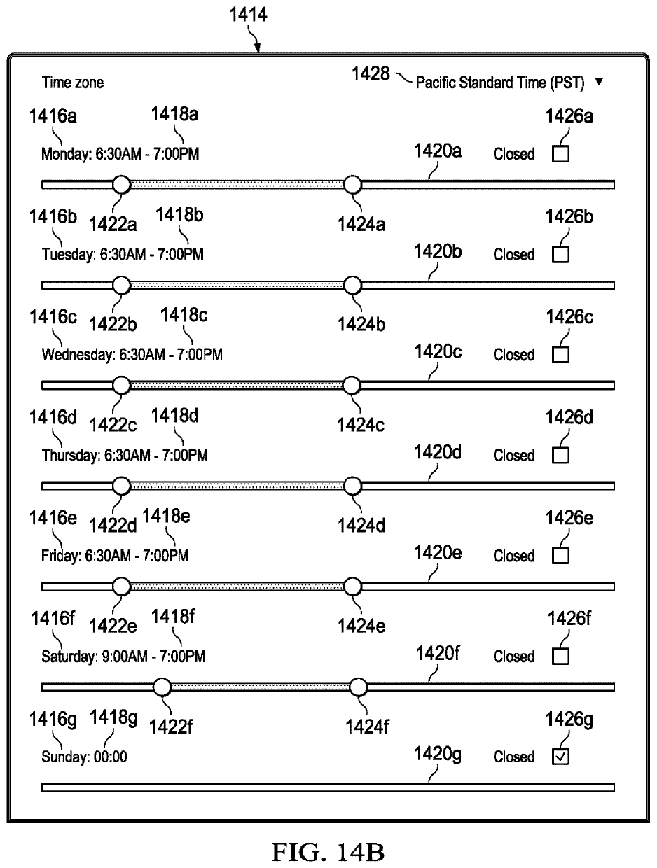

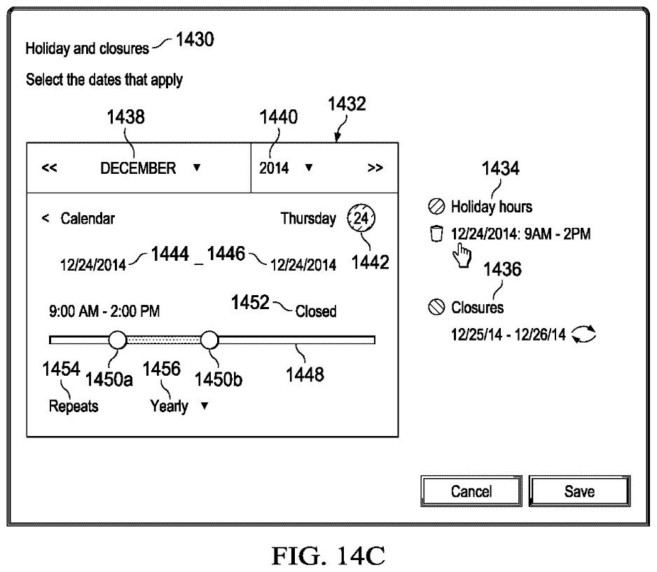

FIG. 14A illustrates a settings wizard 1400 of user interface 500 according to an embodiment. In one embodiment, settings wizard 1400 permits one or more end user systems 120a-120n to create and manage schedules for one or more users, an entire company, or for specific locations. Settings wizard 1400 may also permit grouping one or more end user systems 120a-120n, call groups, or auto-attendants for reporting purposes by creating and managing reporting groups. A reporting group may be, for example, one or more users that are organized differently then, for specific locations. For example, if one or more users are grouped together, such as sales in Phoenix and Los Angeles, a report may be run for this group, without having to tie this group to a specific locations.

In response to selection of settings top level menu choice 504g or settings dashboard 536, settings wizard 1400 displays settings overview wizard 1402 and schedules feature 1404. In one embodiment, settings overview 1402 may comprise information regarding the content of settings wizard 1400. In addition, or as an alternative, schedules feature 1404 may comprise screenshots 1408 and a link button 1410, which relates to a schedules feature 1404 associated with settings wizard 1400.

In one embodiment, schedules feature 1404 comprises one or more screenshots 1408 which may display on user interface 500 examples or pictures of the updated settings wizard 1404, such as, examples of schedules wizard and holidays and closures wizard. Schedules feature 1404 gives information 1412 about schedules feature 1404 including “create new schedules,” “set holiday hours,” and “manage all schedules.” Link button 1410 allows for the selection of a view schedules feature 1404 which causes settings wizard 1400 to update the display to show a wizard associated with the selected feature 1404.

FIG. 14B illustrates a schedules wizard 1414 of user interface 500 according to an embodiment. In one embodiment, schedules wizard 1414 permits a user to associate time zones, schedules, breaks, and the like with one or more accounts of the system. Furthermore, a user is permitted to select one or more times when a call center is open or closed, and set time periods for one or more breaks when call center is open but not accepting calls.

Schedules wizard 1414 may comprise a schedule organized by, for example, one or more days of a week 1416a-1416g. Each of the days 1416a-1416g may be associated with a time period 1418a-1418g during which time the associated call center is open or closed. Time period 1418a-1418g may be adjusted by sliders 1420a-1420g and closed checkboxes 1426a-1426g. To indicate that a call center is open, a user checks or unchecks boxes 1426a-1426g. According to an embodiment, if the box is checked, schedules wizard 1414 receives an indication that the call center is closed on the associated day 1416a-1416g and associated slider 1420a-1420g is dimmed, such as Sunday slider 1420g. To adjust the time period for a day that the call center is open, a user may slide a first dial 1422a-1422f along the slider to a point that indicates an opening time and a second dial 1424a-1424f along the slider to a point that indicates the closing time. Embodiments contemplate adding one or more additional sliders or checkboxes to indicate break periods or other time restraints. A drop down selection box 1428 allows a user to change the time zone associated with the call center schedule.

FIG. 14C illustrates holidays and closures wizard 1430 may comprise a calendar that permits a user to select one or more times and dates that the call center will be closed or that a special message or greeting will be played to callers to call center. According to some embodiments, the user may set a special time for a date during which the call centers hours will differ from the schedule set in schedules wizard 1414.

Holidays and closures wizard 1430 may comprise calendar picker tool 1432, holiday hours viewer 1434, and closures viewer 1436. Calendar picker tool 1432 comprises a month selector 1438, year selector 1440, and day selector 1442. A user may select according to the month selector 1438, year selector 1440, and day selector 1442 a date for a holiday or closure. According to some embodiments, calendar picker tool 1432 comprises a calendar that permits a user to scroll through days, years, and months to select an appropriate day for a holiday or closure.

In addition, or as an alternative, calendar picker tool 1432 permits a user to choose a starting date 1444 and an ending date 1446 for a holiday or closure. A slider bar 1448 permits a user to adjust by one or more dials 1450a-1450b a start time and end time, as described above in connection with sliders 1420a-1420g. Check boxes 1452 and 1454 permit a user to select whether the call center is closed 1452 on the date specified, and whether the holiday or closure repeats 1454 at a specified schedule. The time period for the repeating of the schedule may be selected by selection box 1456 and may be selected as any suitable time period, such as, yearly, monthly, weekly, daily, or the like. After a holiday or closure is selected by calendar picker tool 1432, holiday hours viewer 1434 and closures viewer 1436 display the holiday hours and days of closure, respectively, that were selected by calendar picker tool 1432.

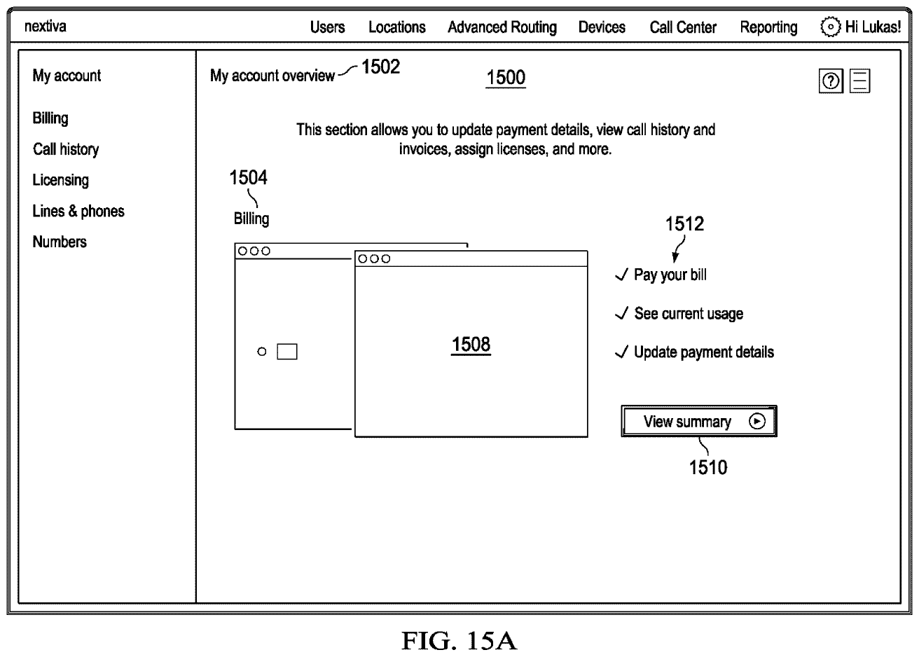

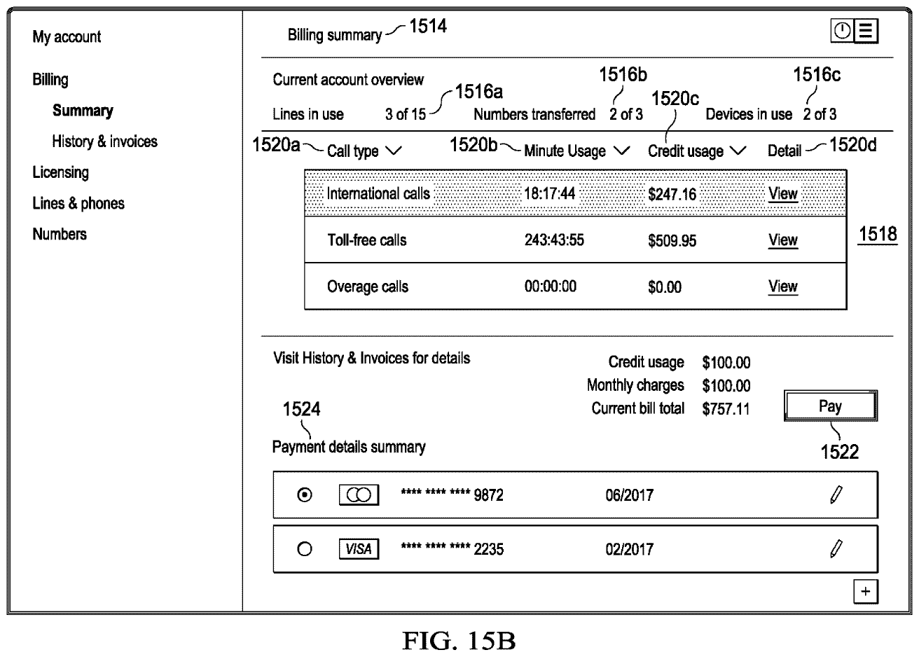

FIG. 15A illustrates my accounts wizard 1500 of user interface 500 according to an embodiment. In one embodiment, my accounts wizard 1500 permits one or more end user systems 120a-120n to update payment details, view call history and invoices, and assign licenses. In response to selection of my accounts top level menu choice 504h, my accounts wizard 1500 displays my accounts overview wizard 1502 and billing feature 1504. My accounts overview 1502 may comprise information regarding the content of my accounts wizard 1500. Billing feature 1504 may comprise screenshots 1508 and a link button 1510, which relates to a billing feature 1504 associated with my accounts wizard 1500.

In one embodiment, billing feature 1504 comprises one or more screenshots 1508 which may display on interface 500 examples or pictures of my accounts wizard 1500, such as, for example a billing wizard, a call history wizard, a licensing wizard, a lines and phone wizard, and a numbers wizard. Billing feature 1504 provides information 1512 about billing feature 1504 including “pay your bill,” “see current usage,” and “update payment details.” Link button 1510 allows for the selection of a billing feature 1504 which causes task interface 804 to update the display to show a wizard associated with the selected feature 1504.

FIG. 15B illustrates a billing summary wizard 1514 of user interface 500 according to an embodiment. In one embodiment, billing summary wizard 1514 permits a user to update credit card information, view invoices, pay bills, and the like. Information presented to the user may include the number of lines in use 1516a, numbers transferred 1516b, and devices in use 1516c. A billing summary list 1518 may provide call type 1520a, minutes of usage 1520b, credit usage 1520c, and a detailed view of charges 1520d. Further information provided by billing summary wizard 1514 includes viewing history and invoice details, totals of credit usage, monthly charges, and current bill totals. According to some embodiments, billing summary wizard provides a pay button 1522 that permits a user to pay a current invoice. A user may edit the payment information in the payment details summary 1524 provided.

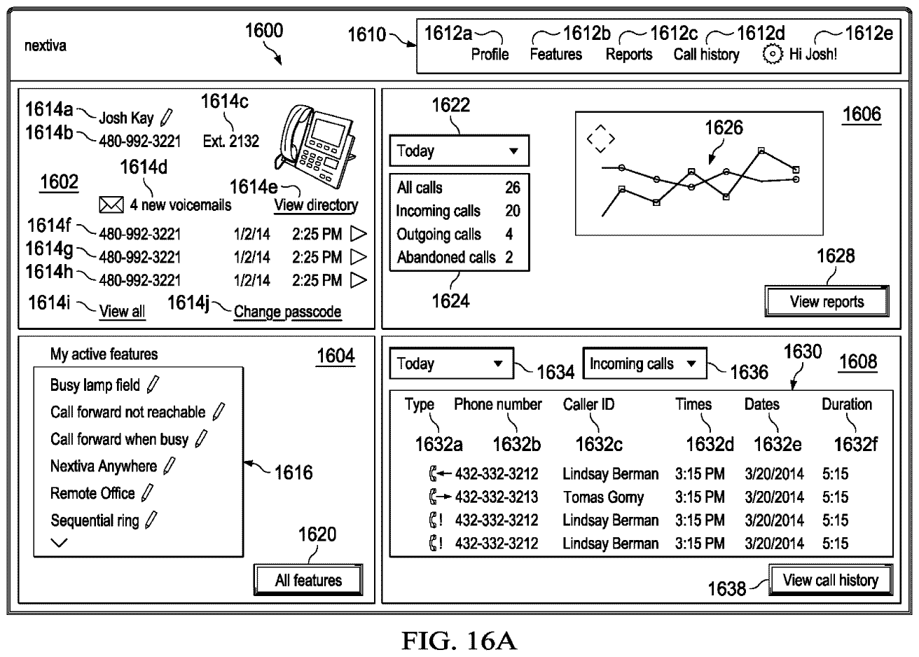

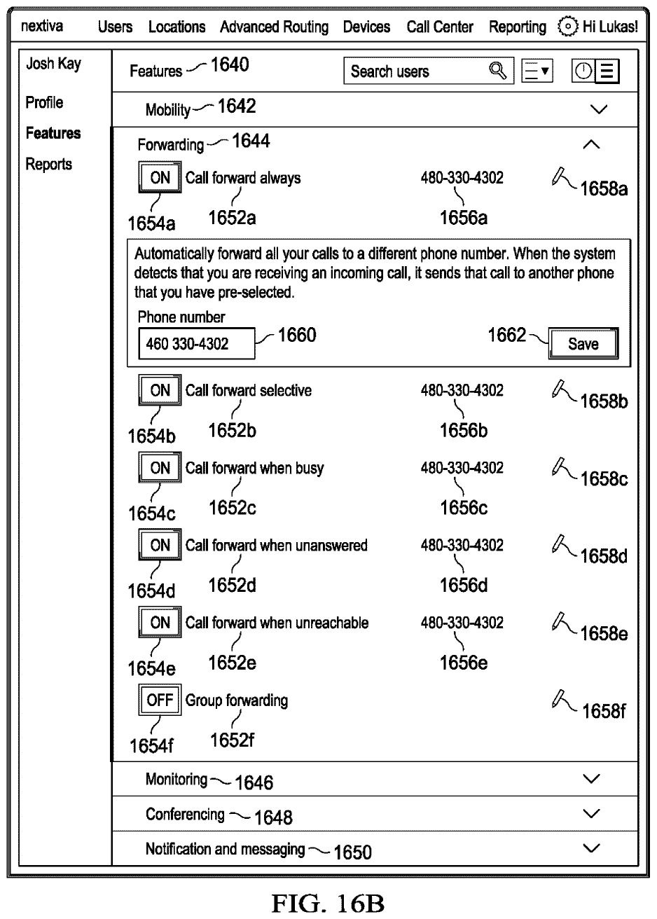

FIG. 16A illustrates a user portal 1600 of interface 500 according to an embodiment. In one embodiment, user portal 1600 provides an interface for a user that does not have administrator status. Each of the one or more end user systems 120a-120n that does not have an administrator status may have a different user portal 1600 that provides for logging into and managing a user account, such as, viewing and changing configurations and settings associated with the non-administrator account.

According to an embodiment, one or more end user systems 120a-120n are permitted to view only the functionalities that are available to them. For example, based on the settings selected by an administrator, one or more features may be shown or hidden from the non-administrative user. User portal 1600 may comprise user summary 1602, active features summary 1604, reports summary 1606, and call history 1608. User summary 1602 may comprise user name 1610a, assigned phone number 1610b, extension 1610c, voicemail indicator 1610d, link to view directory 1610e, missed calls 1610f-1610h, view all missed calls link 1610i, and change passcode link 1610j.

Active features summary 1604 may comprise a list 1612 of currently active features 1614a-1614f. Selection of one of the currently active features 1614a-1614f permits a user to edit one or more configuration settings associated with the active features 1614a-1614f. Additionally, selection of the all features button 1620 permits a user to view and edit all features 1616 available to the user by opening the user features wizard 1640. User features wizard 1640 will be discussed in more detail in connection with FIG. 16B.

Reports summary 1606 of user portal 1600 may comprise call statistics for a predefined period and charts that represent the selected statistics. According to an embodiment, reports summary 1606 comprises drop down box 1622 which permits a user to select a time period over which statistics 1624 and charts 1626 will display data relating to a user's calls. For example, the current selection for drop down box 1622 is the time period “today,” and statistics 1624 shows that the user has a total of 26 calls today, of which 20 were incoming calls, 4 were outgoing calls, and 2 were abandoned calls. Additionally, a user may elect view reports button 1628 to launch a view reports wizard, which provides for additional reports associated with the user's call data.

Call history 1608 may comprise a list 1630 of calls made to and from the user account. Call history list 1630 may comprise the type of call 1632a (such as whether the call was incoming, outgoing, or abandoned), phone number 1632b, caller ID 1632c, time of call 1632d, date of call 1632e, and duration of call 1632f. The list may be sorted according to a time period or by call type by selecting an appropriate choice in time period selection box 1634 or call type selection box 1636. According to some embodiments, a user may launch the call history wizard to a larger list of the call history and edit or modify the call history by selecting view call history button 1638.

FIG. 16B illustrates a user features wizard 1640 according to an embodiment. In response to selection all features 1616, user portal 1600 updates to display user features wizard 1640. User features wizard 1640 may permit a user to select, modify, and turn on and off various features associated with the user account. According to an embodiment, the configurations and settings may be grouped into one or more subwizards that are expanded or collapsed according to an accordion function.

In one embodiment, user features wizard 1640 may comprise mobility subwizard 1642, forwarding subwizard 1644, monitoring subwizard 1646, conferencing subwizard 1648, and notification and messaging subwizard 1650. As illustrated forwarding subwizard 1644 is expanded and comprises features 1652a-1652f that may be toggled on and off by switches 1654a-1654f and edited by edit button 1658a-1658f. Each of the features 1652a-1652f may be associated with a phone number 1656a-1656e or other setting.

In response to selection of call forward always feature 1652a, user portal 1600 expands according to the accordion function and permits a user to edit the associated phone number by a phone number edit box 1660. Changes to the phone number may be saved by selection of save button 1662. Embodiments contemplate the editing or modifying of other settings associated with each of the features 1652a-1652f according to particular needs.

As can be seen from the above disclosure, the clean structure of user interface 500 and the accordion function permits an interface to be equally useful on any sized device with any type of input, such as a laptop, tablet, smartphone, or the like. Similarly, the product has sufficient design that everyone in an organization may be able to use the interface, not simply a highly-trained technical user. Among other things, user interface 500 eliminates and reduces the number of calls that users will have to make into a help desk. In addition, embodiments provide for complex functionalities of user interface 500 to be greatly simplified according to current disclosure. For example, time to accomplish a task is greatly reduced and the number of steps are greatly reduced, that is, features now take less clicks and less time.

As an example only and not by way of limitation, if a first user is setting up a location according to customer management system 100 and wants to assign an administrator to the location but the administrator is not in the list of current administrators, prior art interfaces require abandoning the process, opening an administrator creation process, setting up a new administrator, and returning to the location setup. However, according to the present disclosure, a user may simply add an administrator in the setting up location process, greatly reducing the steps and time needed to set up the location.

By way of further example, TABLE 1 illustrates the time savings using the set up process of the current disclosure compared with prior art set up processes.

TABLE 1

| Method | # of Clicks | Total Time | Time saved |
|---|---|---|---|
| The Old Way | 124 | 165 minutes | |
| The Current Disclosure | 64 | 85 minutes | 80 minutes |

As shown above, user interface 500 of the current disclosure greatly reduces the number of clicks and amount of time to setup and/or use customer management system 100 and user interface 500. For example, and as shown above, prior art required, for example, 124 clicks, to accomplish an exemplary task, while the current disclosure requires only 64 clicks. Similarly, prior art required an additional one hour and twenty minutes of productivity time in performing the same function.

Additional evidence of the time and amount of clicks savings can be seen in TABLE 2.

### Save Time and Steps

TABLE 2

| | Old | New | | Time |
|---|---|---|---|---|
| | system | portal | Difference | saved |
| Setting up busy lamp field (BLF) | 20 | 6 | 14 | 20 mins. |
| Setting up shared call | 21 | 8 | 13 | 15 mins. |
| appearance (SCA) | | | | |
| Creating a call/hunt group | 11 | 4 | 7 | 10 mins. |
| Creating an auto attendant | 10 | 4 | 6 | 10 mins. |
| Creating a schedule | 9 | 4 | 5 | 7 mins. |
| Setting up call forwarding, always | 9 | 5 | 4 | 3 mins. |
| Setting up call forwarding, | 9 | 6 | 3 | 3 mins. |
| not reachable | | | | |
| Adding a device to the account | 6 | 4 | 2 | 3 mins. |
| Adding an administrator | NA | 4 | — | — |
| Making a payment | 3 | 5 | −2 | |

As shown above, the current disclosure “new portal” saves time and steps for every process or action.

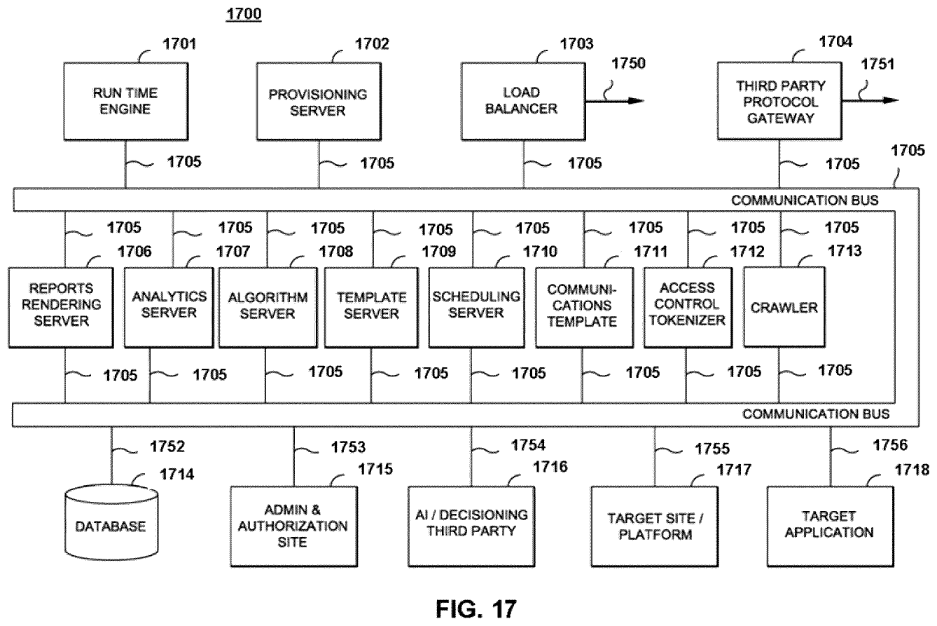

FIG. 17 shows an example system for auto-provisioning AI-based (artificial intelligence based) dialogs 1700. The figure is divided into three logical sections: The four elements at the top of the diagram represent the “Provider/Coordinator” services part of the system. The eight boxes in the middle of the diagram represent the “Microservices” part of the system. The elements at the bottom represent the “Third Party Resources” part of the system. In a preferred embodiment, all elements depicted in the diagram with the exception of the “Third Party Resources” would communicate with each other over a communication bus 1705 as described here and/or with elements of customer management system 100 via communications link 160 over network 150. At the discretion of the practitioner of the system 1700, some or many of these elements may be “collapsed” into a process or server of a more singular or monolithic nature. In no way does the articulation here of separate processes or servers or applications obviate the possibility of competently deploying the system by combining some of its elements.

The run time engine 1701 is characterized as a “Provider/Coordinator” service. A developer of computer software and networks will be familiar with the concept of an application controller or run time engine. Examples of run time software used to control other software includes, but is not limited to, the Java Virtual Machine, the Common Language Runtime component of the .NET framework by Microsoft, or the Adobe AIR runtime engine. Runtime environments also include Node.js, which enables server-side execution of JavaScript, and WebAssembly (Wasm), which allows high-performance execution of code across platforms in a secure sandbox. Additionally, Docker Engine and OCI-compliant container runtimes (e.g., containerd, CRI-O) are widely used to encapsulate and execute microservices in cloud-native environments. Tasks performed by the run time engine 1701 of the system 1700 may include, for example and without limitation: a) the operation of the overall software state machine and execution of various programs; b) performing workflow management; c) logic flow decisioning (primary decisioning for the system 1700); and d) overall coordination of various software represented in the remainder of FIG. 17. A practitioner deploying AI-based dialog systems may use Docker to containerize the runtime engine and orchestrate it via Kubernetes, enabling scalable deployment across hybrid cloud environments. Runtime coordination may also be enhanced using service mesh frameworks like Istio or Linkerd for observability and traffic control.

In a preferred embodiment, a run time engine 1701 will be employed to act as the orchestrator of various services and microservices depicted in the remainder of the figure. Most of these services and microservices communicate with one another over a communication bus, as depicted in FIG. 17 as communication bus 1705 and as depicted in FIG. 1 with elements of customer management system 100 via communications link 160 over network 150. There are many commercially available and open source communication buses that can be utilized. For example, the TIBCO Enterprise Message Service (using JMS/Java Message Service), the RabbitMQ open source message broker, or the Apache Kafka open source distributed streaming platform may be used. Modern orchestration frameworks such as Kubernetes can be used in conjunction with Kafka to manage containerized microservices, enabling dynamic scaling, health checks, and service discovery. Kubernetes also supports sidecar patterns, service mesh integrations (e.g., Istio), and declarative configuration for managing distributed systems. The communication bus 1705 may act as a communications highway for internal computing platforms in the same network. Communications with third party or cloud-based platforms used by the system 1700 may use external communications methods such as, but not limited to, REST/HTTP, Webhooks, Web Services, or even proprietary or private network-based communication channels. A practitioner may deploy Kafka as the event streaming backbone and use Kubernetes to orchestrate microservices such as analytics, reporting, and decisioning. For example, Kafka topics may be used to route dialog events between the run time engine and AI decisioning modules, while Kubernetes ensures high availability and fault tolerance.

The run time engine 1701 can be programmed to perform and coordinate overall “bot” or automation functions in concert with other elements of the system 1700 and/or with elements of customer management system 100. The use of a third party protocol gateway 1704 as described below in relation to FIG. 17 may also allow the run time engine 1701 to augment the utility of third-party bots, either by replacing their function altogether, or to communicate with them to add additional value as described throughout this disclosure. In addition, the run time engine 1701 can act as a coordinator of bot services supplied by an AI/decisioning third party 1716 as described in further detail below in relation to FIG. 17. Modern implementations of such automation functions often use agent-based frameworks or conversational AI platforms that go beyond traditional “bots.” These include generative AI agents powered by large language models (LLMs) such as OpenAI's GPT, Google's Gemini, or Anthropic's Claude. These agents can be orchestrated using frameworks like LangChain or Semantic Kernel, which allow for chaining of tasks, memory management, and integration with external APIs. A practitioner may use the run time engine to coordinate multiple AI agents that handle different dialog intents, such as customer support, scheduling, or product recommendations. These agents may be deployed using containerized services and integrated with third-party platforms via RESTful APIs or protocol gateways.

In addition to the run time engine 1701, the provisioning server 1702 is also characterized as a “Provider/Coordinator” service. The purpose of the provisioning server 1702 may be to: a) get credentials and access tokens from third party platforms and applications; b) provide secret API keys; c) get AI/decisioning deploy codes from third party AI platforms; and d) supply token and secret exchange to validate credentialed users of an admin & authorization site 1715. The provisioning server 1702 may communicate with other (internal network) aspects of the system 1700 over the communication bus 1705 and/or with elements of customer management system 100 via communications link 160 over network 150. In a preferred embodiment, the provisioning server 1702 will also communicate with “Third Party Resources” such as a database 1714; administration and authorization site 1715, AI/decisioning third party 1716, target site/platform 1717, and/or target application 1718. Such communication may happen via external communication channels 1752, 1753, 1754, 1755, and 1756 respectively. These external communication channels are described in more detail below in relation to FIG. 17. In an alternative embodiment of the system 1700, the provisioning server 1702 may also communicate with one or more “Third Party Resources” that are not externalized but rather located on the same internal network. Modern implementations of provisioning servers often use secure token exchange protocols such as OAuth 2.0, OpenID Connect, and JSON Web Tokens (JWT) to manage access to third-party AI platforms. Emerging standards such as Agentic A2A (Agent-to-Agent), Retrieval-Augmented Generation (RAG), and Model Communication Protocols (MCP) are increasingly used to facilitate secure and dynamic interactions between AI agents and external systems. A practitioner may configure the provisioning server to retrieve access tokens from platforms like OpenAI or Hugging Face using OAuth 2.0 flows, and store them securely using vault systems such as HashiCorp Vault or AWS Secrets Manager. These tokens can then be used to authenticate API calls to deploy AI models or retrieve decisioning outputs.

An example of how the provisioning server 1702 may be used to get access tokens is illustrated by using methods commonly available to developers of, for example, Facebook-ready applications. An application developer with average skills will be familiar with the idea of access tokens. These access tokens are used when a user connects to Facebook using an application that is authenticated with their user ID and password. In a preferred embodiment, the provisioning server 1702 can act as a third-party application that obtains Facebook access tokens for secure access to Facebook APIs (Application Programming Interfaces). These access tokens contain a string of data identifying a Facebook user, Facebook page, or Facebook-ready application. There are various access tokens, for example, user access tokens, app access tokens, page access tokens, and client tokens. The provisioning server 1702 can therefore be used to act as a proxy on behalf of the owner of a Facebook account, such as a Facebook Business Page. Modern best practices for managing Facebook access tokens include using the OAuth 2.0 Authorization Code Grant flow, often enhanced with Proof Key for Code Exchange (PKCE), to prevent interception and misuse. Tokens should be scoped narrowly to limit access and refreshed periodically to maintain secure sessions. Developers are advised to store tokens securely using encrypted vaults and monitor token usage to detect anomalies. A practitioner may configure the provisioning server to initiate an OAuth 2.0 flow with Facebook, where the user authenticates via a login dialog, and the server receives a short-lived access token. This token can be exchanged for a long-lived token if needed, and stored securely using systems like AWS Secrets Manager or HashiCorp Vault. The provisioning server can then use this token to interact with Facebook APIs on behalf of the user, such as retrieving page insights or posting content.

As an illustrative example of Facebook credentialization, a practitioner of the system 1700 would send a client access request via an API method provided by Facebook to start a login dialog. The user would then authenticate and approve permissions for the provisioning server 1702 to gain access to the platform. Finally, Facebook would then programmatically return the access token to the client application (the client application being the system 1700). Specifically, it is the provisioning server 1702 that acts as the client application. In a preferred embodiment, the user would grant access to the system 1700 by accessing the admin & authorization site 1753 of the system 1700 to enter his or her Facebook credentials. These credentials would then be passed by the admin & authorization site 1753 to the provisioning server 1702 where the tokens and credentials can be used on behalf of the user. A practitioner will grasp easily how the system 1700 could be used to gain access to Facebook Business Pages, once authenticated, in order to run programs for the purposes of timeline crawling and dialog automation as described below with reference to FIG. 17. Modern implementations of Facebook login dialogs rely on the OAuth 2.0 Authorization Code Grant flow, which involves redirecting the user to Facebook's login page, obtaining an authorization code, and exchanging it for an access token via Facebook's Graph API [1](https://moldstud.com/articles/p-authenticate-users-with-facebook-api-complete-guide). This process is enhanced by using PKCE (Proof Key for Code Exchange) to prevent interception and replay attacks [2](https://apidog.com/blog/facebook-oauth-2-0-access-for-website/). The access token can then be used to retrieve user profile data, manage pages, or post content, depending on the scopes granted. For example, a practitioner may configure the provisioning server to initiate the OAuth 2.0 flow using Facebook's endpoint ‘https://www.facebook.com/v19.0/dialog/oauth’, followed by a token exchange at ‘https://graph.facebook.com/v19.0/oauth/access_token’. The provisioning server would store the token securely and use it to interact with Facebook APIs such as ‘https://graph.facebook.com/v12.0/me?fields=id,name’.

The disclosed systems and methods provide for automated crawling of network-accessible content sources, including both publicly accessible websites and application-based content platforms, using substantially similar logical processes. In one embodiment, crawler 1713 may comprise one or more processors configured to generate electronic requests to remote computing systems (e.g. target site 1717 and target platform 1718), receive structured responses containing content objects and associated metadata, analyze such responses to identify relationships or references to additional content, and iteratively issue subsequent requests based on said analysis. Whether the content source is a traditional website or a social media application environment (e.g. Facebook, Twitter (aka X), Instagram, TikTok), crawler 1713 may perform the steps of content acquisition, traversal, and/or processing, based, at least in part, on the interface through which content is accessed.

In certain embodiments, access to application-based content platforms may be performed through authenticated interfaces, including application programming interfaces (APIs), service endpoints, and/or other platform-defined access mechanisms. Crawler 1713 may be configured to obtain and present appropriate credentials, tokens, or authorization artifacts that permit retrieval of content in accordance with platform-defined permissions. Upon successful authentication, crawler 1713 may issue structured requests and may receive machine-readable responses representing content items, user-generated data, media assets, and/or relational information. For example, the Graph API offered by Facebook may allow third party applications to traverse content, post, and reply on behalf of the owner of the account. These responses may be processed in substantially the same manner as web documents obtained via conventional crawling, with crawler 1713 identifying embedded identifiers, references, or graph relationships that indicate additional content available for retrieval.

In further embodiments, crawler 1713 may apply these methods to social media platforms that expose content through credentialed access models. For example, a platform may provide interfaces that return posts, videos, comments, user profiles, or engagement data in response to authorized requests. The crawler 1713 may process such responses to determine subsequent requests, thereby traversing target application 1718's and/or target platform 1717's content space in a programmatic and automated fashion. Accordingly, the disclosed methods may treat target platform 1717 and/or target application 1718 as structured content networks analogous to hyperlink-based websites, enabling systematic crawling through API-mediated interactions rather than open web requests. This approach may extend established crawling techniques to environments in which content is accessible through authenticated application interfaces while preserving the core principles of automated content discovery.

Commonly available APIs (Application Programming Interfaces) from Facebook, Twitter, and other social platforms make credentialization of these applications understandable and doable with minimum effort. Modern best practices for credentialization and token exchange with platforms like Facebook rely on the OAuth 2.0 Authorization Code Grant flow, enhanced with Proof Key for Code Exchange (PKCE) to prevent interception attacks. According to the OAuth 2.0 Security Best Current Practice (RFC 9700), developers should avoid implicit grants and instead use authorization code flows with PKCE, enforce strict redirect URI validation, and scope tokens narrowly to reduce exposure. A practitioner may configure the provisioning server to initiate a secure OAuth 2.0 flow with Facebook, using PKCE and state parameters to prevent CSRF. The server would exchange the authorization code for an access token via Facebook's Graph API and store it securely using encrypted vaults. The token would then be used to access Facebook APIs for timeline crawling, page management, or dialog automation.

In certain embodiments, system 1700 may be configured to access both structured and unstructured data made available by target platform 1717 and/or target application 1718 through authenticated interfaces. Structured data may include discrete data elements returned in response to authorized requests, such as identifiers, textual fields, timestamps, relationship descriptors, and/or metadata objects encoded in machine-readable formats. System 1700 may be configured to parse such responses using data-serialization techniques, store extracted fields in one or more data stores, and may analyze embedded identifiers or references to determine additional content available for retrieval. This process may enable systematic traversal of platform content spaces using structured data as navigational input.

Unstructured data may be accessed by system 1700 through content references provided within structured responses and/or through authenticated retrieval endpoints associated with such responses. Unstructured data may comprise free-form text, images, audio, video, and/or other media assets that are not inherently constrained to predefined schemas. System 1700 may retrieve such data using authorized requests, may store the data in raw or transformed form, and/or may associate the data with corresponding structured metadata to maintain contextual linkage. Content ingestion, indexing, and analysis may be applied without modification to platform-specific internals, thereby enabling processing of unstructured data using standard computing resources.

By combining structured data traversal with unstructured data retrieval under a unified authenticated access model, crawler 1713 may implement automated crawling of application-based platforms. Crawler 1713 may be configured to operate across multiple platforms and/or data types. The systems and/or methods disclosed herein are not limited to any particular platform, data format, or authentication provider, and may be applied to any environment in which content is programmatically accessible through credentialed interfaces.

There is no implied limitation on the operational scope of provisioning server 1702 in facilitating token-based authentication and exchange with third-party digital platforms. The provisioning server 1702 may be integrated with contemporary social media APIs such as those provided by Twitter, enabling secure token issuance and validation using OAuth 2.0 or OpenID Connect protocols. Additionally, the server may interface with mobile ecosystems including Android and iOS through platform-specific authentication frameworks such as Google Identity Services and Apple Sign-In. Proprietary applications and websites may also leverage the provisioning server 1702 for secure token exchange using standardized protocols or custom implementations. For example, a practitioner implementing this system might configure the server to issue JSON Web Tokens (JWTs) for session management across a multi-platform app suite, storing tokens securely using Android Keystore or iOS Keychain.

In addition to the run time engine 1701 and provisioning server 1702, the load balancer 1703 is also characterized as a “Provider/Coordinator” service.

There are numerous commercially available application delivery controllers and load balancers, offered in both hardware and software formats. These solutions can be deployed on physical infrastructure or virtualized platforms. Examples include Radware Alteon by Radware Ltd., BIG-IP by F5 Networks, NGINX Plus by NGINX, Inc., Cisco Application Control Engine by Cisco Systems, Inc., Citrix NetScaler by Citrix Systems, Inc., and LoadMaster by Kemp Technologies, Inc. Each of these products may serve as the load balancer 1703 within system 1700. The load balancer 1703 may communicate with other in-network components of system 1700 via communication bus 1705, and with elements of customer management system 100 through communications link 160 over network 150. Additionally, load balancer 1703 may interface with external services via communication channel 1750. For instance, it may connect to DNS services such as DNS Made Easy or Neustar, Inc., which enable geographic traffic distribution. In a preferred embodiment, the practitioner would deploy multiple geographically distributed instances of system 1700. By combining DNS-based traffic steering with localized load balancer 1703 elements, the practitioner can achieve disaster recovery and high availability. This configuration supports fault tolerance and minimizes downtime. However, such redundancy is optional and presented here solely as a preferred implementation.

Functions of the load balancer 1703 and the run time engine 1701 may include the use of a container orchestration system such as the open source Kubernetes, or Apache Mesos, or Docker Swarm. These platforms enable automated deployment, scaling, and management of containerized applications across distributed environments. For example, a practitioner might use Kubernetes to manage microservices running in containers, leveraging features such as self-healing, rolling updates, and service discovery to maintain system resilience and performance. This reference to container orchestration does not imply any limitation of the disclosed subject matter if a containerized approach to network computing is not contemplated by the particular practitioner.

In addition to the run time engine 1701, the provisioning server 1702, and the load balancer 1703, the third party protocol gateway 1704 is also characterized as a “Provider/Coordinator” service. The third party protocol gateway 1704 is the means with which external communications may be established between the system 1700 and various third party platforms. The third party protocol gateway 1704 may communicate with other internal elements of the system 1700 via the communication bus 1705 and/or with elements of customer management system 100 via communications link 160 over network 150. In addition, the third party protocol gateway 1704 may communicate with third party platforms via the communication channel 1751. The third party protocol gateway 1704 may communicate over the communication bus 1705 with “Third Party Resources” such as the database 1714, the administration and authorization site 1715, the AI/decisioning third party 1716, the target site/platform 1717, and/or the target application 1718. Such communication will happen via external communication channels 1752, 1753, 1754, 1755, and 1756 respectively. For example, a practitioner might configure the protocol gateway to translate between RESTful APIs and proprietary messaging formats to enable seamless data exchange with external AI services or legacy systems.

The purpose of the third party protocol gateway 1704 may be two-fold: First, the third party protocol gateway 1704 may contain a plurality of communication applications expressly designed to pass command and control information between the system 1700 and specific third party platforms. For example, the third party protocol gateway 1704 may include the protocols, instructions, and credentials necessary for interfacing with one or more third-party services such as Automatic Call Distributors (ACDs), email delivery platforms, SMS/Text gateways, chat platforms, websites, or social media platforms. A practitioner with average skill in service provider integration—such as with Twilio or Nexmo—will be familiar with using RESTful APIs to programmatically initiate and manage communications. For instance, sending an SMS via Twilio typically involves issuing an HTTP POST request to the Twilio API endpoint with parameters such as sender ID, recipient number, and message body, authenticated via OAuth or API keys. Similarly, initiating a WebRTC call may involve signaling through a gateway using STUN/TURN servers and exchanging session descriptions via JSON payloads. Second, the third party protocol gateway 1704 may act as a proxy for coordinating communications with third-party platforms on behalf of a specific user or subscriber of system 1700. For example, the gateway may be configured to initiate an outbound SMS notification for the owner of Facebook Business Page “X” while simultaneously triggering an outbound voice call for the owner of Facebook Business Page “Y.”

The third party protocol gateway 1704 may also be used to send text or voice-based messages to a contact center platform or digital engagement platform. These communications may be processed downstream by such platforms to distribute interactions among customer service representatives or support agents. For example, a practitioner may configure the gateway to send an SMS message using a RESTful API to a cloud-based contact center platform such as Genesys Cloud or Amazon Connect. The message payload may include metadata such as customer ID, priority level, and interaction type, which can be used by the contact center's routing engine to assign the message to the appropriate agent queue. Similarly, voice-based messages may be transmitted using SIP or WebRTC protocols and integrated into an IVR system that supports dynamic routing based on caller input or backend data lookups. These implementations typically involve secure authentication, event-driven triggers, and workflow templates that define how different types of interactions are handled.

No limitations in the use of the third party protocol gateway 1704 are contemplated. A wide range of third-party platforms, both standard and proprietary, may be connected to system 1700. These include, for example, cable set-top box networks, in-car telemetry systems, the Public Switched Telephone Network (PSTN), Private Branch Exchange (PBX) systems, and cellular networks. A practitioner implementing such integrations may use protocol adapters or gateway modules to bridge between IP-based services and legacy telephony or telemetry systems. For instance, connecting to a PSTN or PBX may involve the use of SIP-to-TDM gateways that translate signaling and media formats, allowing system 1700 to initiate or receive calls over traditional telephony infrastructure. Similarly, telemetry data from vehicles may be transmitted over cellular networks using protocols such as MQTT or HTTPS, and routed through the gateway for processing or triggering downstream actions.

The reports rendering server 1706 is characterized as a “Microservices” element of the system 1700. Its functions may include: a) rendering data for reports; b) extracting report data from the analytics server 1707; c) sending rendered report data to the admin and authorization site 1715; d) sending rendered report data to customer management system 100; and e) storing reporting data in the database 1714. The reports rendering server 1706 may communicate with other internal elements of system 1700 via communication bus 1705 and/or with elements of customer management system 100 via communications link 160 over network 150. Additionally, the reports rendering server 1706 may communicate with external resources via external communication channels 1751, 1752, 1753, 1754, 1755, and 1756 as previously described. A practitioner implementing this component may use containerized microservices to isolate the report rendering logic, enabling scalability and fault tolerance. For example, the server may be built using a stateless RESTful API that queries analytics data from server 1707, transforms it into structured formats such as JSON or CSV, and delivers it to downstream systems via secure HTTPS endpoints.

A practitioner with common knowledge of analytics and report rendering will be familiar with commercially available software for rendering reports such as Microsoft's Forerunner, amCharts, RAWGraphs, and Chart.js. Any one or more of these may be utilized as part of the function of the reports rendering server 1706. For example, a practitioner may use Chart.js to generate interactive bar or line charts by embedding a ‘<canvas>’ element in the HTML output and populating it with data using JavaScript. The rendering logic may be encapsulated in a microservice that receives structured data (e.g., JSON) from the analytics server 1707, applies a predefined chart configuration, and returns a visual report to the admin and authorization site 1715 or customer management system 100. Similarly, amCharts or RAWGraphs may be used to create more complex visualizations such as Sankey diagrams or bubble charts, with configuration driven by JSON templates stored in the template server 1709.

The reports rendering server 1706 may transmit report data to a third-party platform for downstream processing via the third party protocol gateway 1704. A practitioner with average skill in contact center infrastructure and digital engagement platforms will be familiar with the fact that such downstream systems typically include native reporting capabilities. These platforms can also ingest external report data to augment their internal analytics. For example, a practitioner may configure the reports rendering server 1706 to export structured data in JSON or CSV format via RESTful API endpoints, which can then be consumed by platforms such as Genesys Cloud, NICE CXone, or Salesforce Service Cloud. This data may include performance metrics, customer interaction summaries, or sentiment scores, which are used to enrich dashboards, trigger alerts, or feed predictive models.

The analytics server 1707 is characterized as a “Microservices” element of the system 1700. Its functions may include: a) executing software subroutines to enrich existing datasets with new, relevant data; b) analyzing customer interactions with bots, applications, and timelines; c) storing analytics results in database 1714 using templates defined in template server 1709; and d) generating recommendation data for downstream decisioning by the run time engine 1701 and/or the AI/decisioning third party 1716. The analytics server 1707 may communicate with other internal elements of system 1700 via communication bus 1705, and with elements of customer management system 100 via communications link 160 over network 150. It may also interface with external resources via communication channels 1751 through 1756 as previously described. A practitioner implementing this component may use containerized microservices to isolate analytic functions such as data ingestion, transformation, and model inference. For example, one microservice may apply machine learning models to classify customer sentiment based on chat transcripts, while another may generate predictive scores for customer churn. These services may be orchestrated using Kubernetes and exposed via RESTful APIs for consumption by downstream systems. Semantic data modeling may also be used to ensure interoperability across heterogeneous data sources.

The algorithm server 1708 is characterized as a “Microservices” element of the system 1700. It may communicate with other internal elements of system 1700 via communication bus 1705, and with elements of customer management system 100 via communications link 160 over network 150. In addition, the algorithm server 1708 may communicate with external resources via external communication channels 1751, 1752, 1753, 1754, 1755, and 1756 as described earlier. A practitioner implementing this component may deploy the algorithm server as a stateless microservice responsible for executing computational logic such as scoring models, rule-based decision trees, or real-time data transformations. For example, the server may receive structured input from the analytics server 1707, apply a predictive algorithm (e.g., decision forest or logistic regression), and return a decision payload to the run time engine 1701 or an external AI service. These microservices may be containerized using Docker and orchestrated via Kubernetes, with APIs exposed for synchronous or asynchronous invocation. This approach supports modularity, scalability, and fault isolation.

The algorithm server 1708 may be used to run a variety of software instructions that include but are not limited to a frequency algorithm that parses text and extracts relevant, frequent entries. In a preferred embodiment, the text being analyzed is based on dialogs in a social timeline, mobile application, or web site application. Frequency algorithms may also be applied to email history, chat transcripts, or transcribed voice recordings to extract meaningful patterns. A practitioner with common knowledge in natural language processing and linguistic modeling will be familiar with the use of N-gram frequency profiles, which are a standard method for document categorization and classification tasks. For example, a practitioner may implement a trigram model to identify recurring phrases in customer support chats, using tokenization and frequency thresholds to isolate high-value expressions. These models can be built using open-source tools such as MIT's N-Gram Extraction Toolkit, the Online Ngram Analyzer, or SunPinyin's open-gram utilities.

The algorithm server 1708 may also assemble relevant text into appropriate answers including the sentiment or tone of the speaker, and the length of responses and dialog. This assembly of relevant text may be based on the N-gram as a unit of analysis, determined by the number of phonemes in a word or phrase. A practitioner with experience in natural language processing will recognize that phoneme-based N-gram models can be particularly useful for analyzing spoken or transcribed text, where phonetic structure influences tone and intent. For example, a practitioner may use a phoneme trigram model to detect emotional cues in voice recordings, mapping frequent phoneme sequences to sentiment categories such as frustration or satisfaction. These models may be implemented using open-source phoneme tokenizers and integrated with speech-to-text pipelines.

The algorithm server 1708 may be used to perform a series of important tasks, including: a) separating audience responses from administrator or automated responses; b) performing frequency analysis on N-Gram lengths; c) adding N-grams to a corpus or pool of text based on pre-defined frequency criteria; d) performing sentiment analysis to remove audience “noise” from the potential pool; e) extracting noise and or complaints from the main pool for offline analysis; f) flagging outliers for administrative attention or escalation; g) ranking pools by frequency based on giving a higher rank to elements with greater number of appearances; h) examining bi- and tri-grams for potential sub-topics for answer specificity; i) correlating short-length N-grams with sentence-level N-grams to get statement sets; j) correlating short-length N-grams with sentence-level N-grams; and k) performing extraction and parsing data for downstream assembly and coordination with the template server 1709 and AI/decisioning third party 1716 elements. A practitioner implementing these functions may use a graph-based N-gram model to represent text as interconnected units, where each N-gram is a node and adjacency relationships are modeled as edges. This structure allows for efficient classification, topic modeling, and anomaly detection. For example, frequent bi-grams may be clustered to identify emerging subtopics, while low-frequency or sentiment-tagged N-grams may be flagged for escalation.

The template server 1709 is characterized as a “Microservices” element of the system 1700. It may communicate with other internal elements of system 1700 via communication bus 1705, and with elements of customer management system 100 via communications link 160 over network 150. In addition, the template server 1709 may communicate with external resources via external communication channels 1751, 1752, 1753, 1754, 1755, and 1756 as described earlier. A practitioner implementing this component may use the template server to store and serve reusable configuration templates for rendering reports, assembling responses, or coordinating decision logic. These templates may be defined in JSON, XML, or YAML formats and versioned using Git-based repositories. For example, a practitioner may define a report rendering template that specifies layout, data bindings, and conditional logic, which is then consumed by the reports rendering server 1706. The template server may also expose RESTful endpoints for dynamic retrieval and update of templates, supporting runtime customization.

The template server 1709 may be configured to generate and modify structured templates for the normalization of textual data, particularly in environments involving unstructured or semi-structured inputs. This operation is performed in coordination with the algorithm server 1708, which applies computational models to interpret and transform the data; the analytics server 1707, which performs statistical and semantic evaluations; and the admin and authorization site 1708, which manages access control and template governance. In a preferred embodiment, the analytics server 1707 manages the data sets generated in response to template-driven queries and stores them in the database 1714 for persistent access and downstream processing. In an alternate embodiment, the template server 1709 may retain these data sets locally, utilizing the database 1714 as a backup or archival repository.

In certain embodiments, system 1700 may be further configured to process semi-structured data, which may comprise data that contains both machine-discernible structural elements and variable and/or free-form content. Semi-structured data may include, by way of example only and not by way of limitation, markup-based documents, key-value records, message payloads, logs, annotated text, and/or application responses that may follow a partial schema and may permit inconsistent or optional fields. In embodiments, semi-structured data may be parsed by identifying delimiters, tags, field labels, and/or hierarchical relationships without requiring a fully rigid data model.

The template server 1709 may be configured to generate, store, and apply structured templates that define expected fields, patterns, or semantic anchors within semi-structured inputs. These templates may specify extraction rules, normalization mappings, and/or transformation logic that convert semi-structured data into a more uniform representation. In operation, the algorithm server 1708 may apply computational models to align incoming data with the defined templates. The analytics server 1707 may evaluate extracted elements for statistical relevance, semantic consistency, relational correlation and/or combinations thereof. Through this coordinated processing, semi-structured data may be progressively normalized into structured datasets for storage, querying, analysis and/or combinations thereof.

In preferred embodiments, analytics server 1707 may manage datasets produced from template-driven processing of semi-structured data and may store the resulting normalized representations in database 1714 for example, for persistent access and downstream use. In alternate embodiments, template server 1709 may retain intermediate or finalized datasets locally, with database 1714 serving as a backup and/or archival repository. System 1700 may be configured for transforming semi-structured inputs into structured, analytically usable forms across varying data environments.

In a preferred embodiment, the template server 1709 would be used to create, store, and modify pre-defined templates specific to industry vertical business targets. These templates, which may take the form of editable structured forms, are used to model the assembly of text dialog corpora. This modeling facilitates the definition of question-and-answer treatments appropriate for distinct application-specific corpora, enabling targeted semantic extraction and dialog structuring. Such an approach supports scalable deployment across varied sectors such as healthcare, finance, and logistics, where domain-specific language and interaction patterns differ significantly.

For example, if the system 1700 were to be deployed for use with a Facebook Business Page servicing a restaurant, the template server 1709 could be used to define and re-use templates for “most popular menu item questions” and “most popular menu item answers.” Such templates may be seeded with reusable question-answer pairs applicable across restaurant domains and tagged with relevant N-gram lengths to support dialog modeling. For instance, a practitioner may associate modal responses as quadrigrams (four-word sequences) with “most popular menu item questions,” and as pentagrams (five-word sequences) with “most popular menu item answers.” This tagging enables system 1700 to perform granular semantic parsing and improve response prediction accuracy.

There is no limitation in the way in which the template server 1709 may be implemented by the practitioner of the system 1700. For example, a preferred embodiment may include a default N-gram length, but a practitioner may wish to implement a variable length to tune system 1700 for specific dialog modeling needs. System 1700 may also support randomized or frequency-based responses, allowing the practitioner to define template attributes that influence response selection behavior. These attributes may be configured to optimize semantic granularity, conversational tone, or domain-specific language patterns.

Separate templates may be used to model corpora assembly for stored email threads, SMS threads, chat threads, or transcribed voice recordings. These templates may be configured to reflect the structural and semantic characteristics unique to each communication modality, enabling more accurate parsing and normalization of dialog content. For example, email threads may be modeled with hierarchical reply structures, while SMS and chat threads may emphasize brevity and turn-taking. Transcribed voice recordings may require additional tagging for speaker identification and temporal segmentation. No awarded U.S. patent was found that directly addresses this specific implementation.

The overall ability of the system 1700 to extract text data, assemble text data, connect (run frequency algorithms and conform to templates), deploy, analyze and update lends itself to by-products that go beyond the automated provisioning of automated dialogs. An example by-product is an automatically generated FAQ. In concert with the crawler 1705, the AI/decisioning third party 1716, and the scheduling server 1710, the template server 1709 can be used to normalize FAQ (frequently asked questions and answers) templates so the publishing of auto-generated FAQs can be achieved.

The scheduling server 1710 is implemented as a microservices-based component within system 1700. This architectural choice enables modular deployment, scalability, and fault isolation, consistent with modern cloud-native design principles. The scheduling server 1710 interfaces with other internal components of system 1700 via communication bus 1705, facilitating low-latency, intra-system messaging. It also connects to the customer management system 100 through communications link 160 over network 150, which may be configured using RESTful APIs or gRPC for efficient service-to-service communication. Furthermore, the scheduling server 1710 interacts with external systems via designated communication channels 1751 through 1756, which may include third-party APIs, cloud-based services, or federated data sources. A practitioner example includes deploying the scheduling server as a containerized service within a Kubernetes cluster, using service mesh technologies like Istio to manage traffic routing and security policies.

The scheduling server 1710 may be used to send commands to the crawler 1713 to periodically re-crawl the target site 1717 and/or target application 1718 to extract new text. This functionality is typically invoked following the initial deployment of system 1700 on a designated target site or application. The target site 1717 and/or target application 1718 may encompass a wide range of digital sources, including but not limited to social media timelines, mobile applications, websites, transcribed voice recordings, email bodies, SMS messages, and chat interfaces. System 1700 may imposes no restrictions on the nature of the target application, provided that programmatic access and data extraction mechanisms are available-such as APIs, SDKs, or scraping interfaces. A practitioner example includes configuring the crawler to use headless browser automation (e.g., Puppeteer or Selenium) for dynamic content extraction from JavaScript-heavy web applications, while leveraging webhook-based triggers for real-time updates from chat platforms. No suitable U.S. patent was identified that directly addresses a scheduling server controlling a crawler to extract data from such a diverse set of sources.

In certain embodiments, scheduling server 1710 may be configured to control temporal and/or event-driven execution of crawler 1713 across multiple heterogeneous content sources. Such sources may include web-based platforms, application-based environments, messaging systems, media repositories, and/or other digitally accessible interfaces. Scheduling server 1710 may generate, for example, crawl instructions specifying target identifiers, access methods, execution frequency, and/or scope parameters, and may transmit such instructions to crawler 1713 for execution. Scheduling server 1710 and crawler 1713 may provide one or more functionalities independent of the content source type and may perform consistent re-crawling, change detection, and/or incremental data extraction across diverse environments using scheduling and task-queue mechanisms.

Crawling from a diverse set of sources may differ primarily in the access modality and trigger conditions rather than in the fundamental crawling logic. For example, certain sources may expose pull-based interfaces, such as APIs or scraping-accessible endpoints, while others may provide push-based mechanisms, such as webhooks, event streams, or subscription notifications. Crawler 1713 may be configured to select an appropriate acquisition technique based on source characteristics, including authenticated API requests, headless browser execution for dynamically rendered interfaces, software development kits (SDKs) for mobile or embedded applications, or message listeners for communications platforms. In each case, crawler 1713 may retrieve new or modified content, may process the retrieved data, and/or may store the results using substantially the same ingestion and normalization pipeline.

Relative to the Facebook example described above, crawling from other sources may differ in the degree of structure, access control, and update signaling. In the Facebook example, content may be accessed through a credentialed API that returns structured responses in accordance with platform-defined schemas. In contrast, crawling of websites or JavaScript-heavy applications may require rendering and DOM inspection, while messaging systems or voice transcription feeds may provide event-driven content without hierarchical navigation. System 1700 may apply a uniform crawling framework in which scheduling server 1710 may govern execution, crawler 1713 may adapt an access mechanism to a target source, and extracted content may be processed using common downstream components. System 1700 may be configured to implement scheduled, automated crawling across a broad range of digital sources and may be capable of extending beyond any single platform-specific example.

One example of software utilities that function as subroutines to implement timer-based operations is the “cron” utility in Unix-like operating systems, which facilitates time-based job scheduling. This utility enables the execution of commands, shell scripts, or other scheduled tasks at defined times, dates, or intervals. The use of cron provides for automating routine administrative functions, such as downloading files from remote servers or retrieving chat and email transcripts at regular intervals. A nonlimiting example includes configuring a cron job to invoke a Python script every hour to poll a messaging API and archive incoming messages to a local database.

In a preferred embodiment, the practitioner of system 1700 may configure the scheduling server 1710 to orchestrate a range of time-based and event-driven operations. These include: (a) initiating re-crawling of target applications post-deployment in coordination with crawler 1713; (b) scheduling notifications or escalation events in conjunction with third-party protocol gateway 1704; (c) coordinating notifications or escalations with system administrator 110 and/or communication devices 124; (d) executing periodic authentication and control token routines in collaboration with access control tokenizer 1712; (e) triggering analytics routines at defined intervals in concert with analytics server 107; (f) managing the distribution or refresh of reports in coordination with reports rendering server 1706 and admin & authorization site 1715; and (g) scheduling the publication of FAQs in coordination with target site/platform 1717 and/or target application 1718. A practitioner example includes deploying a scheduling server that uses a priority-based task queue to manage concurrent operations across microservices, with escalation logic for time-sensitive tasks.

The communications template 1711 is characterized as a “Microservices” element of the system 1700. This design enables modular communication logic that can be independently deployed and scaled. The communications template 1711 interfaces with other internal components of system 1700 via communication bus 1705, supporting service-to-service messaging and orchestration. It also connects to the customer management system 100 through communications link 160 over network 150, which may utilize RESTful or event-driven protocols. Additionally, the communications template 1711 communicates with external systems via designated communication channels 1751 through 1756, which may include third-party messaging platforms, notification services, or federated data endpoints. A practitioner example includes deploying the communications template as a stateless microservice using container orchestration (e.g., Kubernetes) and integrating it with a message broker such as Apache Kafka for asynchronous communication.

The communications template 1711 may be used to define, edit and store specific third-party credentials, addresses, and sign-on protocols that work in concert with the system 1700. Such templates may be made available downstream to customer management system 100, third-party protocol gateway 1704, admin & authorization site 1715, target site/platform 1717, and/or target application 1718. The communications template 1711 may, for example, store rules governing communication syntax, structural formatting, handshaking protocols, and endpoint metadata to accommodate the diverse and often proprietary mechanisms by which third parties expose access to their systems via protocol gateways. A practitioner example includes using the communications template to dynamically generate OAuth2 credential payloads for integration with external APIs, while enforcing endpoint-specific handshaking rules.

In certain embodiments, communications template 1711 may be configured to abstract and normalize credential, endpoint, and/or protocol requirements associated with third-party service providers, including large-scale cloud and platform operators such as Google, Google Cloud Platform (GCP), and Amazon Web Services (AWS). Such providers may expose access to services through a combination of identity frameworks, service endpoints, and protocol conventions that, while standardized at a high level, differ in implementation details. Communications template 1711 may store provider-specific parameters including authentication method identifiers, token exchange rules, endpoint metadata, request formatting constraints, and renewal policies, thereby enabling system 1700 to interact with multiple providers through a consistent internal interface.

For example, when integrating with Google or GCP services, communications template 1711 may define rules for generating and managing OAuth-based credentials, service account assertions, and/or identity tokens used to access APIs such as data services, messaging systems, or application endpoints. Communications template 1700 may specify required scopes, token lifetimes, audience parameters, and/or endpoint URLs, allowing system 1700 to dynamically construct credential payloads and handshake sequences appropriate to the selected Google service. Similarly, for Amazon or AWS environments, communications template 1711 may encode rules for request signing, credential rotation, region-specific endpoints, and service identifiers, enabling system 1700 to generate properly formatted authentication headers or authorization artifacts required to access AWS-managed APIs or resources.

By encapsulating these provider-specific access requirements within communications template 1711, system 1700 may provide integration with Google-, GCP-, or Amazon-hosted services without modifying core system logic or introducing platform-dependent constraints. The template-driven approach may permit dynamic selection, update, and governance of third-party communication protocols, while downstream components consume a normalized representation of credentials and endpoints. System 1700 may implement third-party integrations across heterogeneous provider ecosystems and may provide a generalized mechanism for managing proprietary and semi-proprietary access protocols.

The access control tokenizer 1712 is characterized as a “Microservices” element of the system 1700. This architectural approach allows for modular and scalable access control logic that can be independently deployed and maintained. The access control tokenizer 1712 communicates with other internal components of system 1700 via communication bus 1705, enabling secure and efficient intra-system authorization workflows. It also interfaces with the customer management system 100 through communications link 160 over network 150, which may utilize token-based authentication protocols such as OAuth2 or JWT. Additionally, the access control tokenizer 1712 may interact with external systems via communication channels 1751 through 1756, supporting federated identity and access management across third-party platforms. A practitioner example includes deploying the tokenizer as a stateless microservice that issues and validates access tokens using a centralized identity provider, while enforcing fine-grained access policies through service mesh integration.

One purpose of the access control tokenizer 1712 may be to retrieve deployment codes from the AI/decisioning third party 1716 in order to automatically deploy a bot and/or crawler 1713 function on the target site/platform 1717 and/or target application 1718. Another purpose of the access control tokenizer 1712 may be to retrieve authorization tokens and/or keys from the target platform or application. The practitioner of the system 1700 may program the access control tokenizer 1712 to store these deployment codes, authorization tokens and/or keys in the database 1715 for downstream retrieval by the run time engine 1701, provisioning server 1702, and third party protocol gateway 1704. A practitioner example includes configuring the tokenizer to interface with an external identity provider to retrieve OAuth2 bearer tokens and deployment credentials, which are then securely stored in an encrypted database for use by downstream orchestration services.

In a preferred embodiment, the access control tokenizer 1712 is central to the automatic deployment and provisioning of timeline dialogs. This is due to the fact that automating the retrieval and management of tokens and deployment codes is a labor-intensive process when performed manually or with human intervention. The practitioner of system 1700 will note that the access control tokenizer 1712 may be used in concert with the scheduling server 1710 to periodically re-authenticate tokens for target applications, thereby enabling automated re-authentication routines. A practitioner example includes configuring the tokenizer to interface with an external identity provider to retrieve refresh tokens and deployment credentials, which are then periodically validated and renewed using scheduled tasks.

FIG. 17 further depicts the crawler 1713, which is characterized as a “Microservices” element of the system 1700. This modular design allows the crawler 1713 to be independently deployed and scaled for targeted data extraction tasks. The crawler 1713 communicates with other internal components of system 1700 via communication bus 1705, enabling coordinated operations with other microservices. It also interfaces with the customer management system 100 through communications link 160 over network 150, which may utilize secure API calls or event-driven messaging. Additionally, the crawler 1713 may interact with external systems via communication channels 1751 through 1756, supporting integration with third-party platforms, data sources, or content repositories. A practitioner example includes deploying the crawler as a containerized service using headless browser automation to extract structured and unstructured data from dynamic web applications.

The use of crawling technology will be understood by the average practitioner of software and text document disciplines. Crawling forms the foundation of search engines on the World Wide Web and is also widely used in enterprise environments for internal document management. A crawler is essentially an automated program that programmatically scans text data across web-based and other digital platforms to generate a structured index of content. There are numerous crawling platforms available to practitioners, many of which are open source, including Nutch, Heritrix, Hounder, WebEater, and LARM. A practitioner example includes deploying an open-source crawler configured with custom parsing rules to extract metadata and content from enterprise document repositories.

Of particular utility for the deployment of the system 1700, the crawler 1713 may be used to scan text on the target site/platform 1717 and/or the target application 1718. In addition, the crawler 1713 may be used by the practitioner of system 1700 to scan and tabulate text from email platforms, chat platforms, SMS platforms, or even transcribed voice recordings. No limitation is implied regarding the type or format of text that may be crawled. A practitioner example includes configuring the crawler to interface with multiple APIs and data endpoints, enabling ingestion of structured and unstructured text from diverse communication platforms.

In a preferred embodiment of the system 1700, the resulting text collected by the crawler 1713 may be stored in the database 1714 for downstream use by other elements of the system 1700. For example, a downstream use of crawled data may be the application of AI or decisioning subroutines performed by the algorithm server 108 and the AI/decisioning third party 1716. A practitioner example includes configuring the system to pass indexed text from the crawler into a machine learning pipeline for entity recognition, sentiment analysis, or classification.

In a preferred embodiment of the system 1700, the resulting text collected by the crawler 1713 may be stored in the database 1714 for downstream use by other elements of the system 1700. For example, a downstream use of crawled data may be the application of AI or decisioning subroutines performed by the algorithm server 1708 and the AI/decisioning third party 1716. A practitioner example includes configuring the system to pass indexed text from the crawler into a machine learning pipeline for entity recognition, sentiment analysis, or classification.

FIG. 17 further depicts the database 1714, which is characterized as a “Third Party Resource” element of the system 1700. The database 1714 may communicate with other elements of the system 1700 via the communication bus 1705 over communication channel 1752. The database 1713 may communicate with elements of customer management system 100 via communications link 160 over network 150. In addition, the database 1714 may communicate with external resources, such as the admin & authorization site 1715, the reports rendering server 1706, the template server 1709, and the third party protocol gateway 1704, over communication channels 1753 and 1705. A practitioner may implement system 1700 in such a way that individual non-database elements of the platform access database 1714 by proxy via another process or element as part of the overall system 1700. A direct communication path to database 1714 should not be construed as a limitation of the disclosed subject matter.

FIG. 17 further depicts the admin & authorization site 1715, which is characterized as a “Third Party Resource” element of the system 1700. The admin & authorization site 1715 may communicate with other elements of the system 1700 via the communication bus 1705 over communication channel 1753. The admin & authorization site 1715 may communicate with elements of customer management system 100 via communications link 160 over network 150. The purpose of the admin & authorization site 1715 may be to provide administrators and other users of the system 1700 with access to the platform from a common UI (user interface) for the purpose of defining templates, entering application target data, stipulating schedules, running reports, defining permissions for users and target sites and applications, and making changes to third party platform access permissions and configuration.

A practitioner with average skill in web site and web page design will be familiar with commercially available and open source programs and tools for building secure web pages that provide UI access to forms and sign-in functions. For example, tools for the purpose of constructing web site forms can be obtained from 123Form Builder and Zoho Forms. These tools are essential for implementing secure data collection workflows that comply with modern privacy regulations such as HIPAA, GDPR, and CCPA. Commercially available platforms such as 123FormBuilder and Zoho Forms offer drag-and-drop interfaces, API integration, and built-in compliance features including TLS/SSL encryption, reCAPTCHA, and role-based access control. For example, 123FormBuilder provides developers with a secure API that supports real-time data transfer to CRMs like Salesforce, automated workflows via webhooks, and HIPAA-compliant form templates, making it suitable for regulated industries such as healthcare and finance. Open-source alternatives such as Crudin, Xataface, VFront, and Tellform offer customizable frameworks for form generation and database interaction, though they may require additional configuration to meet enterprise-grade security and compliance standards. A practitioner implementing a secure intake form for a healthcare portal might use 123FormBuilder's API to encrypt patient data end-to-end, validate inputs server-side, and automate EHR updates—all while maintaining audit logs for compliance. For developers preferring open-source solutions, Tellform can be extended with middleware to support OAuth2 authentication and HTTPS transport. These tools collectively enable practitioners to build secure, scalable, and compliant web interfaces for user data entry.

In a preferred embodiment, the practitioner of the system 1700 will set up authorities that dynamically hide or display certain forms and functions depending on the credentials of the person accessing the admin & authorization site 1715. This implementation aligns with modern principles of zero trust architecture and least privilege access, which are critical in secure web environments. Tools for credential and secrets management are widely available and include enterprise-grade solutions such as HashiCorp Vault, Passbolt, and CyberArk. For example, HashiCorp Vault supports dynamic secrets provisioning, enabling credentials to be generated on-demand and automatically revoked, thereby minimizing exposure windows. A practitioner might use Vault's identity-based access policies to restrict form visibility based on LDAP group membership or JWT claims. Passbolt, an open-source password manager, integrates with GPG and supports team-based credential sharing with fine-grained access control. CyberArk's solutions, including its Application Access Manager, are designed for secure credential injection into applications without hardcoding secrets.

Once authorities are established, the admin and authorization site 1715 can be segmented into functional modules to support secure and scalable operations. These modules may include: a) an administrative login section for making configuration changes at the target application or enterprise level; b) a template management section for defining rules governing text extraction, transformation, and assembly; c) a section for managing third-party communication tokens and protocols, including OAuth2, JWT, and webhook configurations; d) a reporting section for defining and executing analytics queries and visualizations; e) a notification and escalation section for integrating with third-party digital engagement platforms or contact center systems such as Twilio, Genesys, or Nextiva; f) a scheduling interface for managing timed tasks and cron-like job execution; g) a workflow and decision logic section governed by the runtime engine 1701 or external AI/decisioning service 1716; and h) an algorithm management section for accessing, editing, and deploying algorithms hosted by the algorithm server 1708. A practitioner implementing this segmentation might use a microservices architecture with containerized services for each module, secured via role-based access control and API gateways.

In an alternative embodiment, separate user-specific applications can be created for non-web use and access depending on the role of the user. These applications may include native desktop clients, mobile applications, or embedded system interfaces, and can be configured to enforce role-based access policies independent of browser-based administration tools. This approach supports deployment in environments where web-based UIs are impractical or restricted, such as secure mobile platforms, offline enterprise systems, or specialized industrial devices. In no way is a preferred method of using a web-based administration UI meant to be a limitation of the disclosed subject matter.

FIG. 17 further depicts the AI/decisioning third party 1716, which is characterized as a “Third Party Resource” element of the system 1700. The AI/decisioning third party 1716 may communicate with other elements of the system 1700 via the communication bus 1705 over communication channel 1754. Additionally, it may interact with elements of the customer management system 100 through communications link 160 across network 150, which may include public or private IP-based infrastructure. The AI/decisioning third party 1716 is designed to perform two primary functions: (i) ingest and index a defined corpus of textual data to enable programmatic search and retrieval using natural language processing (NLP) techniques; and (ii) generate and expose conversational agents—commonly referred to as “chatbots”—via an Application Programming Interface (API), allowing external systems to initiate and manage dynamic dialogues. For example, a practitioner may implement this using a transformer-based model such as GPT or BERT to parse and embed the corpus, and deploy the chatbot using RESTful API endpoints integrated with a cloud-based orchestration layer.

A practitioner familiar with NLP (Natural Language Processing) and Machine Language Learning will be familiar with open source tools for creating both a discovery- and conversation-based program. In a preferred embodiment, a commercially available service is easily attainable for this purpose. For example, IBM's Watson Discovery Service and Watson Assistant Service remain viable enterprise-grade solutions, offering secure, multilingual conversational AI and document insight mining capabilities. While the term “bot” is often used informally to describe automated dialogue systems, the more precise term of art in enterprise and academic contexts is “conversational agent,” which refers to a system capable of maintaining context-aware, multi-turn interactions using structured or generative models. Practitioners may also consider modern alternatives such as OpenAI's ChatGPT Enterprise, Google Dialogflow CX, Amazon Lex, and Microsoft Azure Bot Service, each of which provides scalable, cloud-based platforms for building conversational agents with advanced NLP and integration features. For open-source implementations, frameworks such as Rasa (Python-based with advanced NLU), Botpress (JavaScript-based with visual flow editor), and ChatterMate (optimized for large language models and rapid deployment) offer customizable environments for chatbot development. A practitioner may, for instance, use Rasa to build a multi-turn dialogue system with contextual awareness, integrating it with enterprise APIs for customer support automation.

It is important to contemplate the operational limitations of NLP (Natural Language Processing), AI (Artificial Intelligence), and other machine learning systems in real-world deployment scenarios. Despite advances in transformer-based architectures, multimodal learning, and fine-tuning techniques, these systems do not autonomously provision themselves for use on a target social platform, website, or enterprise application. They lack native capabilities for automated content crawling, template adherence, or self-publication workflows. Instead, they require deliberate orchestration, including infrastructure provisioning, API integration, data mapping, and compliance validation. For example, deploying a conversational agent to a regulated financial services portal may involve aligning the model's output with legal disclaimers, user authentication protocols, and audit logging mechanisms. These systems are highly configurable but demand significant engineering effort and cross-functional planning to ensure secure and compliant integration. Accordingly, the AI/decisioning third party 1716 is contemplated as a third-party subsystem within the disclosed inventive subject matter and does not embody the spirit of the invention itself—that spirit being the complete automation of the provisioning of AI-based dialog services.

Nonetheless, it is instructive for the prospective practitioner of system 1700 to be familiar with the foundational capabilities of corpus analysis and conversational agent platforms when contemplating alternatives for the AI/decisioning third party 1716. Among the most widely adopted solutions is OpenAI's ChatGPT Enterprise, which enables ingestion of large corpora and supports conversational interfaces via both API and GUI. A practitioner may implement ChatGPT Enterprise to analyze a given corpus as input. Once the corpus is ingested, the system applies transformer-based algorithms to embed and index the content, making it searchable and contextually accessible across associated services. A practitioner may connect ChatGPT Enterprise to a search engine or integrate it with a front-end conversational agent, enabling dynamic dialogue generation. These agents can be accessed programmatically via API or configured through graphical interfaces provided by the platform. The core logic structure of such systems typically revolves around constructs such as intents (representing user goals) and entities (representing extracted data), which are foundational to dialogue orchestration. Other popular platforms include Google Dialogflow CX, Amazon Lex, Microsoft Azure Bot Service, and IBM's Watson Discovery Service and Watson Assistant Service, all of which offer enterprise-grade capabilities for corpus analysis and conversational agent deployment.

Intents are conversational stems (e.g., “how are you,” “how's it going,” “what's up,” “how's it hanging”) that convey similar meanings and are used to infer user goals. In traditional NLP-based systems, such as those implemented using IBM Watson Assistant or Google Dialogflow, a creator manually defines these intents and trains the system to recognize variations using labeled examples. The platform then extrapolates additional phrasings through rule-based or statistical models. In modern generative AI systems, such as those built on OpenAI's ChatGPT Enterprise or Anthropic's Claude, intents are not explicitly defined but are instead inferred dynamically using transformer-based architectures that model semantic relationships across large corpora. A practitioner using ChatGPT Enterprise, for example, may upload a corpus and configure system behavior through prompt engineering and API parameters, allowing the model to anticipate user goals without manual enumeration of intents. Nonetheless, the concept of intents remains relevant in structured dialogue design, particularly when integrating conversational agents with deterministic workflows or regulatory constraints.

Entities are conceptual units used to classify and extract specific data from user input. For example, an entity for colors might include red, orange, yellow, green, blue, indigo, and violet, while one for fruits might include apples, pears, oranges, bananas, kiwis, strawberries, and raspberries. (These entities may be separate and distinct from one or more entities 140, as discussed above.) In traditional NLP-based platforms such as IBM Watson Assistant or Google Dialogflow, entities are manually defined and used to shape dialogue flows by enabling conditional logic based on user-provided values. Unlike intents, which may be extrapolated or inferred through training data, entities are typically static and do not generalize beyond their defined scope. For example, in a restaurant-related dialogue flow, a practitioner may define an entity for days of the week. If a user asks about Saturday operating hours, the system can detect “Saturday” as a recognized entity and return information specific to that day. The creator would have explicitly defined “Saturday” as part of the entity set and configured the dialogue accordingly. In modern generative AI systems, such as those built on large language models (LLMs), entity extraction is increasingly handled through dynamic inference and contextual modeling. A notable example is the GPT-NER framework, which reformulates entity recognition as a generation task, enabling large language models to identify and label entities with minimal supervision and improved adaptability.

Once the practitioner establishes the associated intents and entities, the conversational agent platform—whether implemented via OpenAI's ChatGPT Enterprise, Google Dialogflow CX, Rasa, or IBM Watson Assistant (WAS) or even a proprietary platform—constructs dialogue functions as a series of nodes or modular steps. In traditional systems such as WAS and Dialogflow, these nodes are order-specific, forming a dialogue tree that the system traverses sequentially based on user input and predefined logic. Child nodes are nested beneath parent nodes, and when the dialogue enters a parent/child structure, only the nodes within that tree are evaluated unless an external intent or entity triggers a transition. This hierarchical structure is designed to optimize response time and maintain contextual awareness. In modern generative systems, such as those built on transformer-based architectures, dialogue flow may be modeled more flexibly, using probabilistic inference and contextual embeddings rather than rigid node trees. However, structured node-based design remains essential when integrating conversational agents with deterministic workflows, regulatory logic, or enterprise-grade service orchestration. A practitioner may use tools like Rasa's visual flow editor or Dialogflow's CX state machine to implement such logic, while platforms like ChatGPT Enterprise allow for hybrid approaches combining prompt-based generation with structured fallback logic.

The practitioner may contemplate commercial alternatives to IBM Watson Assistant Service (WAS). Such alternatives may include Google Dialogflow CX, Amazon Lex, Microsoft Azure Bot Service, and OpenAI's ChatGPT Enterprise, among others. These platforms vary in architecture, integration models, and underlying AI capabilities, ranging from intent-based state machines to generative transformer-based systems. It is important to recognize that the field of conversational AI is highly dynamic, with rapid advancements in model design, deployment frameworks, and orchestration strategies. The volatility of the commercial landscape—driven by frequent releases of new APIs, model updates, and platform deprecations—does not invalidate the core premise of the disclosed invention. Rather, it reinforces the need for a flexible and modular architecture, such as that embodied by system 1700, which contemplates the AI/decisioning third-party 1716 as an interchangeable subsystem. This design allows practitioners to adopt emerging technologies without compromising the integrity or automation goals of the invention. The inventive subject matter is not bound to any specific vendor or implementation method, but instead anticipates and accommodates the evolution of AI tooling as part of its foundational strategy.

FIG. 17 further depicts the target site/platform 1717, which is characterized as a “Third Party Resource” element of the system 1700. The target site/platform 1717 may communicate with other elements of the system 1700 via the communication bus 1705 over communication channel 1755. The target site/platform 1717 may communicate with elements of customer management system 100 via communications link 160 over network 150. The target site/platform 1717 functions as a terminal device and delivery environment for the conversational agents, FAQs, or other AI-driven services automated by system 1700. In modern implementations, this may include web portals, mobile applications, messaging platforms, or embedded interfaces within enterprise software. Deployment of such agents is typically facilitated via RESTful APIs, SDKs, or containerized services, allowing for secure and scalable integration with third-party platforms. The architectural role of the target site/platform 1717 is to serve as the final interface layer, enabling end-user engagement while remaining decoupled from the orchestration and decisioning logic of system 1700.

As an example, the target site/platform 1717 may be a Facebook Business Page managed by a restaurant. The practitioner will be familiar with the aforementioned APIs and tokens provided by Facebook covered earlier in the detailed description of FIG. 17. In this particular example, the system 1700 may act as a robotic proxy as if it were a live person typing in answers to questions posed by a visitor to a particular Facebook Business Page. This proxying is permissible and technically feasible so long as the system is properly credentialed against Facebook's token routines and adheres to platform-specific rate limits, session management, and privacy policies. A practitioner of ordinary skill may implement this using the Facebook Graph API in conjunction with webhook listeners and message handlers, typically deployed using Node.js or Python-based frameworks. Middleware such as Dialogflow, Rasa, or custom-built orchestration layers may be used to manage conversational logic and route responses.

There is no limit to the number or variety of target sites/platforms 1717 the system 1700 could be coupled with. For example, system 1700 could be used to perform similar operations on a feed hosted on X (formerly Twitter), or on a custom-built website. In each case, the system may act as a robotic proxy, simulating human interaction by programmatically responding to user-generated content or queries. For X, a practitioner may use the X API v2, which supports tweet posting, direct messaging, and webhook-based event handling, provided the system is properly authenticated using OAuth 2.0 tokens and adheres to platform-specific rate limits and developer policies. For custom websites, integration may involve embedding JavaScript-based chatbot widgets, deploying RESTful endpoints, or using frameworks such as Rasa or Botpress to manage conversational logic. Irrespective of the target site/platform 1717, the use of automated credentialing, token-trading, and programmatic APIs remains essential to ensure secure, scalable, and compliant deployment. A practitioner of ordinary skill would select tools and integration methods based on the technical constraints and user experience goals of the target environment.

Finally, FIG. 17 depicts the target application 1718, which is characterized as a “Third Party Resource” element of the system 1700. The target application 1718 may communicate with other elements of the system 1700 via the communication bus 1705 over communication channel 1756. It may also interface with elements of customer management system 100 via communications link 160 over network 150. The target application 1718 functions as a terminal device and delivery platform for the conversational agents, FAQs, or other AI-driven services automated by system 1700. In modern implementations, this may include mobile applications, desktop software, or embedded modules within enterprise platforms. A practitioner of ordinary skill may deploy such agents using frameworks such as Microsoft Bot Framework, Google Dialogflow CX, or OpenAI's API, often in combination with containerization tools (e.g., Docker, Kubernetes) and cloud orchestration services. Integration typically involves RESTful APIs, token-based authentication, and event-driven architectures to ensure secure and scalable communication between the agent and the host application.

The target application 1718 may be any application, either a combination of hardware and software, or strictly software. For example, similar bot and FAQ routines and automated provisioning steps may operate with a smartphone application, an in-car telemetry device, a walk-up kiosk, or a hand-held computer. In a preferred embodiment, such target applications 1718 would provide a standard means to programmatically enable credentialization and real time access to timelines or other dialog constructs. A practitioner of ordinary skill may implement such integrations using frameworks like Microsoft Bot Framework, OpenAI's API, or Google Dialogflow CX, combined with deployment tools such as Docker, Kubernetes, or edge computing platforms. For hardware-software hybrid environments—such as kiosks or embedded automotive systems—integration may involve voice interface modules, local inference engines, and secure token-based authentication routines. These systems often rely on real-time communication protocols (e.g., WebSockets, MQTT) and may be optimized for low-latency response using specialized AI chips or embedded processors.

While the foregoing examples describe access to target sites/platforms 1717 and/or target applications 1718 via published APIs, such implementations are provided solely for illustrative purposes and are not intended to limit the scope of the disclosed subject matter. It is expressly contemplated that the automated provisioning and associated value-added functionalities described herein may likewise be implemented through alternative integration techniques, including but not limited to hard-coded interfaces or proprietary access mechanisms employed by platforms lacking publicly documented APIs. These and other variations fall within the spirit and scope of the present disclosure.

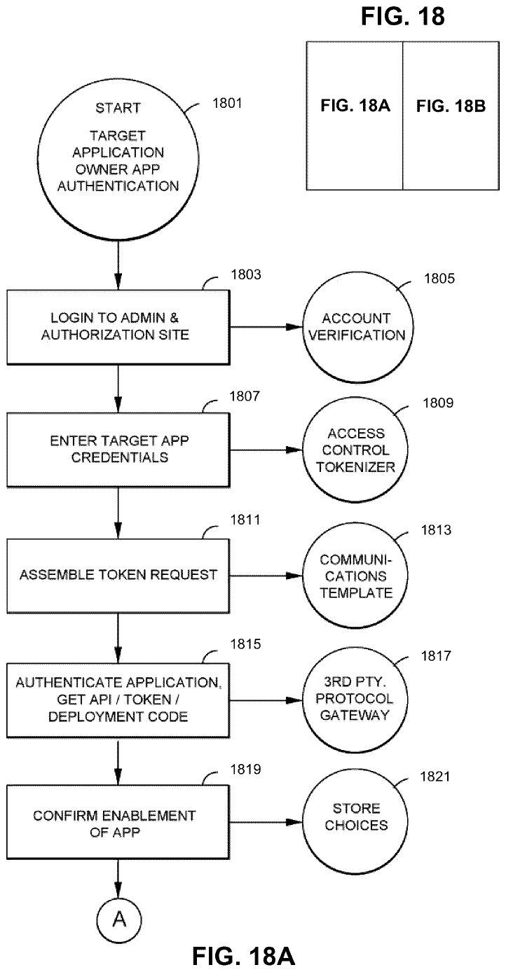

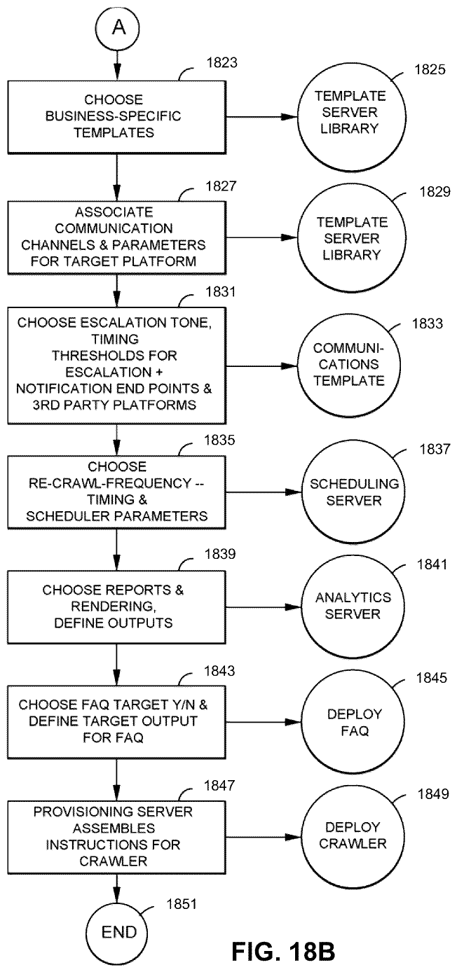

FIG. 18 diagrammatically depicts the arrangement of FIGS. 18A and 18B, of which FIG. 18A shows a first part of a process or logic flow for credentialization and provisioning and FIG. 18B shows a second part of the process. The process or logic flow may be performed by an auto-provisioning AI-based dialog services system, such as the auto-provisioning AI-based dialog services system 1700 of FIG. 17. The process proceeds by one or more activities, which although described in a particular order may be performed in one or more permutations, combinations, orders, or repetitions, according to particular needs.

Starting at step 1801, the “owner” of the target site/platform 1717 and/or target application 1718 (e.g. Facebook Business Page, Twitter account, Web site, etc.), generally referred to hereinafter as target application 1717, 1718, will have in his or her possession the credentials needed to log in as an owner or administrator to the chosen target application 1717, 1718. In embodiments, the “owner” of the target site/platform 1717 and/or target application 1718 may comprise at least one of the one or more entities 140, as described in further detail above. In the context of the system for auto-provisioning AI-based dialog services 1700 shown in FIG. 17, an “owner” of a target application 1717, 1718 may also be regarded as a “user” or “subscriber” of the system 1700 and/or customer management system 100. The practitioner of the system 1700 will have supplied the owner of the target application 1717, 1718 with the location and credentials for logging in to the admin & authorization site 1715 as described in relation to FIG. 17. At step 1803, the owner of the target application 1717, 1718 logs in to the admin & authorization site 1715, establishing account verification at step 1805.

Once the owner of the target application 1717, 1718 is logged in and verified at the admin & authorization site 1715, he or she navigates to a menu item for entering target application credentials at step 1807. These credentials are directed by the system 1700 to the access control tokenizer 1712, described earlier in relation to FIG. 17, at step 1809. The access control tokenizer 1712 assembles a token request at step 1811 and uses a communications template 1711 as described in relation to FIG. 17 to package the information for delivering to the target application 1717, 1718 at step 1813.

The system 1700 is now ready, at step 1815, for the authentication process to continue by sending the token request or other control information to the target application 1717, 1718 (e.g. as an API request). Such request may be sent via the third party protocol gateway 1704 at step 1817. Depending on the authentication steps offered by the target application 1717, 1718, certain choices may now be made available to the owner of the target application 1717, 1718 at step 1819. For example, the owner may be given the opportunity to confirm that the system 1700 will be connected to the target application 1717, 1718, to grant the system 1700 authorization to read and write into a timeline, and/or to grant the system 1700 authorization to access contact records of followers and other third-party users of the target application 1717, 1718. These choices may be relayed to the owner of the target application 1717, 1718 on the admin & authorization site 1715 via an IFrame or API commands depending on the rules set up by the target application 1717, 1718. The owner's credentialization choices are stored at step 1821. At this point, the Access Control Tokenizer will swap the requisite data with the target application 1717, 1718 and then store the resulting token or other credentials in the database 1714 as described in relation to FIG. 17. This part of the logic flow may repeat itself periodically as tokens often expire periodically.

At step 1823, the owner of the target application 1717, 1718 is asked to choose from a list of templates (e.g. a business-specific list of templates) managed by the template server 1709 as described in relation to FIG. 17. For example, the owner of the target application 1717, 1718 may choose a template pre-defined for restaurants, or one for a hardware store or grocery store. The practitioner of the system 1700 may present these templates, which may be accessed from a library of the template server 1709 in step 1825, as forms that allow the owner of the target application 1717, 1718 to choose sets of common questions, answers, business hours and other information that can be used downstream by the system 1700. The resulting choices may be archived in the database 1714 in association with the target application 1717, 1718 and/or owner thereof for later retrieval by other elements of the system 1700.

At step 1827, the owner of the target application 1717, 1718 is asked to choose communication channel(s) and parameters for the target application 1717, 1718. This may be achieved via the use of a list of templates managed by the template server 1709 as described in relation to FIG. 17 and accessed in a step 1829. For example, the owner of the target application 1717, 1718 may choose a template pre-defined for defaulting to target application timeline messages or direct messages. These forms allow the owner of the target application 1717, 1718 to set the default communication parameters available in each target application 1717, 1718 as per the abilities and APIs of the chosen target application 1717, 1718. The resulting choices may be archived in the database 1714 in association with the target application 1717, 1718 and/or owner thereof for later retrieval by other elements of the system 1700.

At step 1831, the owner of the target application 1717, 1718 is asked to choose the attributes for escalation and notification triggers for the target application 1717, 1718. As in the case of steps 1823 and 1827, this may be achieved via the use of a list of templates managed by the template server 1709 as described in relation to FIG. 17. For example, the owner of the target application 1717, 1718 may choose: a) the tone of the end user or speaker to ascertain a trigger for escalation or notification; b) the length of time the bot has been engaged with the end user or speaker; and/or c) the business classification or “cluster” according to the dialog with the end user or speaker. There is no limitation to the number and breadth of attributes that can be used as triggers for notification or escalation.

Also, at step 1831, the owner of the target application 1717, 1718 may specify the address or type of 3rd party platform such notifications or escalations should be pointed to in accordance with communications templates 1711 accessed in step 1833. Examples may include an SMS-based alert defined in the third party protocol gateway 1704 or the address for a third party ACD (Automatic Call Distributor) defined in the third party protocol gateway 1704. Other possible addresses for reference in the third party protocol gateway may include a chat system, an email system, or even an in-car telemetry system or PSTN or cell phone number. The resulting choices may be archived in the database 1714 in association with the target application 1717, 1718 and/or owner thereof for later retrieval by other elements of the system 1700.

At step 1835, the owner of the target application 1717, 1718 is asked to choose the re-crawl frequency including attributes for general timing and scheduling of tasks. This may be achieved via the use of the scheduling server 1710 shown in FIG. 17 in step 1837. At step 1839, the owner of the target application 1717, 1718 is asked to choose the types of reports and analytics that will be used for gaining insights about the performance of the application. Here, the owner of the target application 1717, 1718 will stipulate the rendering of the reports and how reports should be saved (i.e. to the screen, downloaded as a CSV file, uploaded to an FTP server, etc.). This may be achieved by accessing the analytics server 1707 in a step 1841 to obtain available options, as well as via the use of the scheduling server 1710 to specify timing of reports. The resulting choices may be archived in the database 1714 in association with the target application 1717, 1718 and/or owner thereof for use by other elements of the system 1700 and/or by elements of customer management system 100.

At step 1843, an option of outputting an FAQ (Frequently Asked Questions and Answers) may be presented to the owner of the target application 1717, 1718. The owner of the target application 1717, 1718 may define a URL, JSON object, HTML file or some other means to publish an FAQ that will be automatically generated by the system 1700 after the target application 1717, 1718 has been crawled, the FAQ being an AI-based set of answers to common questions as classified by the system 1700. At step 1845, the optional FAQ may be deployed on a preferred platform by the owner of the target application 1717, 1718. The resulting choices may be archived in the database 1714 in association with the target application 1717, 1718 and/or owner thereof for use by other elements of the system 1700 and/or by elements of customer management system 100.

Finally, at step 1847, with the various choices and other user information having been stored in the database 1714 in relation to the target application 1717, 1718, the owner of the target application 1717, 1718 is asked whether or not to deploy the crawler 1713 so it may commence its work on the target application 1717, 1718. All of the data collected at this point may be accessed by the provisioning server 1702 as described in relation to FIG. 17. In concert with the run time engine 1701, the provisioning server 1702 may deploy the system 1700 including the crawler 1713 automatically on the target application 1717, 1718 in a final step 1849. By the same token, at step 1847, the owner of the target application 1717, 1718 may turn the system 1700 “off” so it no longer provides automated AI-based dialog services.

Step 1851 signifies the end of the example credentialization and provisioning logic flow shown in FIGS. 18A and 18B. The practitioner will note, however, that it is not strictly necessary for the entire logic flow to be completed each time the owner of the target application 1717, 1718 wishes to make a change. What has been represented here is a typical “sunny path” flow of steps for provisioning a target application 1717, 1718 comprehensively, but it is contemplated that the owner of the target application 1717, 1718 may enter into the admin & authorization site 1715 to make a change in just a single step or two after the initial provisioning has been completed.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been shown and described, it will be understood that various changes and modifications to the foregoing embodiments may become apparent to those skilled in the art without departing from the spirit and scope of the present invention.

What is claimed is:

1. A system for provisioning, comprising:
a computer comprising a processor and memory, the computer coupled with a database and configured to:
receive a selection of one or more communication channels and one or more parameters for a target application;
receive attributes for escalation and notification triggers for the target application;
receive a specification of an address where an escalation is to be pointed;
assign an agent to handle the escalation;
in response to detection of at least one of the escalation and notification triggers, route a communication to the agent;
receive a selection of a re-crawl frequency comprising a timing and a task schedule;
present an option of outputting a frequently asked questions;
receive a definition of how the frequently asked questions are to be published;
deploy the frequently asked questions on a platform according to the definition;
prompt for a selection of whether or not to deploy a crawler on the target application; and
in response to receiving the selection to deploy the crawler, deploy the crawler on the target application.

2. The system of claim 1, wherein the attributes for the escalation and notification triggers comprise one or more of: a tone of an end user, a length of time a bot has been engaged with an end user and a business classification according to a dialog with an end user.

3. The system of claim 1, wherein the frequently asked questions comprise AI-generated answers to questions classified by the system.

4. The system of claim 1, wherein the definition of how the frequently asked questions are to be published comprises: a uniform resource locator, a JSON object or a HTML file.

5. The system of claim 1, wherein the computer is further configured to:
receive a selection of one or more types of reports and one or more analytics regarding performance of the target application.

6. The system of claim 1, wherein the computer is further configured to:
in response to receiving the selection to not deploy the crawler, turn the system off so automated AI-based dialog services are not provided.

7. The system of claim 1, wherein the one or more parameters for the target application are based on abilities and APIs of the target application.

8. A computer-implemented method for provisioning by a provisioning system, comprising:
receiving, by a computer comprising a processor and a memory, a selection of one or more communication channels and one or more parameters for a target application;
receiving, by the computer, attributes for escalation and notification triggers for the target application;
receiving, by the computer, a specification of an address where an escalation is to be pointed;
assigning, by the computer, an agent to handle the escalation;
in response to detection of at least one of the escalation and notification triggers, routing, by the computer, a communication to the agent;
receiving, by the computer, a selection of a re-crawl frequency comprising a timing and a task schedule;
presenting, by the computer, an option of generating a frequently asked questions;
receiving, by the computer, a definition of how the frequently asked questions are to be published;
deploying, by the computer, the frequently asked questions on a platform according to the definition;
prompting, by the computer, for a selection of whether or not to deploy a crawler on the target application; and
in response to receiving the selection to deploy the crawler, deploying, by the computer, the crawler on the target application.

9. The computer-implemented method of claim 8, wherein the attributes for the escalation and notification triggers comprise one or more of: a tone of an end user, a length of time a bot has been engaged with an end user and a business classification according to a dialog with an end user.

10. The computer-implemented method of claim 8, wherein the frequently asked questions comprise AI-generated answers to questions classified by the system.

11. The computer-implemented method of claim 8, wherein the definition of how the frequently asked questions are to be published comprises: a uniform resource locator, a JSON object or a HTML file.

12. The computer-implemented method of claim 8, further comprising:
receiving, by the computer, a selection of one or more types of reports and one or more analytics regarding performance of the target application.

13. The computer-implemented method of claim 8, further comprising:
in response to receiving the selection to not deploy the crawler, turning, by the computer, the provisioning system off so automated AI-based dialog services are not provided.

14. The computer-implemented method of claim 8, wherein the one or more parameters for the target application are based on abilities and APIs of the target application.

15. A non-transitory computer-readable medium embodied with software for provisioning by a provisioning system, the software when executed:
receives a selection of one or more communication channels and one or more parameters for a target application;
receives attributes for escalation and notification triggers for the target application;
receives a specification of an address where an escalation is to be pointed;
assigns an agent to handle the escalation;
in response to detection of at least one of the escalation and notification triggers, routes a communication to the agent;
receives a selection of a re-crawl frequency comprising a timing and a task schedule;
presents an option of generating a frequently asked questions;
receives a definition of how the frequently asked questions are to be published;
deploys the frequently asked questions on a platform according to the definition;
prompts for a selection of whether or not to deploy a crawler on the target application; and
in response to receiving the selection to deploy the crawler, deploys the crawler on the target application.

16. The non-transitory computer-readable medium of claim 15, wherein the attributes for the escalation and notification triggers comprise one or more of: a tone of an end user, a length of time a bot has been engaged with an end user and a business classification according to a dialog with an end user.

17. The non-transitory computer-readable medium of claim 15, wherein the frequently asked questions comprise AI-generated answers to questions classified by the system.

18. The non-transitory computer-readable medium of claim 15, wherein the definition of how the frequently asked questions are to be published comprises: a uniform resource locator, a JSON object or a HTML file.

19. The non-transitory computer-readable medium of claim 15, wherein the software when further executed:
receives a selection of one or more types of reports and one or more analytics regarding performance of the target application.

20. The non-transitory computer-readable medium of claim 15, wherein the software when further executed:
in response to receiving the selection to not deploy the crawler, turns the system off so automated AI-based dialog services are not provided.

21. The system of claim 1, wherein the system comprises a plurality of microservices including a run time engine, a provisioning server, a load balancer, and a third party protocol gateway, each configured to communicate via a communication bus, and wherein the plurality of microservices are orchestrated using a container orchestration framework.

22. The system of claim 1, wherein the provisioning server is configured to retrieve, store, and manage access tokens using a secure vault system, and wherein the access tokens are used to authenticate communications with one or more third party platforms.

23. The system of claim 1, wherein the AI-based dialog services are generated using one or more transformer-based models, and wherein the dialog services are deployed to the target application via one or more application programming interfaces.

24. The system of claim 1, further comprising a template server configured to define, store, and modify dialog templates using one or more structured formats selected from the group consisting of JSON, XML, and YAML.

25. The system of claim 1, wherein the crawler is configured to extract textual data from one or more sources selected from the group consisting structured data and unstructured data.
